(19) United States
(12) Patent Application Publication
(10) Pub. No.: US 2013/0067443 A1
(43) Pub. Date: Mar. 14, 2013

(54) Parallel Processing Development Environment Extensions

(71) Applicant: Kevin D. Howard, Tempe, AZ (US)

(72) Inventor: Kevin D. Howard, Tempe, AZ (US)

(21) Appl. No.: 13/607,198

(22) Filed: Sep. 7, 2012

Related U.S. Application Data
(60) Provisional application No. 61/531,973, filed on Sep. 7, 2011.

(51) Int. Cl. G06F 9/45

(52) U.S. Cl. 717/149

(57) ABSTRACT

A method for parallelization of an algorithm executing on a parallel processing system. An extension element is generated for each of the sections of the algorithm, where the sections comprise: distribution of data to multiple processing elements, transfer of data from outside of the algorithm to inside of the algorithm, global cross-communication of data between processing elements, moving data to a subset of the processing elements, and transfer of data from inside of the algorithm to outside of the algorithm. Each extension element functions to provide parallelization at a respective place in the algorithm where parallelization of the algorithm may occur.

### RELATED APPLICATIONS

This application claims benefit and priority to U.S. Patent Application Ser. No. 61/531,973, filed Sep. 7, 2011, the disclosure of which is incorporated herein by reference.

The following U.S. patent applications are herewith incorporated by reference herein: U.S. Pat. No. 6,857,004; U.S. Patent Pub. No. 2010/0183028; U.S. Patent Pub. No. 2010/0185719; U.S. Patent Application No. 61/382,405, and U.S. patent application Ser. No. 12/852,919.

### BACKGROUND

The formal concept of code reuse dates back to 1968 when Douglas Mcllroy of Bell Laboratories proposed basing the software industry on reusable components. Since then, a number of related concepts have been developed: ‘cut and paste’, software libraries, and object-oriented programming, to cite several examples. ‘Cut and paste’ means copying text from one file to another. In the case of software ‘cut and paste’ means that the computer programmer first finds the required source code text and copies it into the source code file of another software program. Software libraries are typically groups of associated, precompiled functions. The computer programmer purchases or otherwise obtains the right to use the functions within the libraries then copies the function information into the target source code file. The function libraries generally contain associated function (for example: image processing functions, financial analysis functions, bioinformatics functions, etc.). Object-oriented programming techniques include the ability to create objects whose methods can be reused. While perhaps superior to function libraries, with object-oriented programming techniques the software programmer must still select the correct code.

Other techniques, such as generic frame protocol (jointly developed at SRI International and Stanford University, this protocol provides a generic interface to underlying frame representation systems for artificial intelligence systems) and component-based software engineering (also called component-based software engineering, attempts to reuse web-services or modules that encapsulate some set of related functions or data (called system processes). All system processes are placed into separate components-so that all of the data and functions inside each component are semantically related. In this sense, components behave similarly to software libraries and software objects. All components communicate with each other via interfaces with each component acting as a service to the rest of the system. This service orientation is the primary difference between component-based software engineering and object oriented classes. The primary problem with code-reuse techniques is that they still require the programmer to select the proper reusable code components or objects to use, forcing a manual activity on what is desired to be an automatic process.

### BRIEF DESCRIPTION OF THE DRAWINGS

FIG. 1 shows an exemplary dataflow diagram illustrating how a target algorithm accesses data and performs state transitions.

FIG. 2 shows an exemplary table of valid combinations of data and transition profile output.

FIG. 3 shows exemplary source code illustrating use of “shmget” from the system library.

FIG. 4 shows a table illustrating exemplary binning of 16 sequential data items for processing by four computational elements, each element corresponding to one of bins 1-4.

FIG. 5 illustrates dimensional type 1 static array processing, with 1 object.

FIG. 6 illustrates dimensional type 1 static array processing, with 2 objects.

FIG. 7 illustrates Standard 1-Dimensional Static Array Processing with 3 Unevenly Spaced Objects.

FIG. 8 shows another type of static object which occurs where the data objects are skipped within an array.

FIG. 9 illustrates Standard 1-Dimensional Dynamic Array Processing with 2 moving objects.

FIG. 10 illustrates Standard 1-Dimensional Dynamic Array Processing with 2 growing objects.

FIG. 11 illustrates Standard 1-Dimensional Dynamic Array Processing with 2 objects moving around a ring.

FIG. 12 illustrates Standard 1-Dimensional Dynamic Array Processing with 2 objects growing around a ring.

FIG. 13 shows an example of four data objects concentrated at the ends of an array (bin 1 and bin 4), illustrating an unbalanced workload, wherein bin 2 and bin 3 have no work.

FIG. 14 illustrates balancing a workload from unbalanced data object locations within an array through the use of pointers.

FIG. 15 shows the locating of 4 data objects of FIG. 14 after a number of data movements.

FIG. 16 shows one exemplary table illustrating Dimensional Standard Dataset Topology with Index, Stride, Index-with-Stride, Overlap, Index-with-Overlap, Stride-with-Overlap, and Index-with-Stride-with-Overlap.

FIG. 17 shows an exemplary two dimensional standard dataset topology.

FIG. 18 shows on exemplary two-dimensional table of static objects prior to applying an−a[x][y] transformation, and an updated array that represents the array after transformation has been applied.

FIG. 19 illustrates a Standard 2-Dimensional Static Matrix Processing, with 2 small data objects

FIG. 20 illustrates a Standard 2-Dimensional Dynamic Array Processing, with 2 moving objects

FIG. 21 shows a Standard 2-Dimensional Alternating Dataset Topology 2102 and four additional examples.

FIG. 22 illustrates one exemplary 3-Dimensional Standard Dataset Topology.

FIGS. 23-26 show four examples of 3-Dimensional Mesh_Type_Standard decomposition utilizing Index, Stripe and Overlap.

FIG. 27 shows data positions added to bins in a one-dimensional standard dataset topology.

FIG. 28 shows data positions added to bins in a one-dimensional alternating dataset topology.

FIG. 29 shows one example of a 1-dimensional alternating static model having static objects.

FIG. 30 shows a 1-Dimensional Alternating Dataset Topology with Index, Stride, and Overlap as applied to the example of FIG. 28.

FIG. 31 illustrates one exemplary 2-Dimensional Mesh Type Alternate topology.

FIG. 32 shows four examples of 2-Dimensional Alternating dataset topology within a table.

FIG. 33 shows one exemplary alternate topology in three dimensions within a table.

FIG. 34 shows a one-dimensional block topology table with blocks of data placed into bins.

FIG. 35 shows a table of a 1-Dimensional Continuous Block Dataset Topology with Index, Step, and Overlap.

FIG. 36 shows an example of the 2-Dimensional Continuous Block Topology.

FIG. 37 shows one examples of a 2-dimensional continuous-block dataset topology model with index, step and overlap parameters.

FIG. 38 shows a 3-Dimensional Continuous Block Topology example, such that data is distributed to exemplary computational elements 1-4.

FIG. 39 shows a MESH_TYPE_ROW_BLOCK mesh type which decomposes a 2-dimensional or higher array into blocks of rows such that data is distributed to exemplary computational elements 1-4

FIG. 40 shows one examples of a 2-dimensional row-block dataset topology model with Index, Step and Overlap parameters.

FIG. 41 shows a MESH_TYPE_Column_BLOCK mesh type which decomposes a 2-dimensional or higher array into blocks of columns, such that data is distributed to exemplary computational elements 1-4

FIG. 42 shows the parameters Index, Step and Overlap applied to the example of FIG. 40 to produce the 2-Dimensional Column Block Dataset Topology with Index, Step, and Overlap.

FIG. 43 shows a simplified Howard Cascade data movement and timing diagram.

FIG. 44 shows illustrative hardware view of nodes in communication with smart NIC and a switch in a first time step of FIG. 43.

FIG. 45 shows illustrative hardware view of nodes in communication with smart NIC and a switch in a second time step of FIG. 43.

FIG. 46 shows one example of a data movement and timing diagram of a nine node multiple communication channel system.

FIG. 47 shows one exemplary illustrative hardware view of the first time step of the 2-channel Howard Cascade-based multicast/broadcast of FIG. 46.

FIG. 48 shows one exemplary illustrative hardware view of the second time step of the 2-channel Howard Cascade-based multicast/broadcast of FIG. 46.

FIG. 49 shows one example of a scan command using SUM operation.

FIG. 50 show one exemplary Sufficient Channel Lambda Exchange Model 5000.

FIG. 51 shows one exemplary hardware view of data transmitted utilizing a Sufficient Channel Lambda exchange model.

FIG. 52 shows smart NIC 5212, 5214 performing SCAN (with Sum) using Sufficient Channel Lambda exchange model.

FIG. 53 shows a detectable communication pattern 5300 used to detect the use of a multicast or broadcast.

FIG. 54 shows one exemplary logical view of a Sufficient Channel Howard Cascade-based Multicast/Broadcast.

FIG. 55 shows an exemplary hardware view of Sufficient Channel Howard Cascade-based multicast or broadcast communication model of FIG. 54.

FIG. 56 shows one exemplary scatter data pattern.

FIG. 57 shows one exemplary Sufficient Channel Howard Cascade Scatter.

FIG. 58 shows one exemplary hardware view of the Sufficient Channel Howard Cascade Scatter of FIG. 57.

FIG. 59 shows one exemplary logical vector scatter.

FIG. 60 shows one exemplary timing diagram and data movement for the vector scatter operation.

FIG. 61 shows one exemplary hardware view of the vector scatter operation of FIG. 60.

FIG. 62 shows a logical view of serial data input using Howard Cascade-based data transmission.

FIG. 62 shows one exemplary system in which a home-node selection of top-level compute nodes transmit a decomposed dataset to a portion of the system in parallel.

FIG. 63 show one exemplary hardware view of the first time step of transmitting portions of a dataset from a NAS device of FIG. 62.

FIG. 64 show one exemplary hardware view of the second time step of transmitting portions of a dataset from a NAS device of FIG. 62.

FIGS. 65-67 show one example of transmitting a decomposed dataset to portions of a system

FIG. 68 shows a pattern used to detect a one-dimensional left-right exchange under a Cartesian topology.

FIG. 69 shows a pattern used to detect a left-right exchange under a circular topology.

FIG. 70 shows an all-to-all exchange detection pattern as a first and second matrix.

FIG. 71 shows one exemplary four node all-to-all exchange in three time steps.

FIG. 72 shows an illustrative hardware view of the all-to-all exchange (PAAX/FAAX model) of FIG. 71.

FIG. 73 shows a vector all-to-all exchange model data pattern detection.

FIG. 74 shows a 2-dimensional next neighbor data exchange in a Cartesian topology.

FIG. 75 shows a 2-dimensional next neighbor data exchange in a toroid topology.

A two-dimensional red-black exchange in a Cartesian topology in shown in FIG. 76.

FIG. 77 shows a two-dimensional red-black exchange in a toroid topology.

FIG. 78 shows a two-dimensional left-right exchange in a Cartesian topology.

FIG. 79 shows a two-dimensional left-right exchange in a toroid topology.

FIG. 80 shows a data pattern required to detect an all-reduce exchange.

FIG. 81 shows an illustrative logical view of the sufficient channel-based FAAX of FIG. 80.

FIG. 82 shows an illustrative hardware view of Sufficient Channel-based FAAX Exchange of FIG. 81.

FIG. 83 shows a smart NIC performing all reduction (with Sum) using FAAX model in a three channel overlap communication.

FIG. 84 shows a logical view of Sufficient Channel Partial Dataset All-to-All Exchange (PAAX).

FIG. 85 shows a reduce-scatter model data movement and timing diagram.

FIG. 86 shows smart NIC 8210 performing reduce scatter (with Sum) using PAAX model.

FIG. 87 which shows one exemplary all gather data movement table.

FIG. 88 shows a vector All Gather as a Sufficient Channel Full Dataset All-to-All Exchange (FAAX).

FIG. 89 shows one exemplary data movement and timing diagram for an agglomeration model for gathering scattered data portions such that a final result is centrally location.

FIG. 90 shows one exemplary hardware view 9000 of the agglomeration gather shown in FIG. 89 during the first time step.

FIG. 91 shows one exemplary hardware view 9100 of the agglomeration gather shown in FIG. 89, during the second time step.

FIG. 92 shows a logical view of 2-channel Howard Cascade data movement and timing diagram, the present example showing a Reduce Sum operation.

FIG. 93 shows a hardware view of the first time step of FIG. 92)of the two-channel data and command movement.

FIG. 94 shows one exemplary hardware view of the second time step of FIG. 92.

FIG. 95 shows an illustrative example of a gather model data movement.

FIG. 96 shows a logical view of a sufficient channel Howard Cascade gather.

FIG. 97 shows a hardware view of sufficient channel Howard Cascade-based gather communication model.

FIG. 98 is a list of the basic gather operations which can take the place of the sum-reduce.

FIG. 99 shows one example of a reduce command using SUM operation.

FIG. 100 shows one example of a Howard Cascade data movement and timing diagram using reduce command using sum operation.

FIG. 101 shows a hardware view of sufficient channel overlapped Howard Cascade-based reduce command.

FIG. 102 shows one example of a smart NIC performing a reduction utilizing overlapped communication with computation.

FIG. 103 shows data movements which are detected as a vector gather operation.

FIG. 104 shows a logical view of a vector gather system having three nodes.

FIG. 105 shows a hardware view of system of FIG. 104 for performing a sufficient channel Howard Cascade vector gather operation.

FIG. 106 shows a logical view of a system of serial data output using Howard Cascade-based data transmission.

FIG. 107 shows a partial, illustrative hardware view of a serial data system using Howard Cascade-based data transmission in 1^{st} time step, FIG. 106.

FIG. 108 shows the partial, illustrative hardware view of the serial data system using a Howard Cascade-based data transmission in second time step FIG. 109 shows one example of a Howard Cascade-based parallel data input transmission.

FIG. 110 shows one illustrative hardware view of a parallel data output system using the Howard Cascade during the first time step, FIG. 109.

FIG. 111 shows one illustrative hardware view of a parallel data output system using a Howard Cascade during the second time step, FIG. 109.

FIG. 112 shows a state machine with two states, state 1 and state 2, and four transmissions.

FIG. 113 shows state 2 of FIG. 112 which additional includes a state 2.1 and a state 2.2.

FIG. 114 a illustrative example of a parallel processing determination process which requires combining data movement with state transition for detection.

FIG. 115 shows an exemplary method for processing algorithms which outputs a file containing an index, a list of output values, and a pointer to an extension kernel for each associated data and transition kernel association.

FIG. 116 shows one exemplary method 11600 for processing Parallel Extensions, either my adding, changing or deleting.

FIG. 117 shows one exemplary system for processing algorithms.

FIG. 118 shows an exemplary algorithm used to combine the six parallelism components.

### DETAILED DESCRIPTION

### Definitions

For the purpose of this document, the following definitions are supplied to provide guidelines for interpretation of the terms below as used herein:

Control Kernel—A control kernel is some software routine or function that contains only the following types of computer-language constructs: subroutine calls, looping statements (for, while, do, etc.), decision statements (if-then-else, etc.), and branching statements (goto, jump, continue, exit, etc.).

Process Kernel—A process kernel is some software routine or function that does not contain the following types of computer-language constructs: subroutine calls, looping statements, decision statements, or branching statements. Information is passed to and from a process kernel via RAM.

Mixed Kernels—A mixed kernel is some software routine or function that includes both control- and process-kernel computer-language constructs.

Data Transfer Communication Models—These are models for transferring information to/from separate servers, processors, or cores.

Control Transfer Model—control-transfer models consist of methods used to transfer control information to the system State Machine Interpreter.

State Machine—The state machine employed herein is a two-dimensional matrix which links together all associated control kernels into a single non-language construct that provides for activation of process kernels in the correct order.

State Machine Interpreter—A State Machine Interpreter is a method whereby the states and state transitions of a state machine are used as active software, rather than as documentation.

Profiling—Profiling is a method whereby run-time analysis of algorithm-processing timing, Random Access Memory utilization, data-movement patterns, and state-transition patterns is performed.

Node—A node is a processing element comprised of a processing core, or processor, memory and communication capability.

Home Node—The Home node is the controlling node in a Howard Cascade-based computer system.

### Introduction

The present system and method includes six extensions (extension elements) to a parallel processing development environment: Topology, Distribution, Data Input, Cross-Communication, Agglomeration, and Data Output. The first extension element describes the network topology, which determines discretization, or problem breakup across multiple processing elements. The five remaining extension elements correspond to the different program stages in which data or program (executable code) movement occurs, i.e., where information is transferred between any two nodes in a network, and thus represent the places where parallelization may occur. The six parallel-processing stages and related extension elements are:
(1) Network topology (topology determination occurs prior to program execution). Examples: 1-2-3-dimensional Cartesian and 1-2-3-dimensional toroidal.
(2) Distribution methods of data to multiple processing elements (distribution can occur prior to program execution or during program execution). Examples: scatter, vector scatter, scan, true broadcast, tree broadcast.
(3) Transfer of data from outside of the application to inside of the application (data Input, serial and parallel input).
(4) Global Cross-Communication of data between processing elements (cross-communication occurs during program execution). Examples: all-to-all, vector all-to-all, next-n-neighbor, vector next-n-neighbor, red-black, left-right.
(5) Moving data to a subset of the processing elements (agglomeration occurs after program execution). Examples: reduce, all-reduce, reduce-scatter, gather, vector gather, all-gather, vector all-gather.
(6) Transfer of data from inside of an application to outside of the application (data output, serial I/O and parallel I/0).

Selection of any of the above six elements ensures that the correct usage of a given kernel is made during profiling.

### Manipulating Extension Kernels

The only code that must be written for execution in a parallel processing system, using the present method, is the code required for the process kernels, which represent only the linearly independent code. Selection of any of the six extension elements described above informs the interface system (e.g., system 11700 shown in FIG. 117) that a new parallelization model is being defined. In the present embodiment, parallel processing cluster system 11701 (FIG. 117) executes only non-extension kernels within a state machine (e.g., finite state machine 11746). The states in the state machine correspond to the non-extension kernel code which is to be run and the state transitions correspond to control flow conditions. Because parallel processing cluster system 11701 executes only ‘non-extension’ kernels within state machines, the state transitions and the non-extension kernels produce different, detectable, parallel-processing patterns for each of the six extension elements.

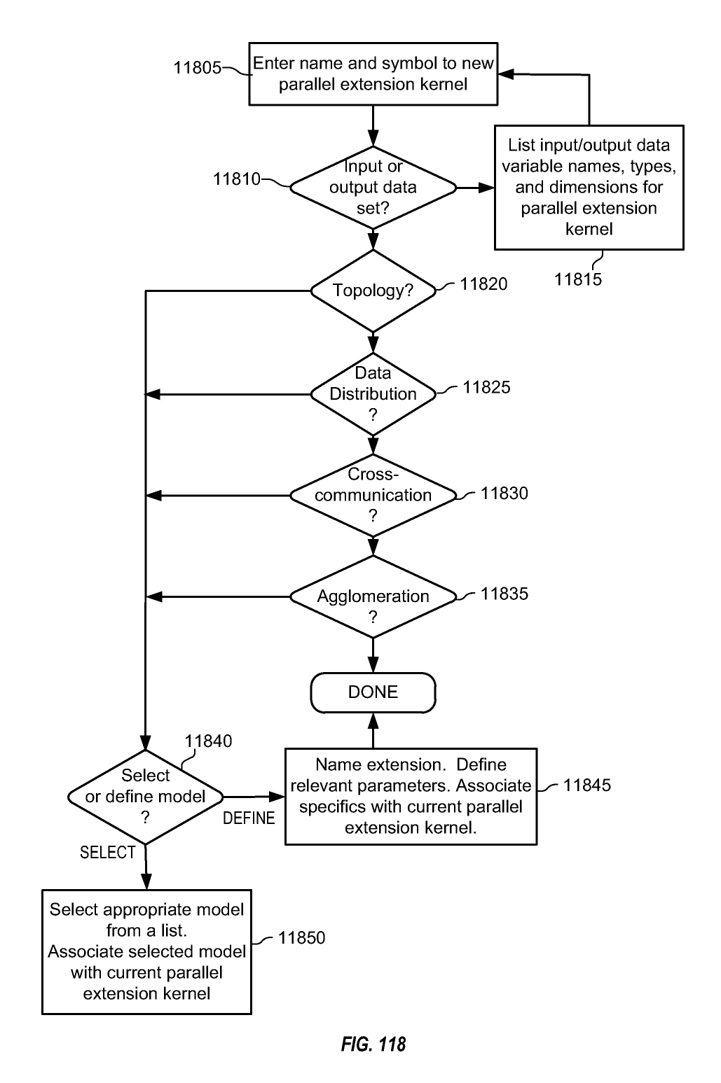

The present system facilitates the creation of kernels that define parallel processing models. These kernels are called ‘parallel extension kernels’. In order to define a parallel extension kernel, all six elements needed to define parallelism must be defined: topology, distribution, input data, output data, cross-communication, and agglomeration. FIG. 118 shows an exemplary algorithm used to combine all six elements to define a parallel extension kernel.

As shown in FIG. 118, the interface system initially receives the name and pointer to a new parallel extension kernel, at step 11805. At step 11810, if the element being defined is an input data set or output data set, then the received input/output data variable names, types, and dimensions are and associated with the present extension kernel being defined.

In steps 11820-11835, checks are made to determine which possible other type of extension element is presently being defined. Once the type of extension element is determined, a check is then made, at step 11840, as to whether an existing parallel extension model element is being selected, or whether a new model, or new element in an existing model, is being defined.

If an existing parallel extension model element is being selected, then at step 11850 the appropriate element is selected from a list residing on the interface system, e.g., in list 11754 in LTM 11722. If a new parallel extension model, or new element in an existing model, is being defined, then at step 11845, the extension name (or extension model name) and relevant parameters are received and added to a list in the interface system, e.g., in list 11754 in LTM 11722. In both cases, the selected extension element or other supplied information is associated with the parallel extension kernel being defined.

There are two pattern types; data and transition. The existence of these pattern types may be determined by two special pattern determining kernel types, the Algorithm Extract Data Access Pattern kernel and the Algorithm State Transition Pattern kernel. The output values of these two pattern searching kernel types are used in combination to determine if a third kernel (the parallel extension kernel) will need to be invoked by a state-machine interpreter.

In accordance with the present system, a state machine interpreter (SMI) [not shown] is a computer system that takes as input a finite state-machine which consists of states which are process kernels and associated data storage, which are connected together using state vectors consisting of control kernels. The combination of process kernels, data storage, and control kernels provides the same capability as a standard computer program, thus the output of a SMI is a functional computer program.

### Pattern Usage—Adding Parallel Extension Kernels

A parallel extension kernel may be added, for example, by a system user. One example of this is an administrative-level user selecting an Add button, for example, from a user interface, after the selection of an element. The system interface then displays an Automated Parallel Extension Registration (APER) screen. The APER screen displays a parallel extension name and category combined with the creating organization's name defines the new parallel extension element.

Extension elements may have one of three computer program types: Data Kernel, Transition Kernel, and Extension Kernel. The Data Kernel is software that tracks RAM accesses that occur when a standard kernel or algorithm is profiled. Thus, the Data Kernel represents the detection method used to determine data movement/access patterns.

The Transition Kernel is software that tracks data transitions that occur during the execution of the state machine for the profiled kernel or algorithm. The Transition Kernel represents the detection method used to determine state-transition patterns. A relationship exists between the Data Kernel and the Transition Kernel, termed the ‘Data and Transition Pattern Relationship Condition’. The Data and Transition Pattern Relationship Condition is a method used to check the output data from one or both of the Data Kernel and the Transition Kernel such that the state machine interpreter knows when the conditions exist to utilize the Extension Kernel.

The Extension Kernel is software that represents a parallel-processing model. An Extension Kernel is utilized at the point either where a data or transition pattern is detected (in the case of a cross-communication member), or at the proper time (in the other member cases). In the situation wherein intellectual property, such as the automatic detection of parallel-processing events and the subsequent code required to perform the detected parallel processing, is made available for use by developers, the organization that makes the code available may add a fee to the end license fee for the parallelized application code.

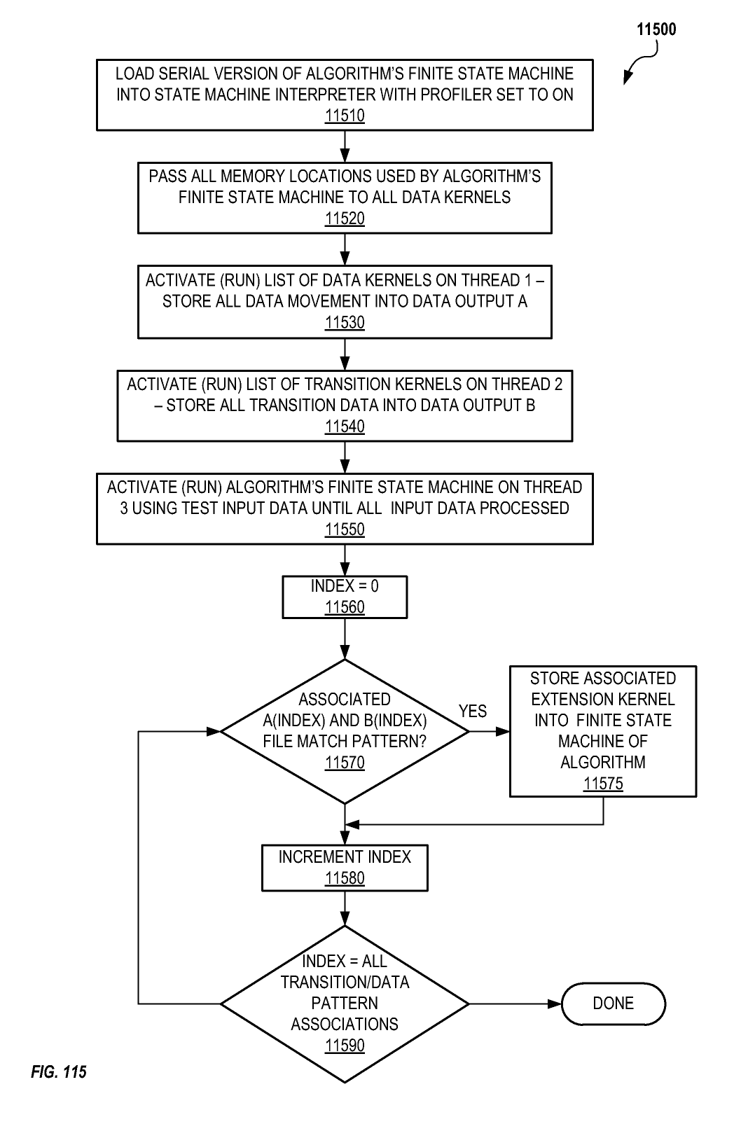

FIG. 115 shows a method 11500 for processing algorithms which outputs a file containing an index, a list of output values, and a pointer to an extension kernel for each associated data and transition kernel. Initially, the algorithm is executed and data accesses to the largest vector/matrix are tracked. Physically moving the data entails copying the contents of an element to a different element within the same vector/matrix. The relative physical element movement is tracked and the track is saved. The saved track is called a pattern. Saved tracks are then compared with a library of known patterns. If the current pattern is found in library of patterns, then the discretization (topology) model of the found library pattern is assigned to the current kernel. The extended parallel kernel of (associated with) the found library pattern is attached to the current kernel forming a finite state machine with the current kernel as a state and the extended parallel kernel(s) as at least one other state.

In step 11510, method 11500 loads a serial version of an algorithm's finite state machine into a state machine interpreter with its profiler set to ON. Step 11520 passes all memory locations used by the algorithm's finite state machine to all data kernels. Step 11530 runs the list of data kernels on a thread 1 and stores all data movements in data output A file. Step 11540 runs a list of transition kernels on thread 2 and stores all transition data in a data output B file. Step 11550 runs the algorithm's finite state machine on a thread 3 using test input data until all the input data is processed. Step 11560 sets an index equal to zero. Decision step 11570 determines if the indexed data output A and data output B match a pattern, one example of which is shown below.

### Data Pattern Detection Example

Detection of the following 2-dimensional data movement:

| | X = 1 | X = 2 | X = 3 |
|---|---|---|---|
| Y = 1 | 1 | 2 | 3 |
| Y = 2 | 4 | 5 | 6 |
| Y = 3 | 7 | 8 | 9 |

which is transformed to the following:

| | X = 1 | X = 2 | X = 3 |
|---|---|---|---|
| Y = 1 | 1 | 4 | 7 |
| Y = 2 | 2 | 5 | 8 |
| Y = 3 | 3 | 6 | 9 |

In addition, if during the course of the detecting, the detected data movement is as follows:
X index={1, 2, 3, 1, 2, 3, 1, 2, 3) and
Y index={1, 1, 1, 2, 2, 2, 3, 3, 3),
   then this indicates a 2-dimensional transpose. The data of a 2-dimensional transpose of this type can be split into multiple rows (as few as 1 row per parallel server) which implies the discretization model, the input dataset distribution across multiple servers, and the agglomeration model back out of the system. In one example, the parallelization from the detection of the above patterns is:
Discretization extension:
   Server 1=(1,1), (1,2), (1,3)
   Server 2=(2,1), (2,2), (2,3)
   Server 3=(3,1), (3,2), (3,3)
Howard Cascade distribution extension
Transpose extension
Howard Cascade agglomeration extension

The incorporation of the identified models allows the present system to fully parallelize the application. If the index data A and data B match the pattern then method 11500 moves to step 11575 where method 11500 stores the associated extension kernel in the algorithm's finite state machine and processing moves to step 11580. In one example, index 3 of data output A refers to the same extension kernel as index 3 of data output B. Otherwise, processing moves to step 11580.

Step 11580 increments the index then moves to step 11590, which determines of the index is equal to total number of transition and data pattern associations. If step 11590 determines that the index is not equal to equal to the total number of transition and data pattern associations, processing moves to step 11570. Otherwise, method 11500 terminates.

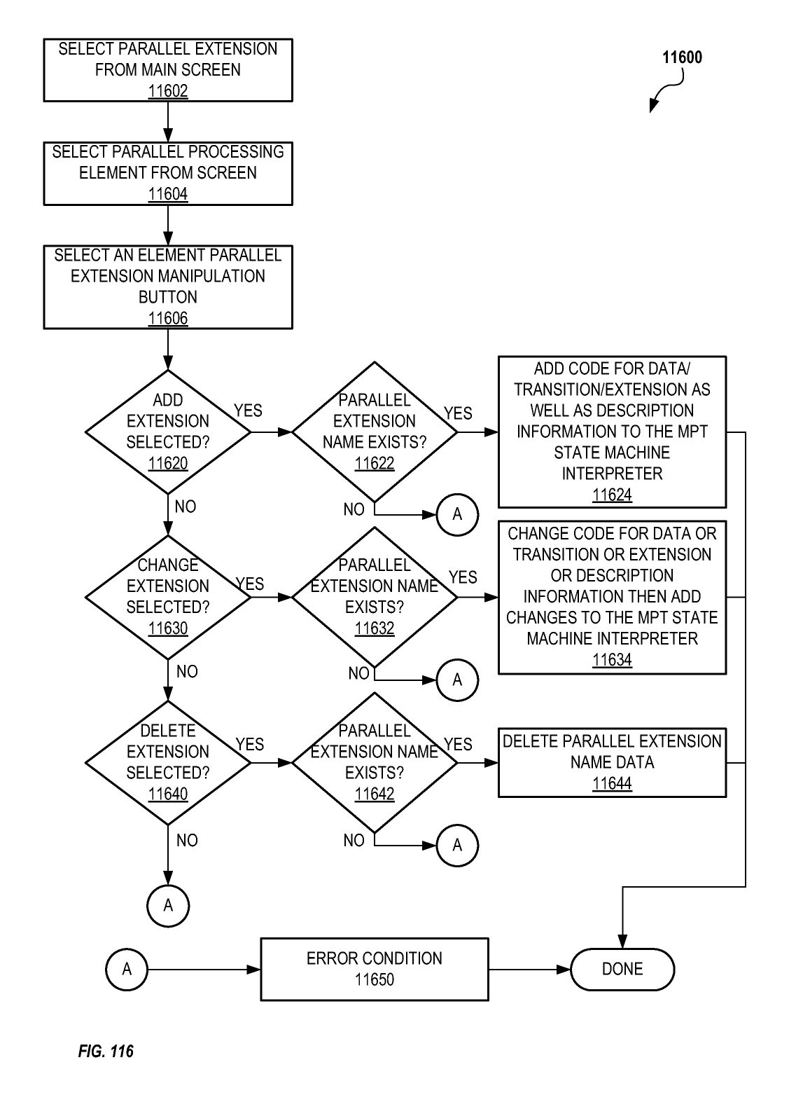

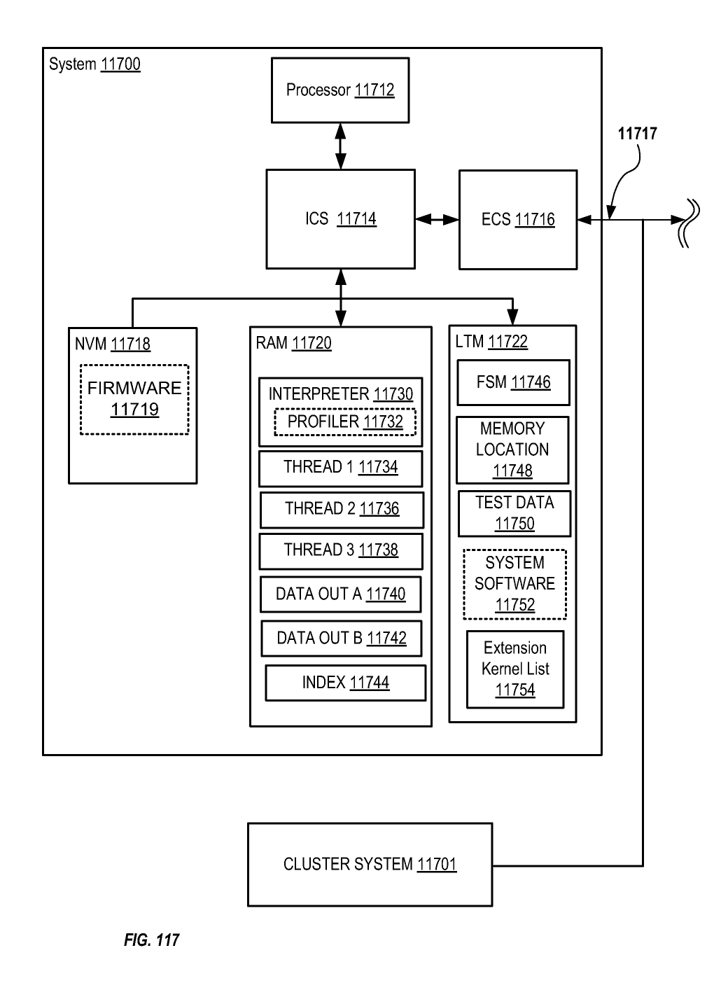

FIG. 116 shows one exemplary method 11600 for processing Parallel Extensions, either my adding, changing or deleting. In method 11600, a user selects a Parallel Extension (step 11602), parallel processing element (step 11604), and a manipulation option (step 11606). Examples of steps 11602-11604 are a user selecting one of more buttons on a user interface.

Decision step 11620 determines if add extension is selected. If add decision is selected in steps 11602-11606, 11620 moves to decision step 11622. In step 11622, it is determined if the selected parallel extension name exists (selected in step 11602). If a parallel extension name does not exist, processing moves to error condition step 11650, where the error is determined prior to terminating method 11600. If, in step 11622, it is determined that the selected parallel extension name exists, processing moves to step 11624. In step 11624, method 11600 adds code for extension associated data as well as description information to the state machine interpreter prior to terminating method 11600. If, in step 11620, it is determined that add extension is not selected, processing moves to decision step 11630.

In decision step 11630, method 11600 determines if change extension was selected in steps 11602-11606. If it is determined that change extension is selected, processing moves to step 11632. In step 11632, it is determined if the selected parallel extension name exists. If a parallel extension name does not exist, processing moves to error condition step 11650, where the error is determined prior to terminating method 11600. If it is determined that the extension name exists, processing moves to step 11634. In step 11634 method 11600 changes code for data or transition or extension or description information then add changes to the state machine interpreter. Method 11600 then terminates. If, in step 11630, it is determined that change extension is not selected, processing moves to decision step 11640.

In step 11640 it is determined if delete extension is selected in steps 11602-11606. If delete extension is selected, processing moves to decision step 11642. In step 11642, it is determined if the selected parallel extension name exists. If a parallel extension name does not exist, processing moves to error condition step 11650, where the error is determined prior to terminating method 11600. If it is determined that the extension name exists, processing moves to step 11644. In step 11644 parallel extension name data is deleted prior to terminating method 11600. If, in step 11640, it is determined that add extension is not selected, processing moves to error condition step 11650, where the error is determined prior to terminating method 11600.

FIG. 117 shows one exemplary system for processing algorithms as described in method 11500, FIG. 115. System 11700 includes a processor 11712 (e.g. a central processing unit), an internal communication system (ICS) 11714 (e.g. a north/south bridge chip set), an Ethernet controller 117116, a non-volatile memory (NVM) 11718 (e.g. a CMOS memory coupled with a ‘keep-alive’ battery), a RAM 11720, and a long-term memory (LTM) 11722 (e.g. HDD).

In the present example, RAM 11720 stores an interpreter 11730 having a profiler 11732, a first thread 11734, a second thread 11736, a third thread 11738, a data out A 11740, a data out B 11742 and an index 11744. LTM 11722 stores a finite state machine (FSM) 11746, a memory location 11748 storage, test data 11750, and system software. NVM 11718 stores firmware 11719. ICS 11714 facilitates the transfer of data within system 11700 and to Ethernet controller 11716 and Ethernet connect 11717 for communication with systems external to system 11700. Processor 11712 executes code, for example, interpreter 11730, firmware 11719 and system software 11752. It will be appreciated that system 11700 may be varied by the number and type of components included and organization structure as long as it maintains functionality for processing algorithms as described by method 11500.

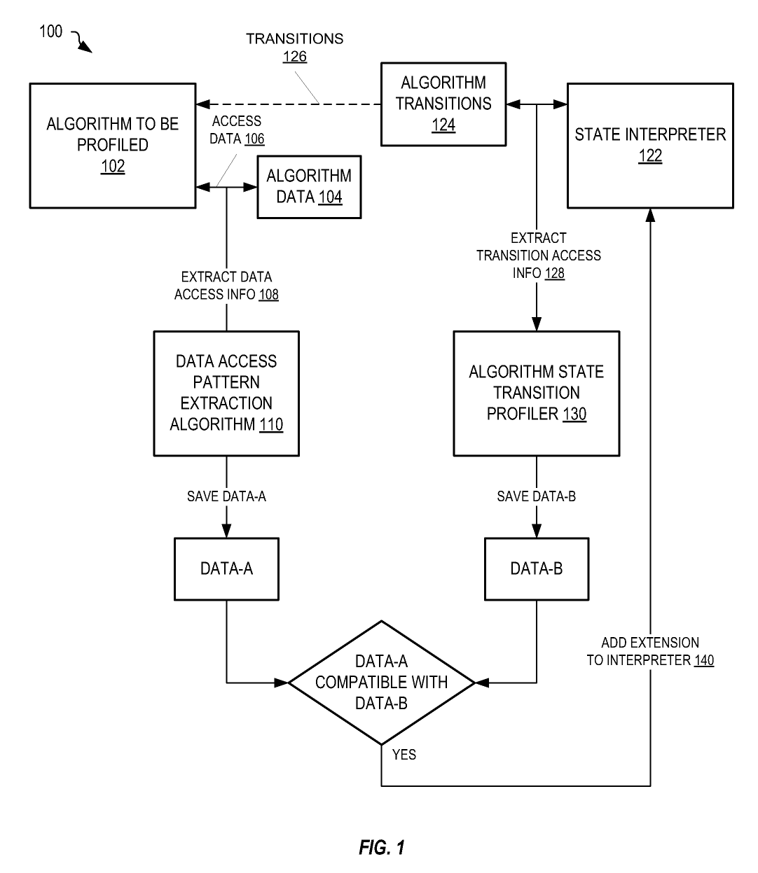

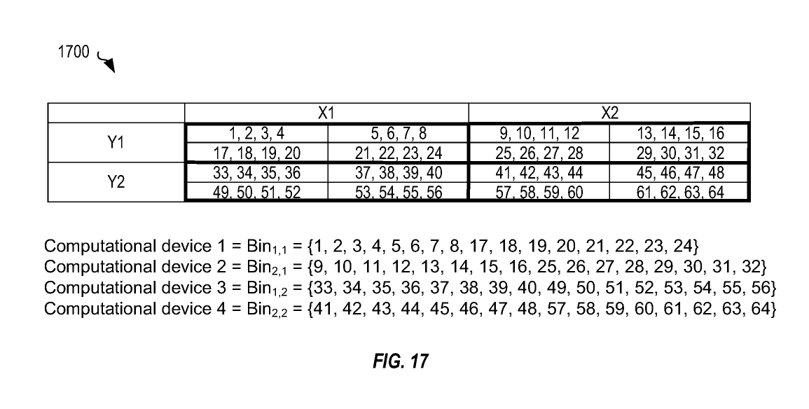

FIG. 1 is an exemplary dataflow diagram 100 illustrating how a target algorithm accesses data and performs state transitions, such that an associated cluster system (e.g., parallel processing cluster system 11701 in FIG. 17) is able to automatically apply a particular parallel-processing extension to that algorithm. As shown in FIG. 1, a data access pattern extraction algorithm 110 extracts data access information 108 from data accesses 106 made by a profiled algorithm 102 accessing algorithm data 104.

If a data access pattern, extracted by data access pattern extraction algorithm 110, matches the pattern found in the data kernel, the associated data kernel's output data, data-A 112, is set to true; otherwise, it is set to false. Similarly, the state transition pattern is extracted by state transition pattern extraction algorithm profiler 130 from access data 128 for transitions 126, via communication between state interpreter 122 and algorithm transitions 124. If the state transition pattern matches the pattern found in the transition kernel, then the transition-kernel output data, data-B 132 is set to true; otherwise, it is set to false.

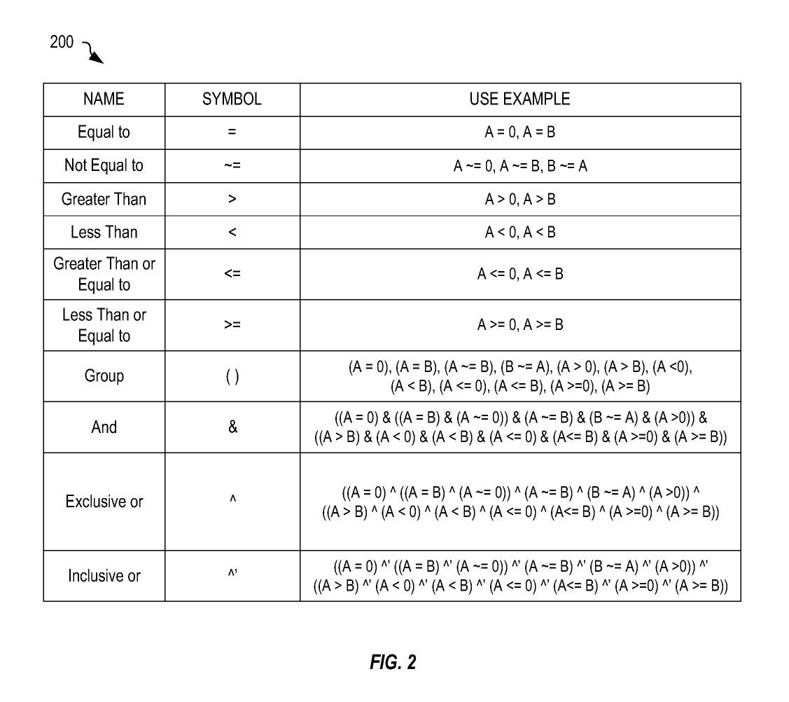

The two profile methods can be combined using the data and transition pattern relationship. Table 200 of FIG. 2 shows the valid combinations of data and transition profile outputs. In table 200, the output of Data Pattern Profiling (DATA-A 112 of FIG. 1) is represented by A, and the output of Transition Pattern Profiling (DATA-B 132 of FIG. 1) is represented by B.

As shown in FIG. 1, if, at decision step 134, the outcome of the comparison between pattern-output values resolves to true, that is, if data-A is compatible with data-B, then the extension for the current element is applied to state interpreter 122 at the memory location identified by profiling, as shown at ‘add extension to interpreter’ 140. Even though multiple kernels are involved with automatic parallel processing, the multiple kernels are stored together. Therefore, kernel attributes which may include license fees, license period, per-use fees, number of free uses and a description, are associated with this group of multiple kernels in a single entity called an application.

Created extensions are stored (e.g., within a database) within parallel processing cluster system 11701. Extensions may also be edited and deleted within cluster system 11701.

### Initial Topology Examples

Although it is possible to add practically any topology imaginable to the present system, the following describes the initial topologies of interest.

### Memory Access Following Method

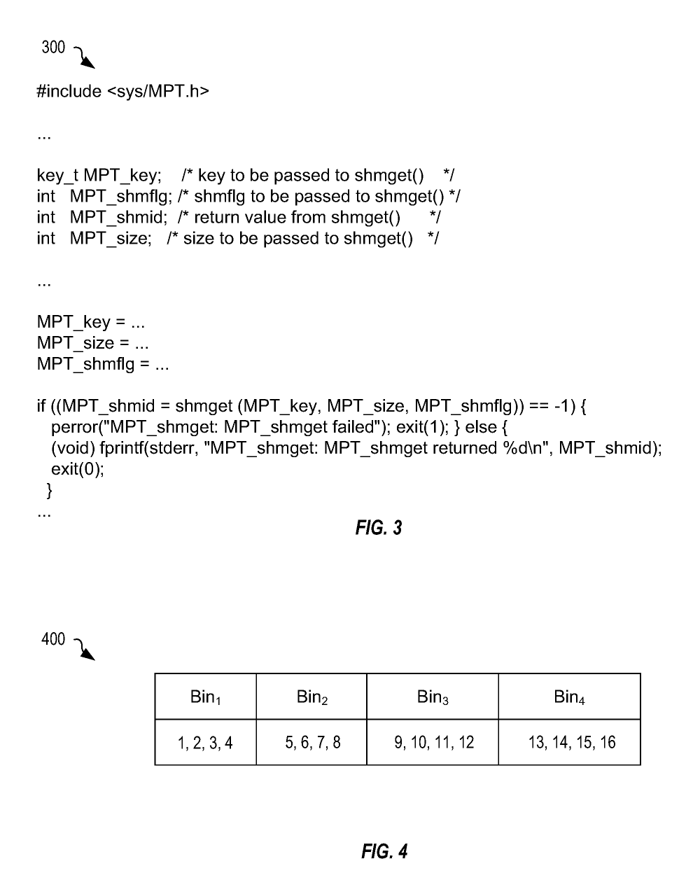

Changes to memory are tracked to detect the various data topology types. Parallel processing cluster system 11701 utilizes RAM (e.g., RAM 11720 in FIG. 117) to connect process kernels together, and thus any process kernel with the correct address and RAM key may view the RAM area 11720 without interfering with processing of that data. For example, it is possible to ghost-copy the shared data to another system (or different part of the same system) for analysis. An application first takes the job number from the RAM area and uses this job number as the RAM key. Rather than calling the standard “shmget” command to allocate a block of RAM, the application calls a modified version of “shmget”, called “MPT_shmget”. FIG. 3 shows exemplary source code 300 illustrating use of “shmget” from the system library.

The function “shmget” is defined similarly to the C-programming language functions “shmget,” “calloc” or “malloc”, with the exception that the key, size and flag parameters as well as the RAM identity (“MPT_shmid”) are accessible by a mesh-type determiner. The present mesh-type determiner is software that determines how to split a dataset among multiple servers based upon the analysis performed by the pattern detectors, either periodically or after the detection of a software interrupt causes the RAM values to be copied from the RAM area into the RAM ghost-copy area (typically a disk-storage area) along with a time stamp. Once the algorithm's run is complete, system 11700 analyzes the data within the RAM ghost-copy area to determine the mesh type. The following sections describe the dataset access patterns used to define the mesh type.

### Determine Mesh_Type_Standard

### 1-Dimensional Examples

The purpose of this mesh type is to process data sequentially in an array. The workload is assumed to remain the same regardless of the array element being processed. A profiler calculates the time it takes to process each element. The MESH_TYPE_Standard mesh type decomposes based on bins. First, MESH_TYPE_Standard creates N data bins, each bin corresponding to a computational element (server, processor, or core) count. It should be appreciated that each computational element may have one or more than one bin associated with it. Next, the array elements are equally distributed over the bins. FIG. 4 is a table 400 illustrating exemplary binning of 16 sequential data items for processing by four computational elements, each element corresponding to one of bins 1-4.

### Mesh_Type_Standard

### 1-Dimensional Static and Dynamic Object Examples

There are two analysis methods used to select the proper Mesh Type Standard (Mesh_Type_Standard) topology model: a static object method and a dynamic object method. A data object, also referred to herein as an “object,” may be any valid numeric data value whose size is greater than or equal to the array element size, up to the maximum number of elements. If the object is equal to the maximum number of elements then, by definition, the object is static. Also, if no data object changes element location(s) or changes the number of array elements that define it, then the objects are static. Alternatively, if, during the kernel processing, any data object changes element location(s) or changes the number of array elements, then those objects are dynamic.

FIG. 5 illustrates dimensional type 1 static array processing, with 1 object. FIG. 5 shows an exemplary data array 500 before an−a[x] transformation 502 is applied, and an updated array 504 that represents array 500 after transformation 502 has been applied.

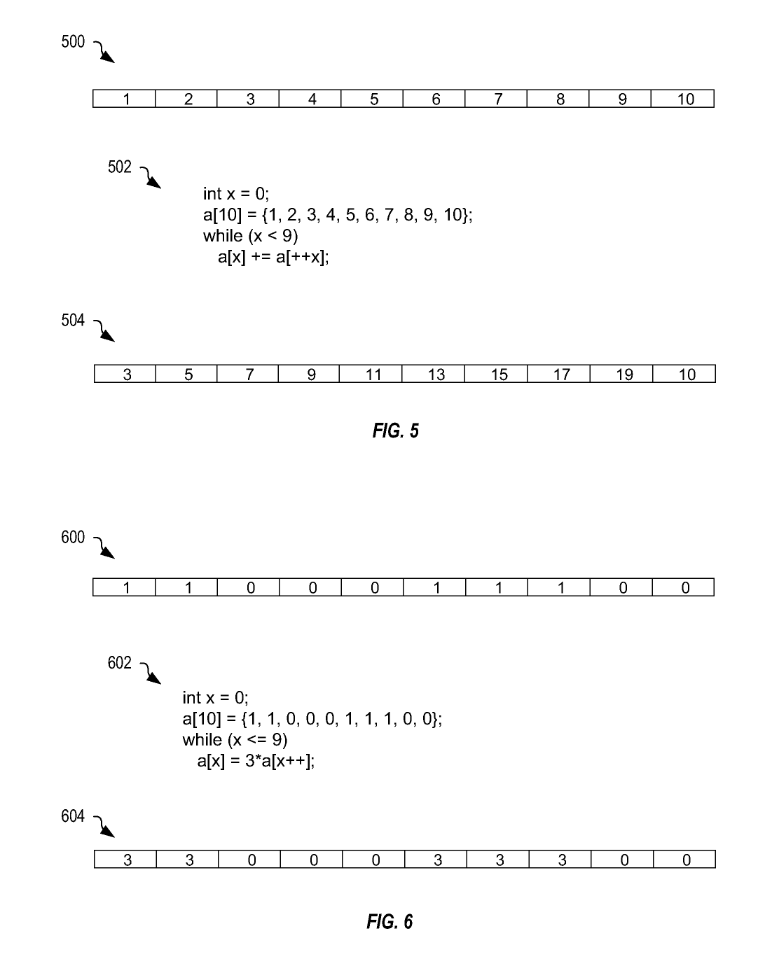

FIG. 6 illustrates dimensional type 1 static array processing, with 2 objects. FIG. 6 shows an exemplary data array 600 before an−a[x] transformation 602 is applied, and an updated array 604 that represents array 600 after transformation 602 has been applied.

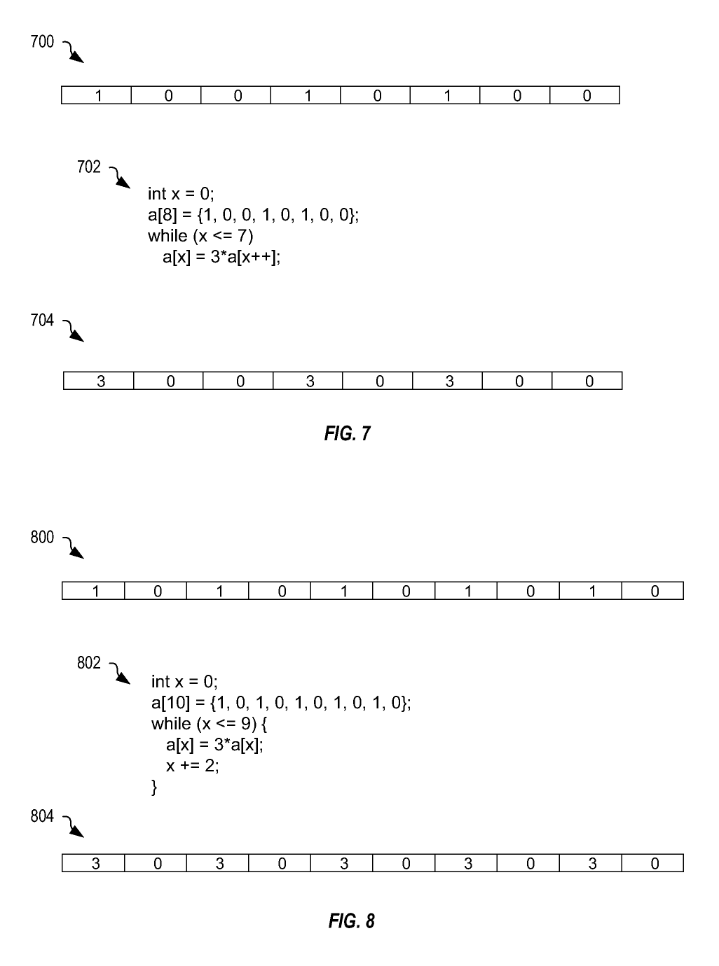

FIG. 7 illustrates Standard 1-Dimensional Static Array Processing with 3 Unevenly Spaced Objects. FIG. 7 shows an exemplary data array 700 before an−a[x] transformation 702 is applied, and an updated array 704 that represents array 700 after transformation 702 has been applied.

In FIG. 5, nine of the elements change value after the transformation, without any non-processed elements separating objects. The changes produce different values in each of the adjoining elements. In FIG. 6, there are multiple sets of adjoining processed elements separated by non-processed areas. Even though the data objects have been located because the objects do not move, the array can be treated as a standard static object.

FIG. 8 shows another type of static object which occurs where the data objects are skipped within an array. FIG. 8 shows an exemplary data array 800 before an−a[x] transformation 802 is applied, and an updated array 804 that represents array 800 after transformation 802 has been applied. This illustrates a Standard 1-Dimensional Static Array Processing, with 5 Objects Accessed by Skipping Elements.

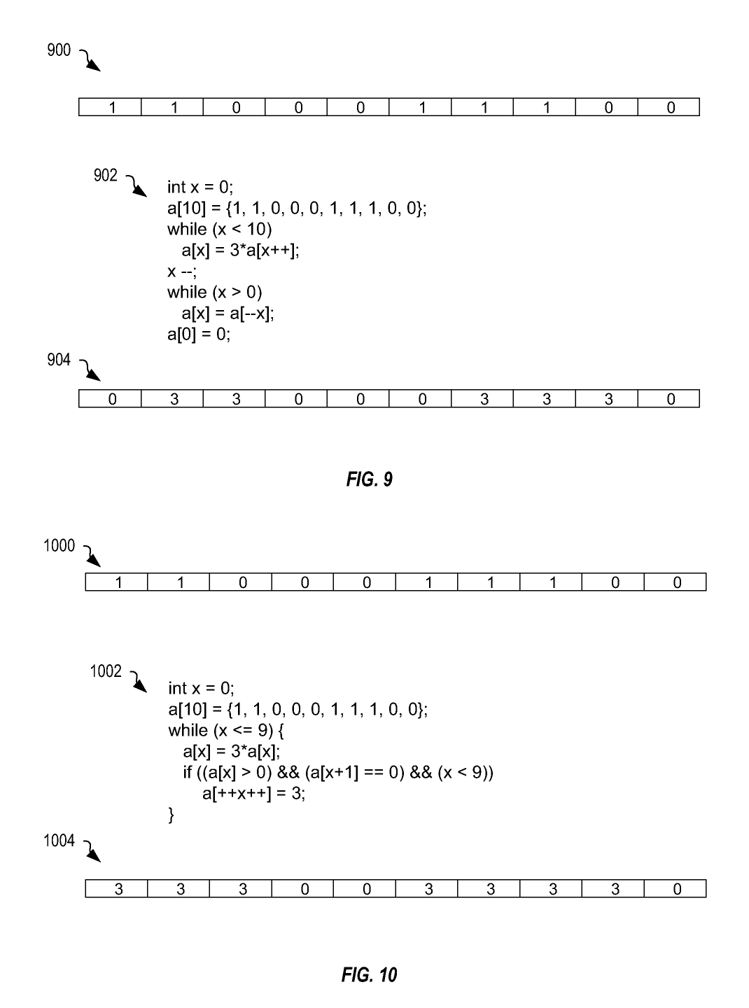

FIG. 9 illustrates Standard 1-Dimensional Dynamic Array Processing, 2 Moving Objects. FIG. 9 shows an exemplary data array 900 before an−a[x] transformation 902 is applied, and an updated array 904 that represents array 900 after transformation 902 has been applied.

FIG. 10 illustrates Standard 1-Dimensional Dynamic Array Processing, 2 Growing Objects. FIG. 10 shows an exemplary data array 1000 before an−a[x] transformation 1002 is applied, and an updated array 1004 that represents array 1000 after transformation 1002 has been applied.

The examples of FIGS. 9 and 10 represent dynamic objects; FIG. 9 shows dynamic objects because the objects are changing location and FIG. 10 shows dynamic objects because one or more of the objects change size.

The following description details which Mesh_Type_Standard model is utilized to profile kernels. While profiling a kernel, if an array of static data with the same workload is accessed sequentially, then the Mesh Type Standard (Mesh_Type_Standard) topology model with no index, stride, or overlap is used. If the processing of an array with static objects is started offset from the first element of the array then the Mesh Type Standard topology model with an index is used. If the processing of an array with static objects is started whereby the distance between accessed objects is fixed, or the kernel accesses the static data by evenly skipping some elements, then the Mesh Type Standard topology with stride is used. If the kernel accesses multiple, static, non-evenly spaced objects then the size of the objects defines the number of bins possible; in addition, overlap between bins is defined to be twice the size of the largest object. If an array of dynamic data with the same workload is accessed then the Mesh Type Standard topology model with overlap is used. The size of the overlapped area is twice the maximum data object size encountered.

In addition, the various Mesh Type Standard topology models can be combined together to generate, for example, the following Mesh Type Standard topology models: index, stride, index-with-stride, index-with-overlap, stride-with-overlap, and index-with-stride-with-overlap. Mesh_Type_Standard, Ring Data Structure Example

If the ends of an array meet during processing, then the array is considered a ring structure. A ring structure is only relevant to dynamic data objects. Below are examples of dynamic data objects using a ring structure.

FIG. 11 illustrates Standard 1-Dimensional Dynamic Array Processing, 2 Objects Moving Around a Ring. FIG. 11 shows an exemplary data array 1100 before an−a[x] transformation 1102 is applied, and an updated array 1104 that represents array 1100 after transformation 1102 has been applied.

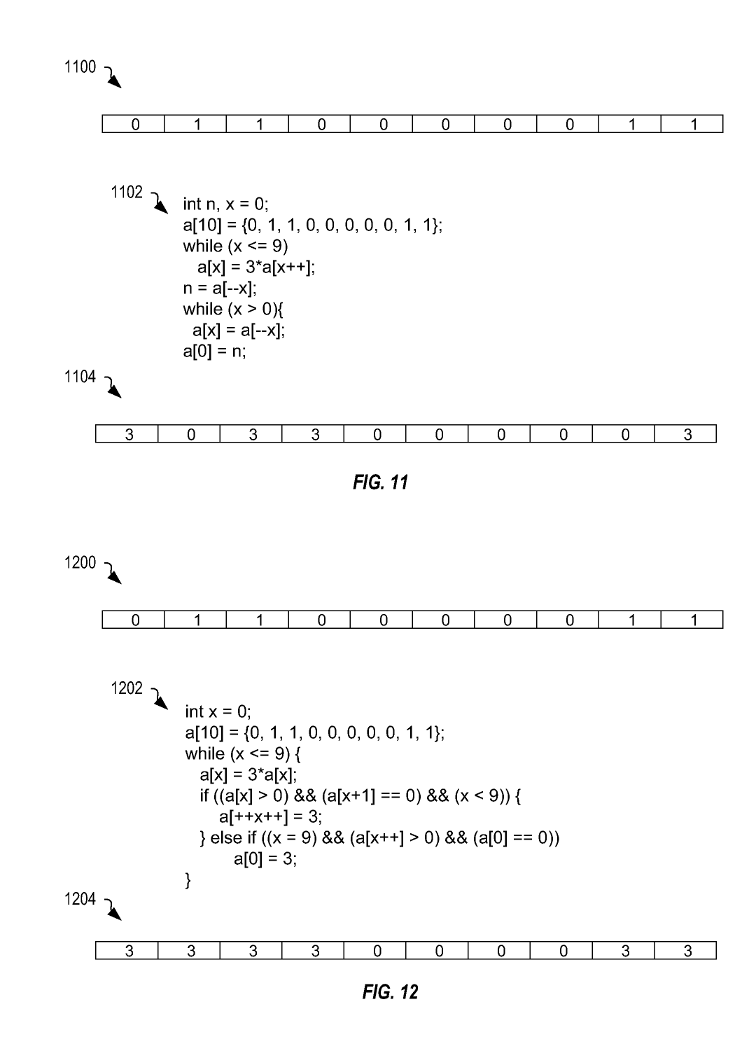

FIG. 12 illustrates Standard 1-Dimensional Dynamic Array Processing, 2 Objects Growing Around a Ring. FIG. 12 shows an exemplary data array 1200 before an−a[x] transformation 1202 is applied, and an updated array 1204 that represents array 1200 after transformation 1202 has been applied.

### Mesh_Type_Standard

### 1-Dimensional Unbalanced Workload Example

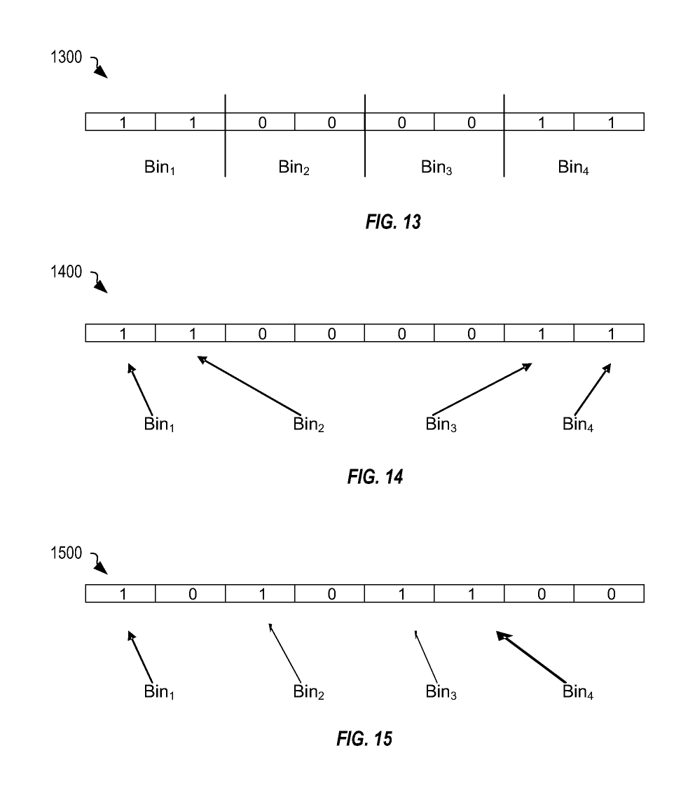

For sake of clarity, FIGS. 13 and 14 should be viewed together. Static data objects may be randomly concentrated in only a few of the potential data bins. When this is detected, the system topology must balance the workload by balancing the number of data objects per bin. FIG. 13 shows an example of four data objects (data objects 1302-1308) concentrated at the ends of an array 1300 (bin 1 and bin 4), illustrating an unbalanced workload, wherein bin 2 and bin 3 have no work.

In order to balance the work, pointers (e.g., point 1402-1408, FIG. 14) are associated with each data object 1302-1308. Each pointer is then referenced by a bin, for example, bin 1 references pointer 1402, as shown in FIG. 14. FIG. 14 illustrates balancing a workload from unbalanced data object locations within an array 1400 through the use of pointers.

With a single level of indirection, that is, associating data objects with bin through the use of pointers, it is possible to balance the work generated from static, randomly placed data objects. This model allows each bin to contain whatever data objects are required to balance the work.

### Mesh_Type_Standard

### 1-Dimensional Variable-Grid Example

A one-dimension variable-grid topology may occur after some number of data movement cycles, wherein the data objects change concentration and, thus, workload. By way of example, assume the balanced workload scenario shown in FIG. 14 where points are used to associate data objects with bins. In the example of FIG. 15, after some number of data movements, the four data objects are located as shown in FIG. 15. By updating pointers 1402-1408, a balanced workload in maintained.

### Mesh_Type_Standard

### 1-Dimensional Examples: Index, Stride, Index-with-Stride, and Overlap Example Data Decomposition Calculations

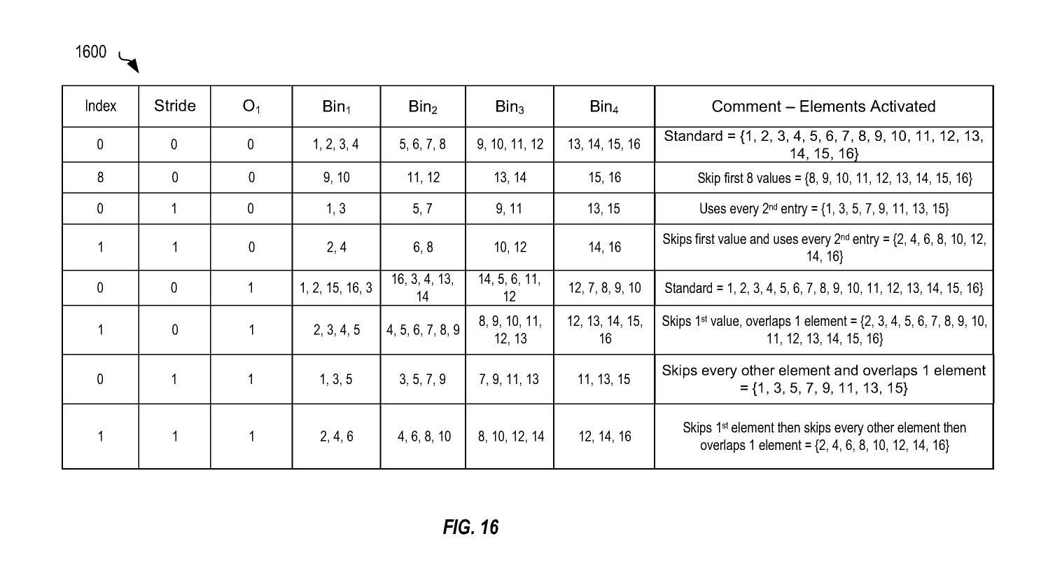

There are three parameters that, taken together, create the data topology for this mesh type. The parameters are index, stride, and overlap (“overlap” is shown as O₁ in FIG. 16). FIG. 16 shows one exemplary table 1600 illustrating Dimensional Standard Dataset Topology with Index, Stride, Index-with-Stride, Overlap, Index-with-Overlap, Stride-with-Overlap, and Index-with-Stride-with-Overlap. FIG. 16 shows examples that may be produced by applying the three parameters index, stride, and overlap to the example given in FIG. 4.

### Mesh_Type_Standard

### 2-Dimensional Examples

The Mesh Type Standard topology method may be extended to two dimensions as long as the amount of work per element remains the same. FIG. 17 shows an exemplary two dimensional standard dataset topology 1700.

### Mesh_Type_Standard

### 2-Dimensional Static and Dynamic Object Examples

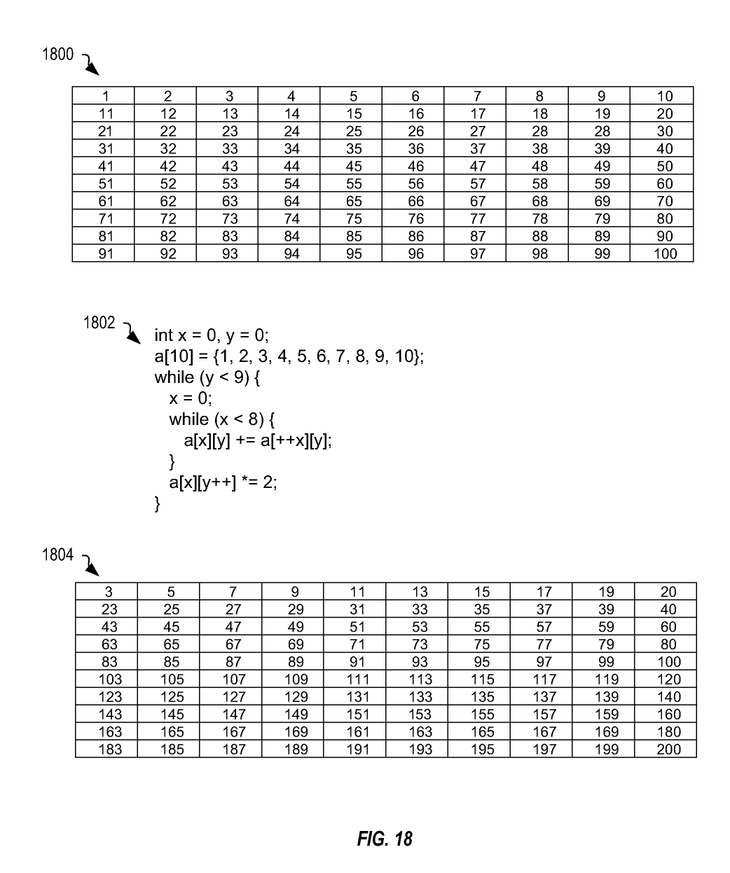

As with the single-dimensional MESH TYPE STANDARD model, the 2-dimensional version has both static and dynamic objects. Because of the extra dimension, the data objects' definitions are extended into the second dimension. Dynamic data objects can grow and move in both dimensions as well. FIG. 18 illustrates a Standard 2-Dimensional Static Array Processing, with 1 Large Data Object. FIG. 18 shows on exemplary two-dimensional table 1800 of static objects prior to applying an−a[x][y] transformation 1802, and an updated array 1804 that represents array 1800 after transformation 1802 has been applied.

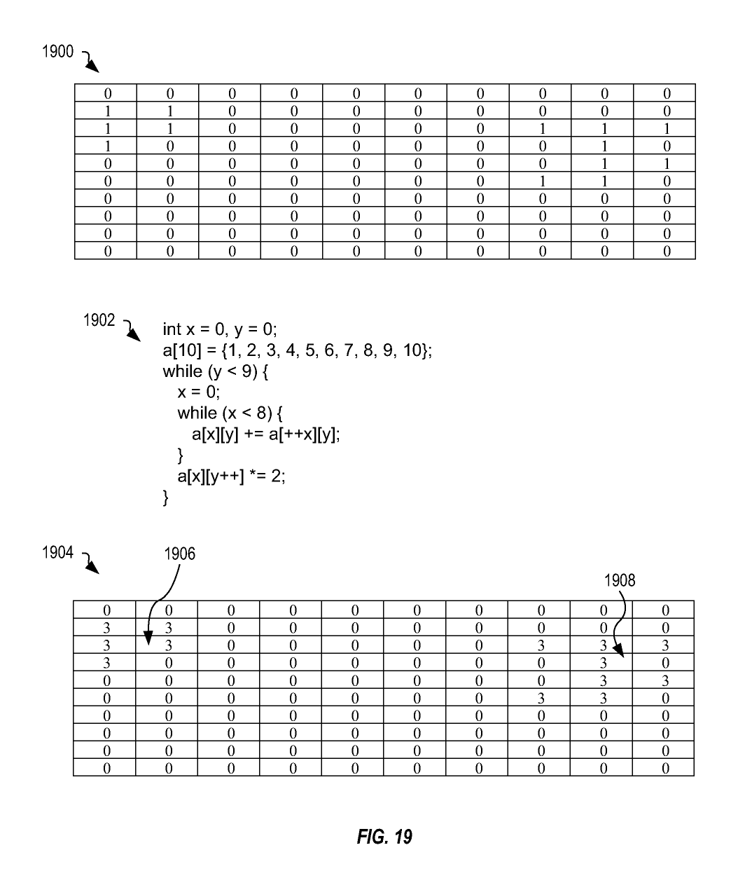

FIG. 19 illustrates a Standard 2-Dimensional Static Matrix Processing, with 2 Small Data Objects. FIG. 19 shows on exemplary two-dimensional table 1900 of static objects prior to an−a[x][y] transformation 1902 is applied, and an updated array 1904 that represents array 1900 after transformation 1902 has been applied.

Note the differences between FIG. 18 and FIG. 19. In reference to FIGS. 18 and 19, an object is a group of non-zero valued, adjacent elements and a non-processed element is an element that does not change value during processing/transformation, e.g. an element with a zero value as seen in FIG. 19. Also, non-processed elements may separate objects. In FIG. 18, all one hundred data elements change values after processed by transformation 1802 without any non-processed elements separating objects. That is, tables 1800 and 1804 do not contain any zero values (non-processed elements) which isolate objects from one another. Furthermore, the changes produce different values in each of the adjoining elements. In FIG. 19, there are two objects, objects 1906 and 1908, consisting of adjoining processed elements separated by non-processed areas. Even though there are multiple objects, the objects are locatable because the objects do not move; thus, the array can be treated as a standard static object.

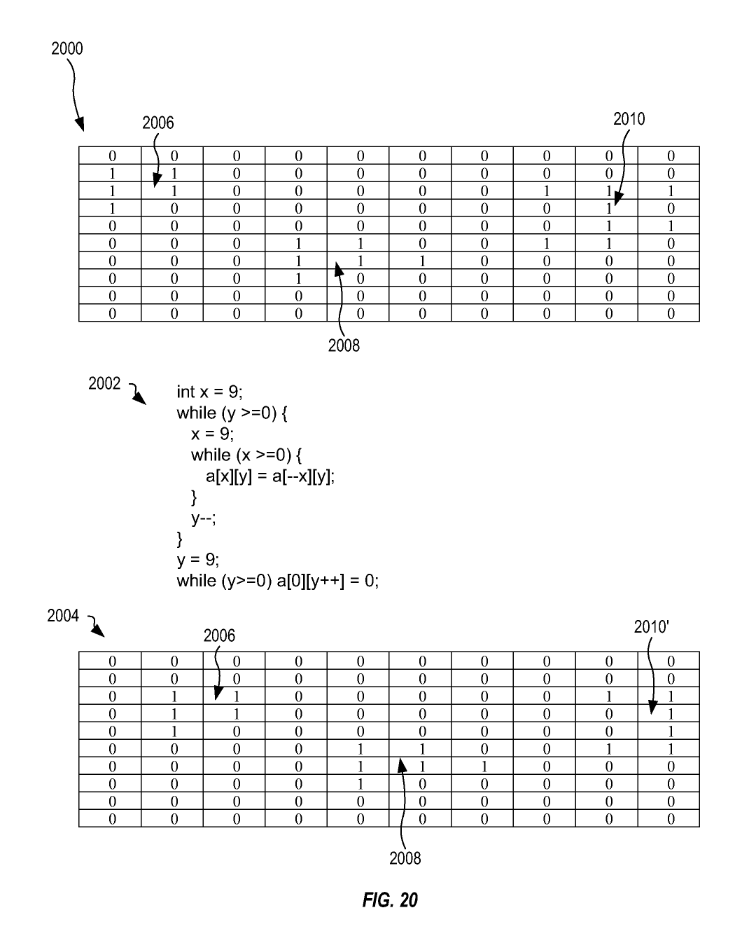

FIG. 20 illustrates a Standard 2-Dimensional Dynamic Array Processing, with 2 Moving Objects. FIG. 20 shows on exemplary two-dimensional table 2000 of objects, objects 2006, 2008 and 2010, prior to applying-a[x][y] transformation 2002, and an updated array 2004 that represents array 2000 after transformation 2002 has been applied. Object 2010 is transformed into object 2010′ due to the rightmost elements of object 2010 being shifted out of the array when transformation 2002 is applied to table 2000. The “After Transformation” table 2004 shown in FIG. 20 shows the effect of objects moving across the x-axis of a 2-dimensional Cartesian space. Since the space is finite, the objects effectively “fall out” of the space. If this were a 2-dimensional toroid then one plus the last x-axis index value would be the first x-axis index value. The y-axis behaves similarly, one plus the maximum y-value of a 2-dimensional toroid would equal the first y-axis index value.

### Mesh_Type_Standard

### 2-Dimensional Examples: Index, Stride, Index-with-Stride, and Overlap Data Decomposition Calculations

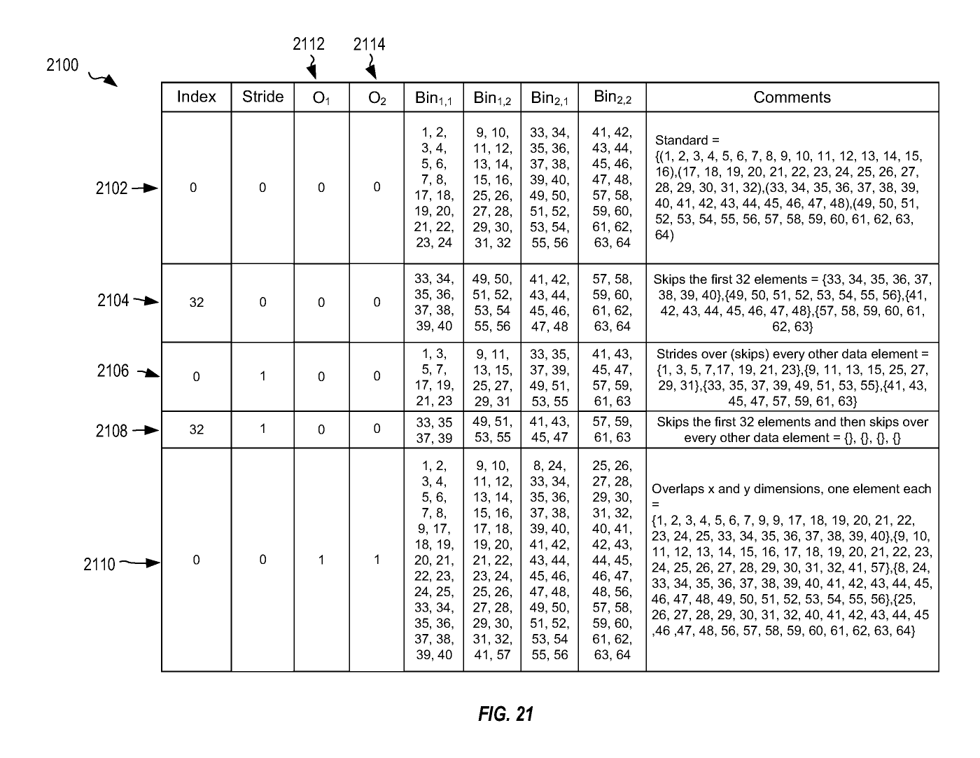

As in the one-dimensional case, the actual topology occurs with the aid of the index, stride, and overlap parameters. FIG. 21 shows a Standard 2-Dimensional Alternating Dataset Topology 2102 and four additional examples, which include 2-Dimensional Alternating Dataset Topology with Index 2104, Stride 2106, Index-with-Stride 2108, and Overlap 2110 Examples. Note that each dimension has its own overlap parameter, Overlap 2112 and 2114.

### Mesh_Type_Standard

### 3-Dimensional Examples

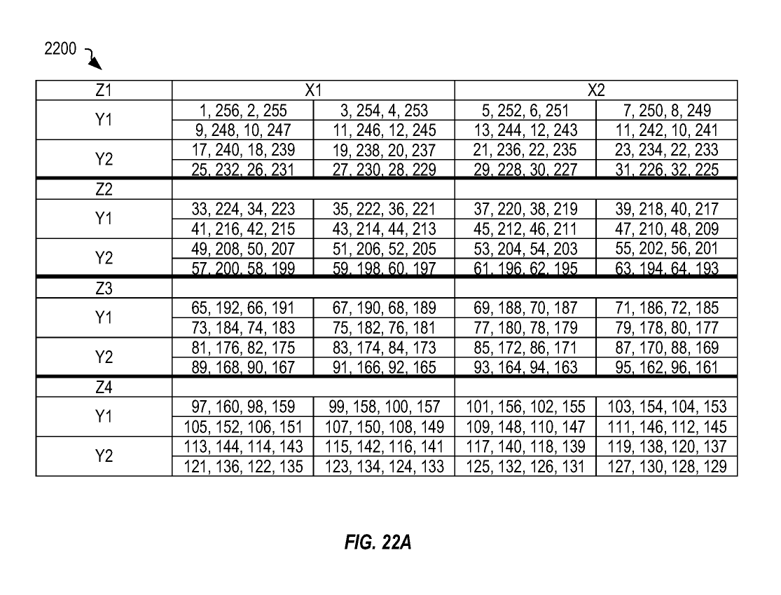

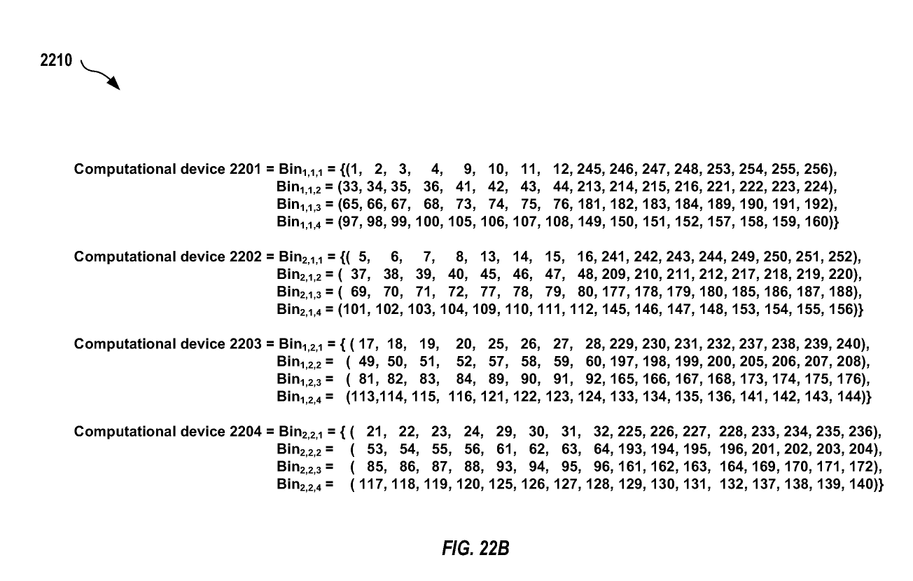

FIG. 22 illustrates one exemplary 3-Dimensional Standard Dataset Topology. FIG. 22 shows a table 2200, formed by a mesh type alternate topology method, which can be extended to three dimensions as long as all dimensions are monotonic. Table 2210 shows exemplary computational devices 2201, 2202, 2203, and 2204. In the example of FIG. 22, each computational device 2201, 2202, 2203, and 2204 includes four 3-dimensional bins, (e.g., device 1 has bin_{1,1,1}, bin_{1,1,2}, bin_{1,1,3}, and bin_{1,1,4}). Each bin includes a plurality of data points as distributed by the exemplary mesh type alternate topology method of table 2200.

### Mesh_Type_Standard

### 3-Dimensional Examples: Index, Stride, and Overlap Data Decomposition Calculations

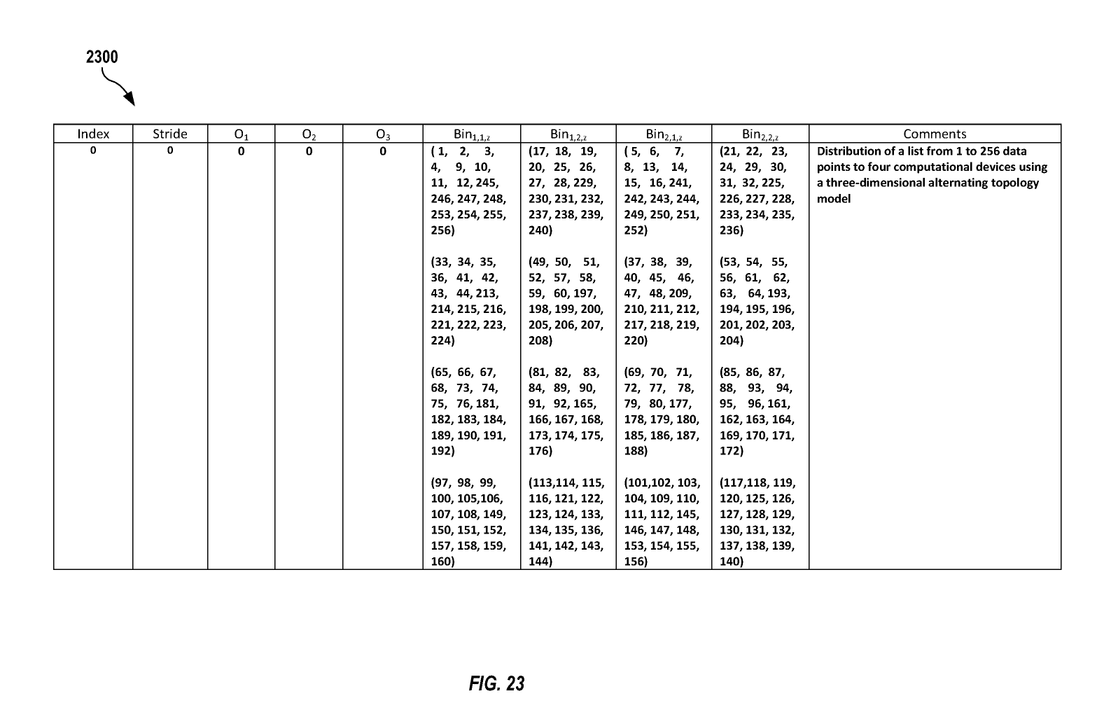

FIGS. 23-26 show four examples of 3-Dimensional Mesh_Type_Standard decomposition utilizing Index, Stripe and Overlap. Similar to the one- and two-dimensional cases, the 3-dimensional topology occurs with the aid of the index and step parameters, but with the added complexity of a third dimension. Below shows four examples of three-dimensional alternating topology.

FIG. 23 shows the distribution of 1 to 256 data points to four computational devices using a three-dimensional alternating topology model.

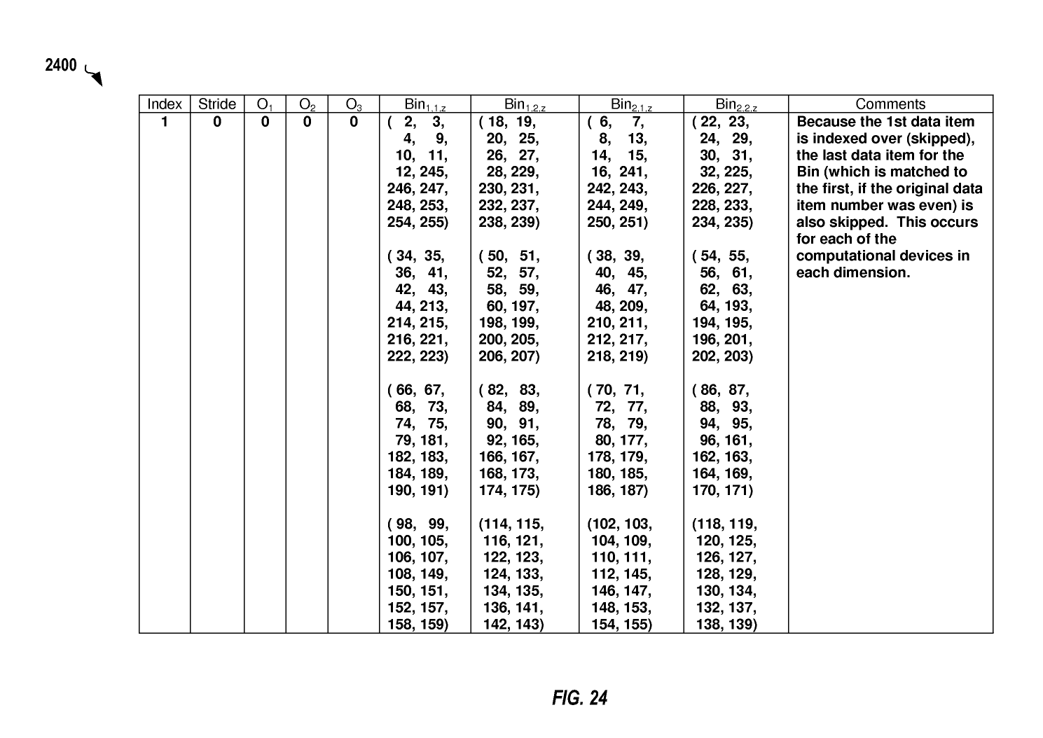

FIG. 24 shows the distribution of data points to four computational devices utilizing an Index=1. In the example of FIG. 24, the 1^{st} data item is indexed over (skipped) and the last data item for the bin (which is matched to the first, if the original data item number was even) is also skipped. Skipping the first and last data item occurs for each of the computational devices in each dimension.

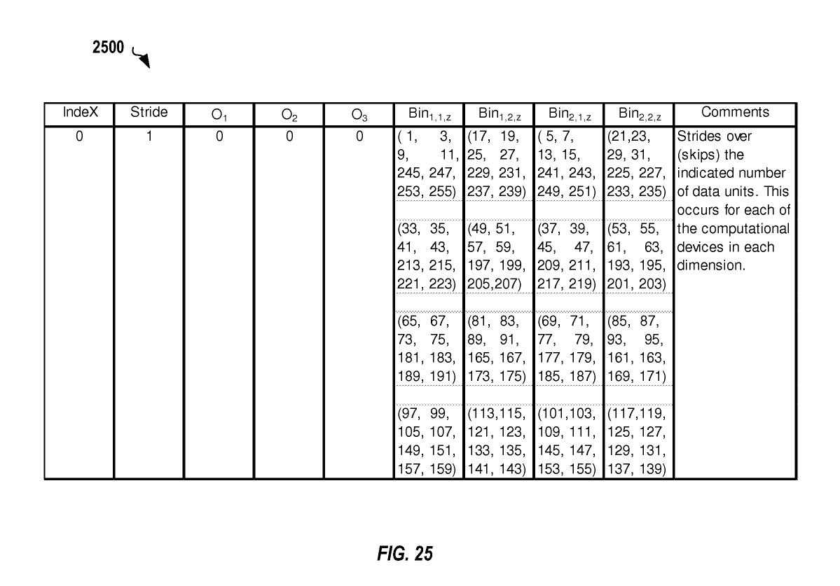

FIG. 25 shows the distribution of data points to four computational devices utilizing Stride=1. In the example of FIG. 25, with Stride=1, the distribution method strides over (skips) every other data unit. That is, if Stride=0, then bin_{1,1,1} would receive data units {(1, 2, 3, 4, 9, 10, 11, 12, 245, 246, 247, 248, 253, 254, 255, 256). With Stride=1, then bin_{1,1,1} receives data units (1, 3, 9, 11, 245, 247, 253, 255), such that data units (2, 4, 10, 12, 246, 248, 254, 256) are skipped. This occurs for each of the computational devices in each dimension.

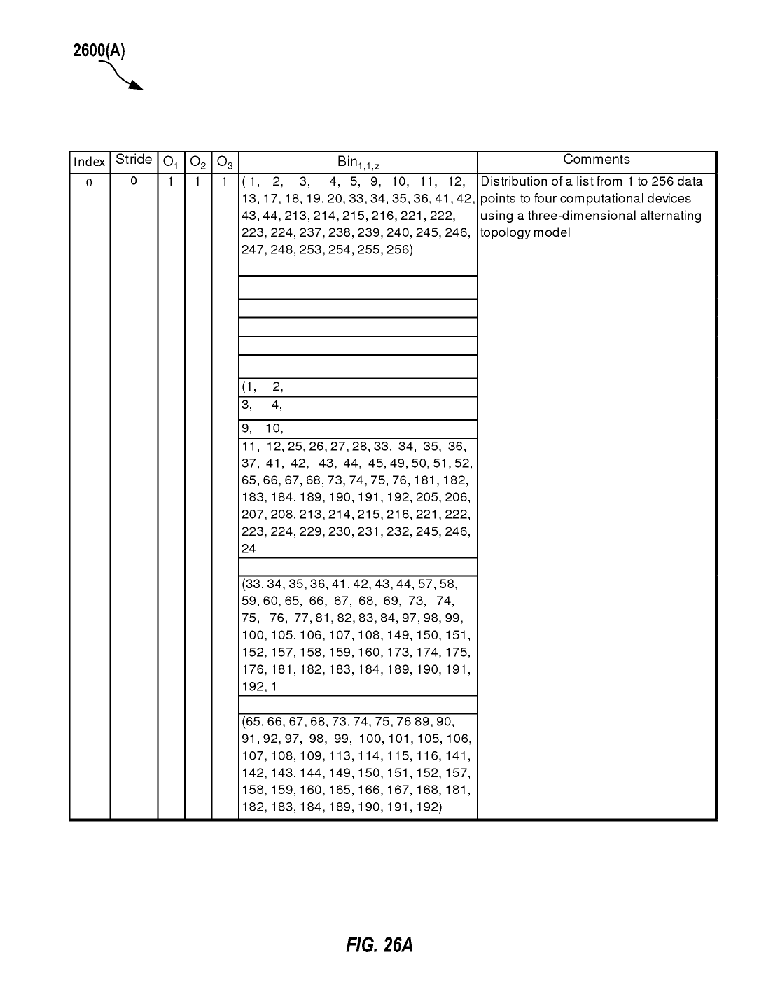

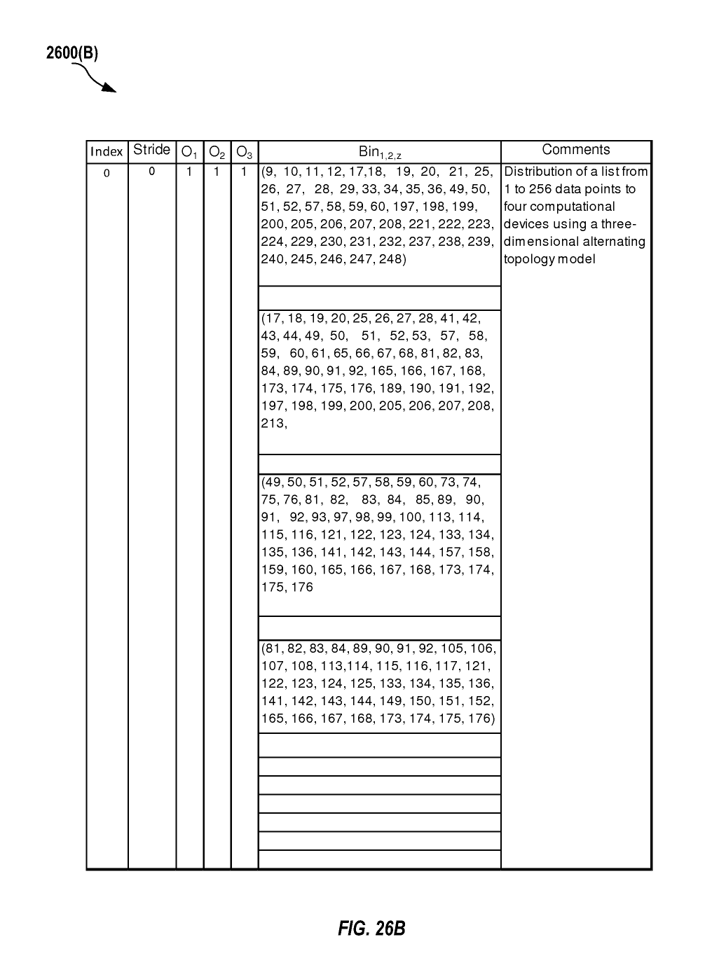

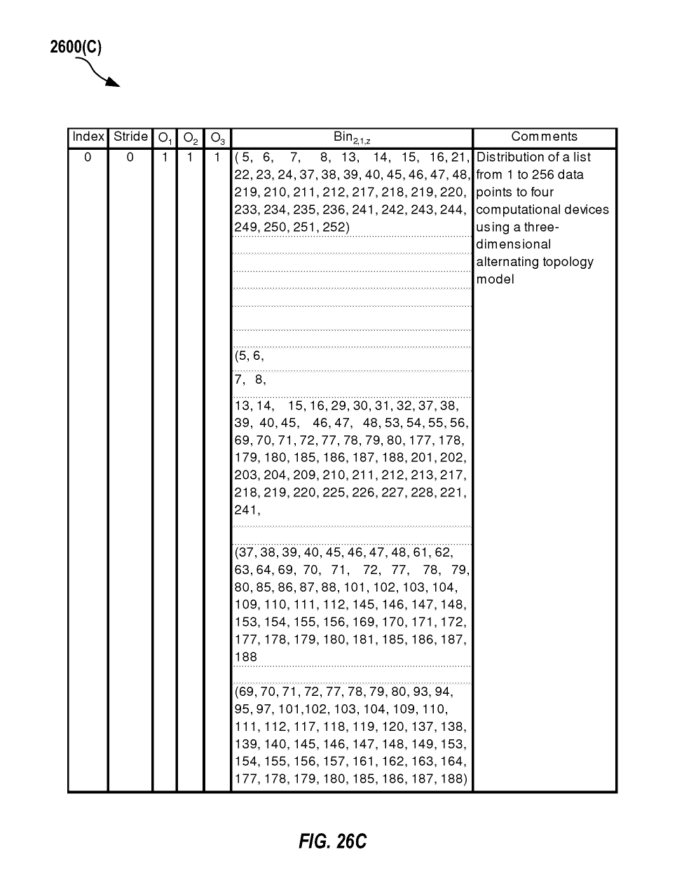

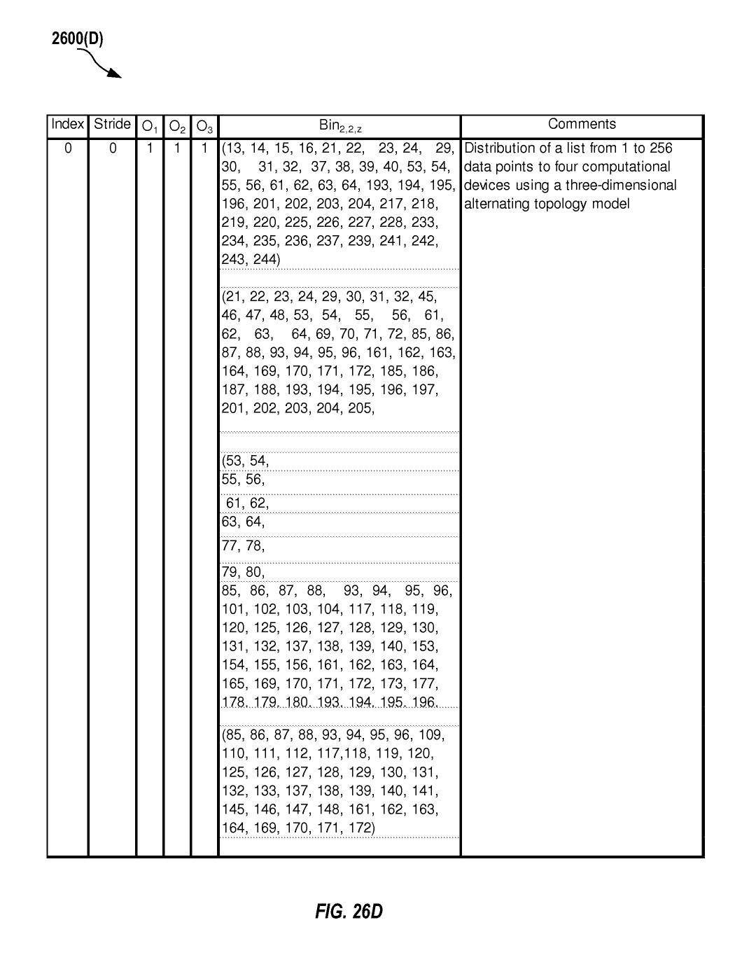

FIG. 26 shows the distribution of data points to four computational devices by overlapping the x, y and z dimensions by one element each. It will be appreciated that each dimension has its own overlap parameter. In the present example, the overlap parameters of the x, y, and z dimensions are O₁, O₂ and O₃, respectively. Therefore, in the example of FIG. 26, overlapping the x, y and z dimensions by one element each is selecting the Overlap to be O₁=O₂=O₃=1.

### Determine Mesh_Type_Alternate

### 1-Dimensional Examples

The purpose of Mesh_Type_ALTERNATE mesh type is to provide load balancing when there is a monotonic change to the workload as a function of the data item used. A profiler calculates the time it takes to process each element. If the processing time either continually increases or continually decreases then there is a monotonic change to the workload. The Mesh_Type_ALTERNATE mesh type decomposes based upon first creating N data bins, each bin corresponding to a computational element (server, processor, or core) count. Next, alternating data positions are added to each bin.

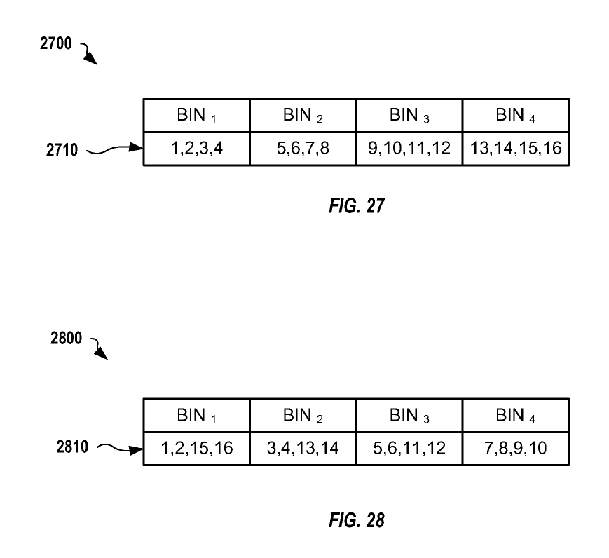

By way of comparison, if data positions are added to each bin without alternation (e.g. as in a one-dimensional standard method), then an imbalance in processing time would occur. One example of this is where the workload grows linearly (that is, if time between data movements grows linearly) as depicted by the dataset {1, 2, 3, 4, 5, 6, 7, 8, 9, 10, 11, 12, 13, 14, 15, 16}, where this series represents increasing time. Adding each increasing term to four computational elements (represented by the bins) in the order of occurrence would generate computational element imbalances; for example, as shown in table 2700 of FIG. 27:
bin₁={1, 2, 3, 4}, average processing time=(1+2+3+4)/4=2.5 time units per data item,
bin₂={5, 6, 7, 8}, average processing time=(5+6+7+8)/4=6.5 time units per data item,
bin₃={9, 10, 11, 12}, average processing time=(9+10+11+12)/4=10.5 time units per data item,
bin₄={13, 14, 15, 16}, average processing time=(13+14+15+16)/4=14.5 time units per data item.

This means that, due to the imbalance in processing time, it would take 14.5 time units (the longest binned-group time) to complete the work. Alternatively, if a one-dimensional alternating dataset topology is used, as shown in table 2800 of FIG. 28, then:
Computational device 1=bin₁={1, 16, 2, 15}, average processing time=8.5 time units per data item,
Computational device 1=bin₂=(3, 14, 4, 13), average processing time=8.5 time units per data item,
Computational device 1=bin₃={5, 12, 6, 11}, average processing time=8.5 time units per data item,
Computational device 1=bin₄={7, 10, 8, 9}, average processing time=8.5 time units per data item.

Thus, the one-dimensional alternating dataset topology is 1.7 (14.5/8.5) times faster than the one-dimensional standard method.

It will be appreciated that the one-dimensional, alternating dataset topology method can have alternative and/or expanded functionality, such as Index functionality and Stride functionality (described above).

### Mesh_Type_Alternate

### 1-Dimensional Static and Dynamic Object Examples

Two analysis methods may be used to select the proper Mesh Type Alternate topology model: the static-object method and the dynamic-object method. The term object refers to a data object. A data object can be any valid numeric data value whose size is greater than or equal to the array element size, up to the maximum number of elements. A data object is a static data object (1) if the data object is equal to the maximum number of elements or (2) if no data object changes element location(s) or changes the number of array elements that define it. A data object is dynamic if, during the kernel processing, any data object changes element location(s) or changes the number of array elements that define them.

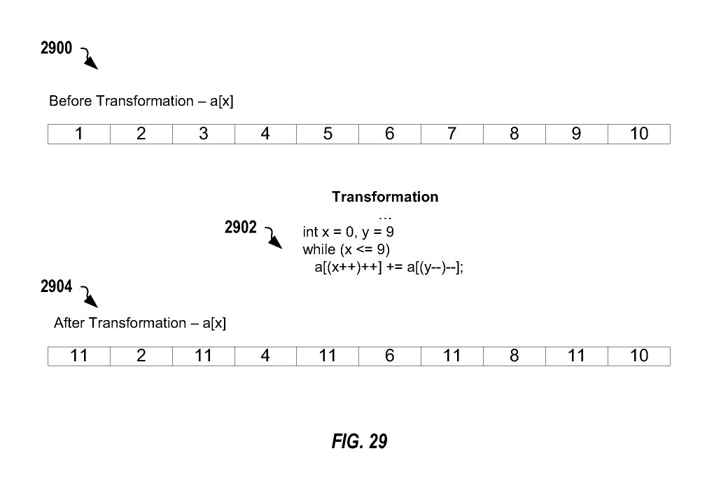

FIG. 29 shows one exemplary 1-dimensional table 2900 of static objects prior to applying an−a[x][y] transformation 2902, and an updated array 2904 that represents array 2900 after transformation 2902 has been applied.

In the process of profiling a kernel, if the kernel only accesses data sequentially then single-dimension Mesh Type Alternate topology model with no Index, Stride, or Overlap is used. Alternatively, if the kernel sequentially accessed data, but begins the sequential data access within the array at a location that is greater than the starting address, then the Mesh Type Alternate topology with Index model is used. If the processing accesses elements of the array by evenly skipping elements, then the Mesh Type Alternate topology model with Stride is used.

### Mesh_Type_Alternate

### 1-Dimensional Examples: Index, Stride, and Overlap Data Decomposition Calculations

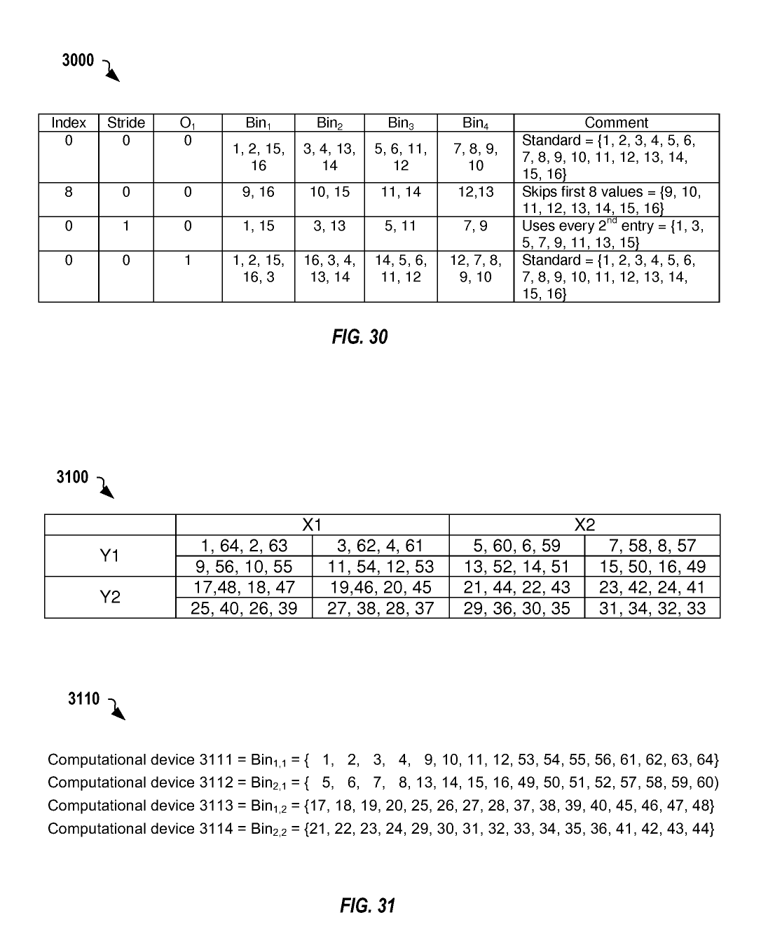

FIG. 27 shows data positions added to bins in a one-dimensional standard dataset topology. FIG. 28 shows data positions added to bins in a one-dimensional alternating dataset topology. The Index, Stride, and Overlap parameters are three parameters that, taken together, create the actual data topology for Mesh_Type_Alternate mesh type. These three parameters are applied to the example shown in FIG. 28 to produce table 3000 shown in FIG. 30, a 1-Dimensional Alternating Dataset Topology with Index, Stride, and Overlap.

The Index parameter is the starting data position for the topology. The Stride parameter represents the number of data elements to skip when stepping through the dataset during topology. The Overlap parameter is used to define the number of data elements overlapped at the data boundary of two bins.

### Mesh_Type_Alternate

### 2-Dimensional Examples

The Mesh Type Alternate topology method can be extended to two dimensions as long as both dimensions are monotonic. FIG. 31 shows one example of the alternate topology in two dimensions, table 3100.

FIG. 31 illustrates one exemplary 2-Dimensional Mesh Type Alternate topology. FIG. 31 shows a table 3100, formed by a mesh type alternate topology method, which can be extended to two dimensions as long as all dimensions are monotonic. Table 3110 shows exemplary computational devices 3111-3114. In the example of FIG. 31, each computational device 3111-3114 includes a 2-dimensional bin, (e.g., device 3111 has bin_{1,1}, device 3112 has bin_{2,1}, etc.). Each bin includes a plurality of data points as distributed by the exemplary mesh type alternate topology method of table 3100.

### Mesh_Type_Alternate

### 2-Dimension Examples: Index, Stride, and Overlap Data Decomposition Calculations

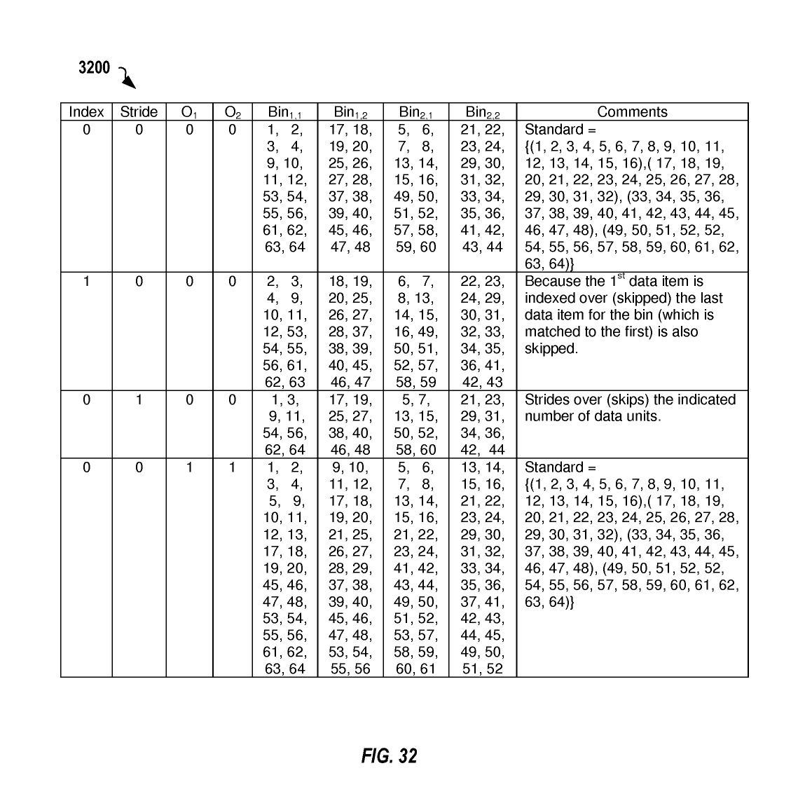

As in the one-dimensional case, the actual topology occurs with the aid of the Index, Stride, and Overlap parameters. FIG. 32 shows four examples of 2-Dimensional Alternating dataset topology within table 3200. The first example has Index=Stride=O₁=O₂=0. The second example has Index=1 and Stride=O₁=O₂=0. The third example has Stride=1 and Index=O₁=O₂=0. The fourth example has O₁=O₂=1 and Index=Stride=0. Note that each dimension has its own overlap parameter.

### Mesh_Type_Alternate

### 3-Dimensional Examples

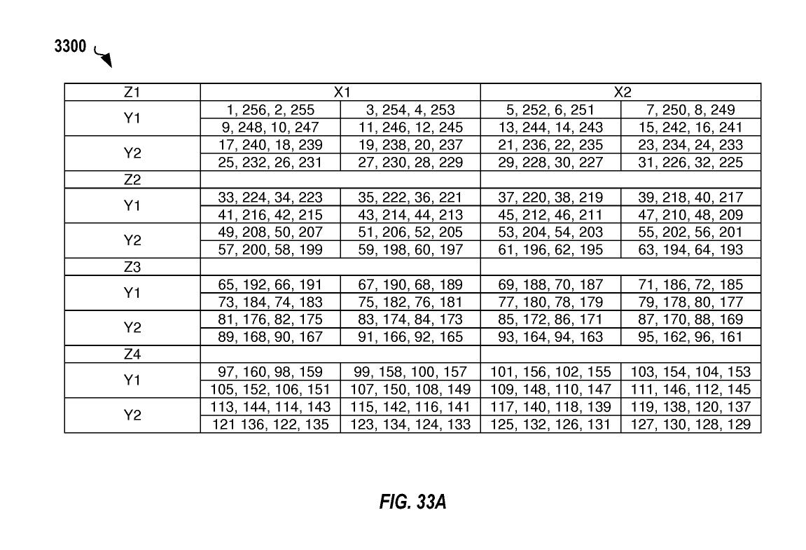

The Mesh Type Alternate topology method can be extended to three dimensions as long as all dimensions are monotonic. FIG. 33 shows one exemplary alternate topology in three dimensions, table 3300. Table 3310 shows exemplary computational devices 3311-3314. In the example of FIG. 33, each computational device 3311-3314 includes four 3-dimensional bins, (e.g., device 3311 has bin_{1,1,1}, bin_{1,1,2}, bin_{1,1,3}, bin_{1,1,4}; device 3312 has bin_{2,1,1}, bin_{2,1,2}, bin_{2,1,3}, bin_{2,1,4}, etc.). Each bin includes a plurality of data points as distributed by the exemplary mesh type alternate topology method of table 3300.

### Mesh_Type_Alternate

### 3-Dimensional Examples: Index, Stride, and Overlap Data Decomposition Calculations

Although the three dimensional examples are not shown, it will be appreciated that, as is the case with the one- and two-dimensional, the 3-dimensional Mesh_TYPE_ALTERNATE topology occurs with the aid of the Index, Stride and Overlap.

### Mesh_Type_Cont_Block

### 1-Dimensional Example

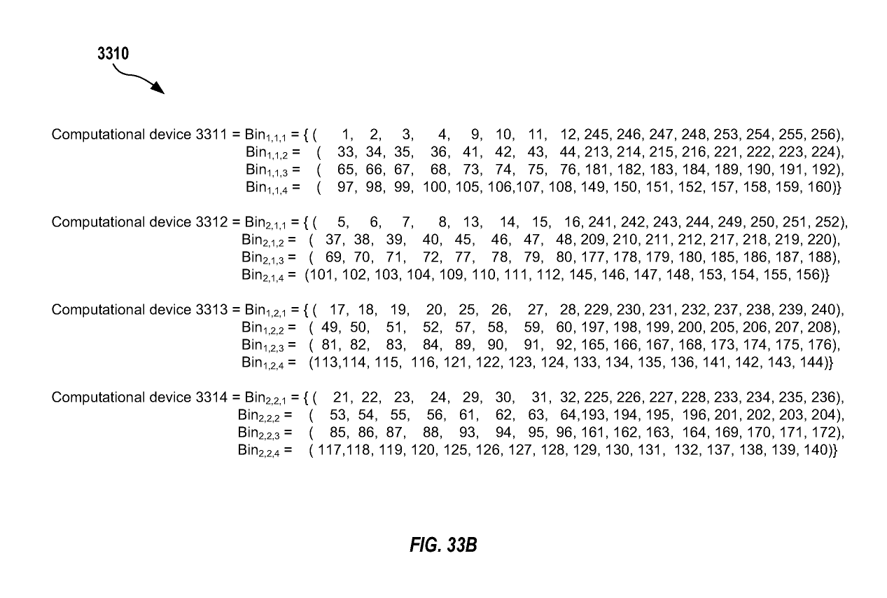

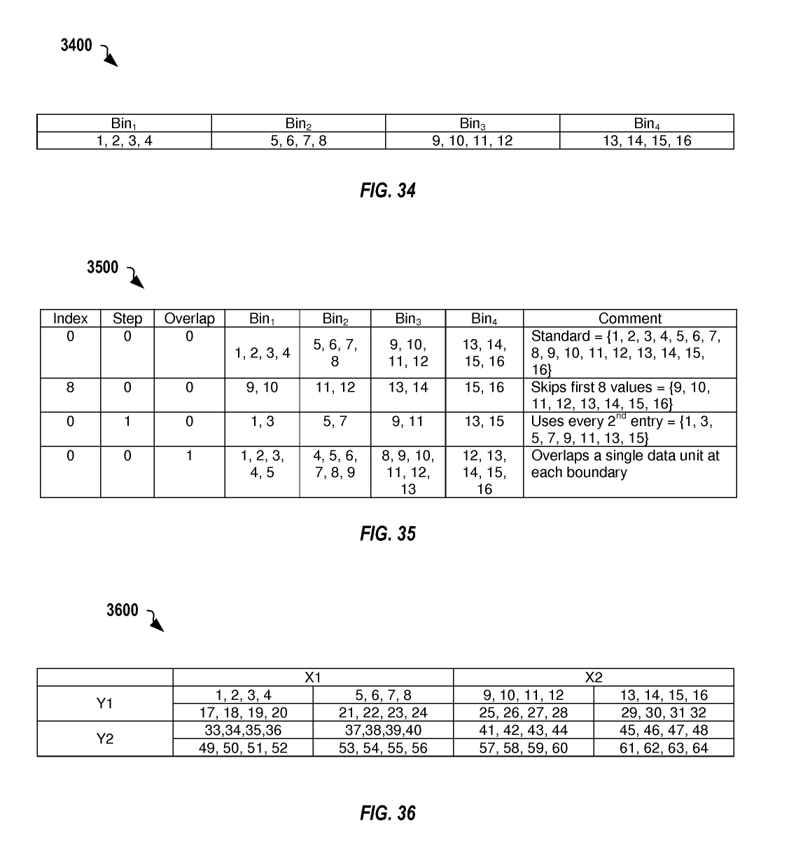

The purpose of the MESH_TYPE_CONT_BLOCK mesh type is to evenly decompose a dataset into blocks. The present example is a one-dimensional block example. MESH_TYPE_CONT_BLOCK mesh type may be utilized for many simple linear data types. In a first step, bins corresponding to the number of computation elements are created. In a second step, blocks of data are placed into bins, allowing evenly distributed blocks of data to be accessed, for example, as shown in the one-dimensional block topology table 3400, FIG. 34.

In the one-dimensional case shown in table 3400, the following information is saved as follows:
Bin₁={1, 2, 3, 4},
Bin₂={5, 6, 7, 8},
Bin₃={9, 10, 11, 12},
Bin₄={13, 14, 15, 16}.

Thus, computational element 1 corresponds to Bin₁, computational element 2 corresponds to Bin₂, computational element 3 corresponds to Bin₃, and computational element 4 corresponds to Bin₄.

### Mesh_Type_Cont_Block

### 1-Dimensional Examples: Index, Step, and Overlap Data Decomposition Calculations

As with the above examples, there are three parameters that, taken together, create the actual data topology for this mesh type: index, step and overlap. Applying these three parameters to the example of table 3400, FIG. 34, produces the 1-Dimensional Continuous Block Dataset Topology with Index, Step, and Overlap shown in table 3500, FIG. 35.

### Mesh_Type_Cont_Block

### 2-Dimensional Example

The continuous block model of dataset topology can be extended to two dimensions. This mesh type is useful for non-FFT-related image processing. Table 3600, FIG. 36, shows an example of the 2-Dimensional Continuous Block Topology.

In the two-dimensional example of table 3600, computational element 1=Bin_{1,1}, computational element 2=Bin_{1,2}, computational element 3=Bin_{2,1} and computational element 4=Bin_{2,2}, such that data is distributed as follows:
Bin_{1,1}={1, 2, 3, 4, 5, 6, 7, 8, 17, 18, 19, 20, 21, 22, 23, 24},
Bin_{2,1}={9, 10, 11, 12, 13, 14, 15, 16, 25, 26, 27, 28, 29, 30, 31, 32},
Bin_{1,2}={33, 34, 35, 36, 37, 38, 39, 40, 49, 50, 51, 52, 53, 54, 55, 56},
Bin_{2,2}={41, 42, 43, 44, 45, 46, 47, 48, 57, 58, 59, 60, 61, 62, 63, 64}

### Mesh_Type_Cont_Block

### 2-Dimensional Examples: Index, Step, and Overlap Data Decomposition Calculations

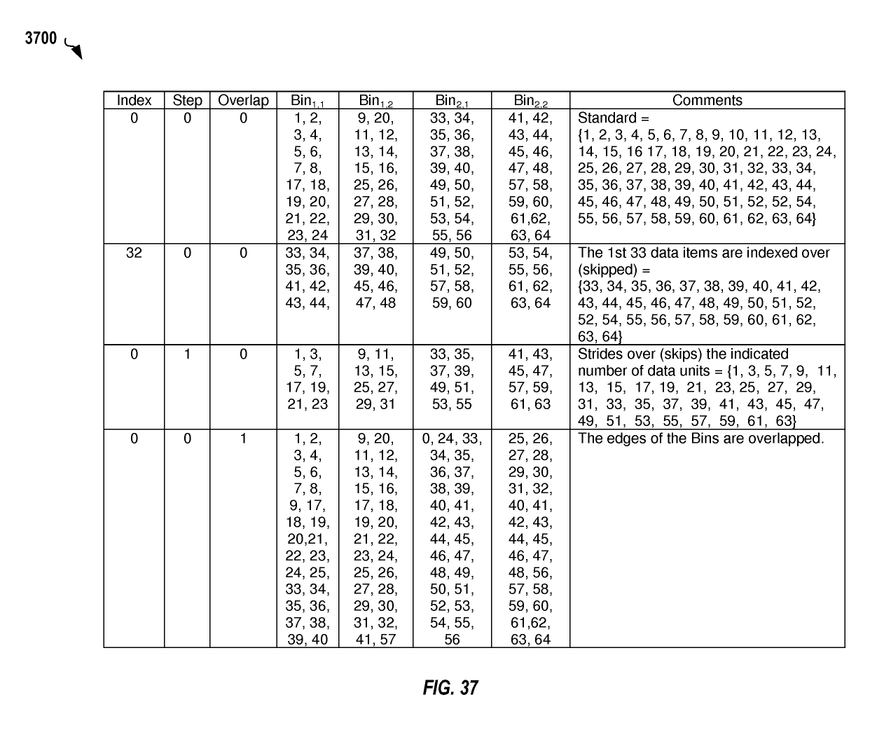

As in the one-dimensional case, the actual dataset topology for continuous blocks for two dimensions requires three parameters: index, step, and overlap. FIG. 37 shows one examples of a 2-dimensional continuous-block dataset topology model with index, step and overlap parameters, table 3700.

### Mesh_Type_Cont_Block

### 3-Dimensional Examples

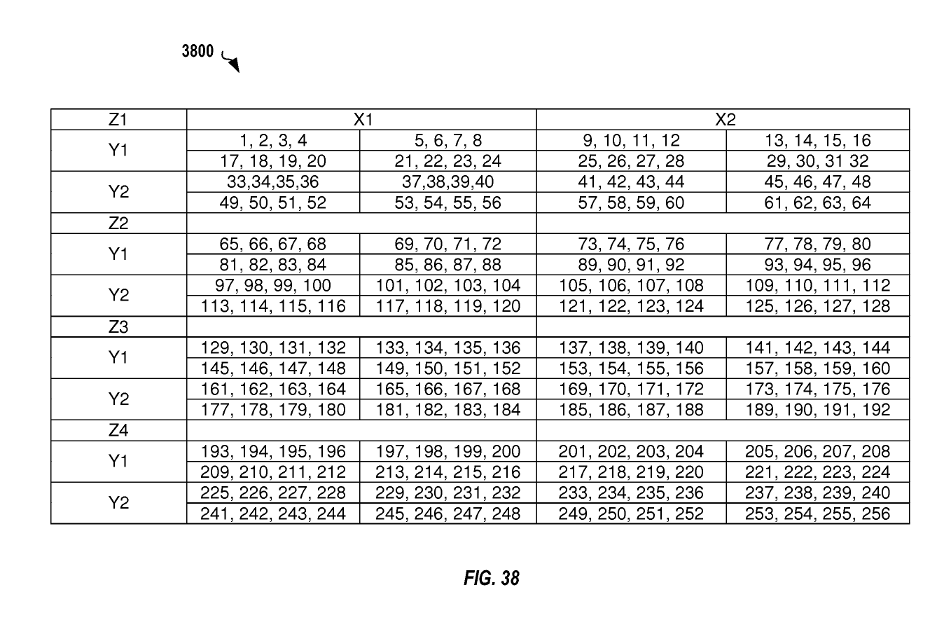

The continuous-block data topology model can also be extended to the 3-dimensional case, as shown in 3-Dimensional Continuous Block Topology example of table 3800, FIG. 38, such that data is distributed to exemplary computational elements 1-4 as follows:
Computational Element 1=[Bin_{1,1,1}={1, 2, 3, 4, 5, 6, 7, 8, 17, 18, 19, 20, 21, 22, 23, 24}, Bin_{1,1,2}={65, 66, 67, 68, 69, 70, 71, 72, 81, 82, 83, 84, 85, 86, 87, 88}, Bin_{1,1,3}={129, 130, 131, 132, 133, 134, 134, 136, 145, 146, 147, 148, 149, 150, 151, 152}, Bin_{1,1,4}={193, 194, 195, 196, 197, 198, 199, 200, 209, 210, 211, 212, 213, 214, 215, 216}];
Computational Element 2=[Bin_{2,1,1}={9, 10, 11, 12, 13, 14, 15, 16, 25, 26, 27, 28, 29, 30, 31, 32}, Bin_{2,1,2}={73, 74, 75, 76, 77, 78, 79, 80, 89, 90, 91, 92, 93, 94, 95, 96}, Bin_{2,1,3}={137, 138, 139, 140, 141, 142, 143, 144, 153, 154, 155, 156, 157, 158, 159, 160}, Bin_{2,1,4}={201, 202, 203, 204, 205, 206, 207, 208, 217, 218, 219, 220, 221, 222, 223, 224}];
Computational Element 3=[Bin_{1,2,1}={33, 34, 35, 36, 37, 38, 39, 40, 49, 50, 51, 52, 53, 54, 55, 56}, Bin_{1,2,2}={97, 98, 99, 100, 101, 102, 103, 104, 113, 114, 115, 116, 117, 118, 119, 120}, Bin_{1,2,3}={161, 162, 163, 164, 165, 166, 167, 168, 177, 178, 179, 180, 181, 182, 183, 184}, Bin_{1,2,4}={225, 226, 227, 228, 229, 230, 231, 232, 241, 242, 243, 244, 245, 246, 247, 248}];
Computational Element 4=[Bin_{2,2,1}={41, 42, 43, 44, 45, 46, 47, 48, 57, 58, 59, 60, 61, 62, 63, 64}, Bin_{2,2,1}={105, 106, 107, 108, 109, 110, 111, 112, 121, 122, 123, 124, 125, 126, 127, 128}, Bin_{2,2,1}={169, 170, 171, 172, 173, 174, 175, 176, 185, 186, 187, 188, 189, 190, 191, 192}, Bin_{2,2,1}={233, 234, 235, 236, 237, 238, 239, 240, 249, 250, 251, 252, 253, 254, 255, 256}].

### Mesh_Type_Cont_Block

### 3-Dimensional Examples: Index, Step, and Overlap Data Decomposition Calculations

Although the three dimensional examples are not shown, it will be appreciated that, similar to the above described one- and two-dimensional cases, the 3-dimensional continuous block data topology model utilize Index, Step, and Overlap parameters.

### Mesh_Type_Row_Block Examples

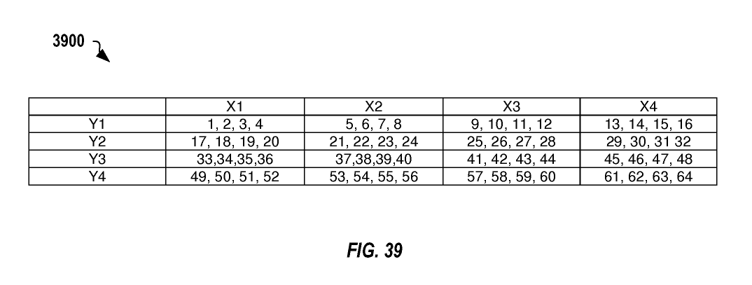

The MESH_TYPE_ROW_BLOCK mesh type decomposes a 2-dimensional or higher array into blocks of rows, one example of which is shown in table 3900, FIG. 39, such that data is distributed to exemplary computational elements 1-4 as follows:
Computational Element (CE) 1=Bin_{1,1}={1, 2, 3, 4}, Bin_{2,1}={5, 6, 7, 8}, Bin_{3,1}={9, 10, 11, 12}, Bin_{4,1}={13, 14, 15, 16}; Computational Element (CE) 2=Bin_{1,2}={17, 18, 19, 20}, Bin_{2,2},={21, 22, 23, 24}, Bin_{3,2}={25, 26, 27, 28}, Bin_{4,2}={29, 30, 31, 32};
Computational Element (CE) 3=Bin_{1,3}={33, 34, 35, 36}, Bin_{2,3}={37, 38, 39, 40}, Bin_{3,3}={41, 42, 43, 44}, Bin_{4,3}={45, 46, 47, 48};
Computational Element (CE) 4=Bin_{1,4}={49, 50, 51, 52}, Bin_{2,4}={53, 54, 55, 56}, Bin_{3,4}={57, 58, 59, 60}, Bin_{4,4}={61, 62, 63, 64}.

### Mesh_Type_Row_Block

### 2-Dimensional Examples: Index, Step, and Overlap Data Decomposition Calculations

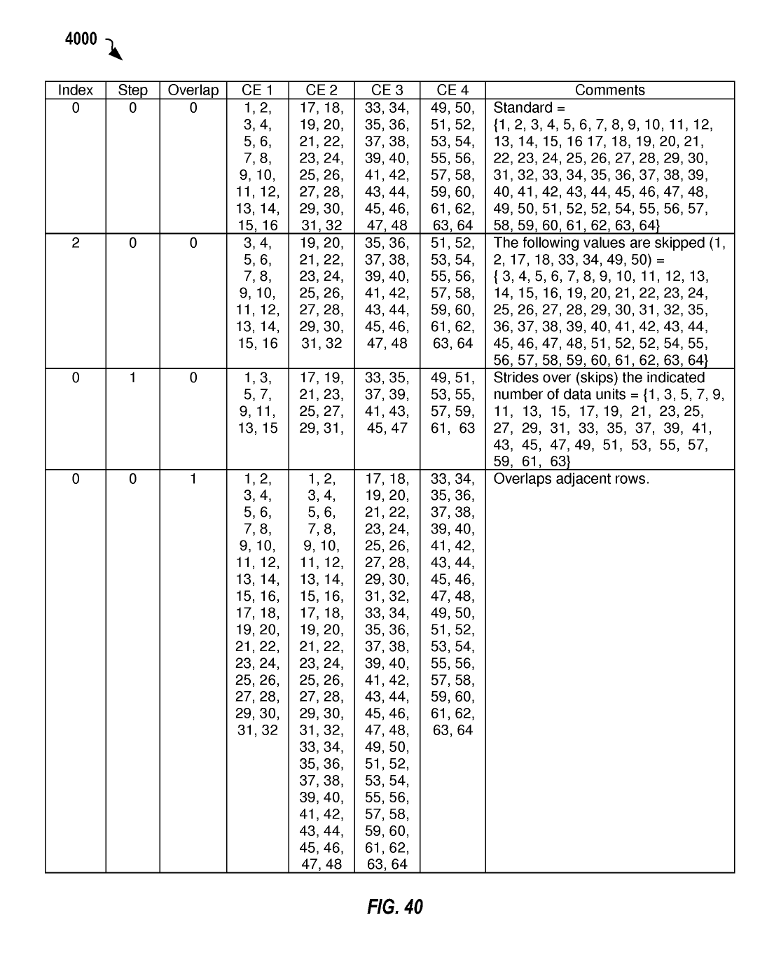

As in the one-dimensional case, the actual dataset topology for MESH_TYPE_ROW_BLOCK mesh type topology for two dimensions requires three parameters: Index, Step, and Overlap. FIG. 40 shows one examples of a 2-dimensional row-block dataset topology model with Index, Step and Overlap parameters, table 4000.

### Mesh_Type_Column_Block Examples

The MESH_TYPE_Column_BLOCK mesh type decomposes a 2-dimensional or higher array into blocks of columns, as shown in table 4100, FIG. 41, such that data is distributed to exemplary computational elements 1-4 as follows:
Computational Element (CE) 1=[Bin_{1,1}={1, 2, 3, 4}, Bin_{1,2}={17, 18, 19, 20}, Bin_{1,3}={33, 34, 35, 36}, Bin_{1,4}={49, 50, 51, 52}];
Computational Element (CE) 2=[Bin_{2,1}={5, 6, 7, 8}, Bin_{2,2},={21, 22, 23, 24}, Bin_{2,3}={37, 38, 39, 40}, Bin_{2,4}={53, 54, 55, 56}];
Computational Element (CE) 3=[Bin_{3,1}={9, 10, 11, 12}, Bin_{3,2}={25, 26, 27, 28}, Bin_{3,3}={41, 42, 43, 44}, Bin_{3,4}={57, 58, 59, 60}];
Computational Element (CE) 4=[Bin_{4,1}={13, 14, 15, 16}, Bin_{4,2}={29, 30, 31, 32}, Bin_{4,3}={45, 46, 47, 48}, Bin_{4,4}={61, 62, 63, 64}].

### Mesh_Type_Column_Block

### 2-Dimensional Examples: Index, Step, and Overlap Data Decomposition Calculations

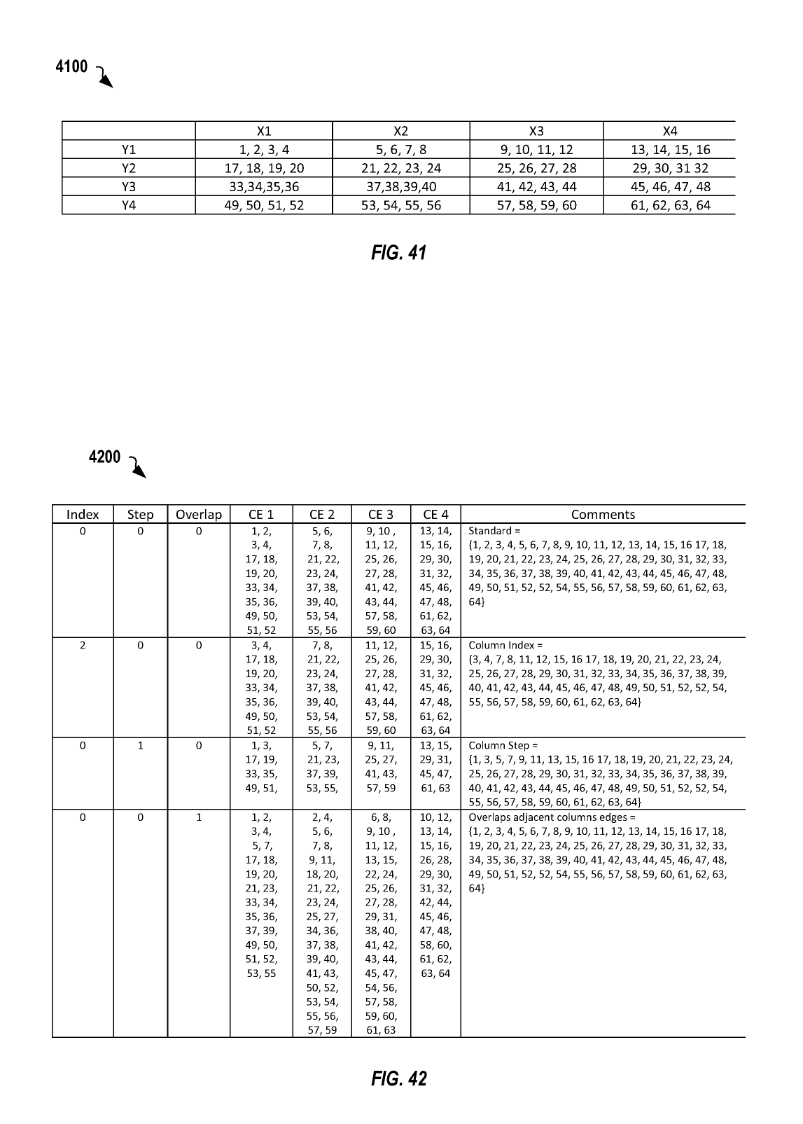

As with the above examples, there are three parameters that, taken together, create the actual data topology for this mesh type: Index, Step and Overlap. Applying these three parameters to the example of table 4100, FIG. 40, produces the 2-Dimensional Column Block Dataset Topology with Index, Step, and Overlap shown in table 4200, FIG. 42.

### Initial Distribution Models

In general, a system may use a distribution model to activate the required processing nodes and pass enough information to those nodes such that the nodes can fulfill the requirements of an algorithm. Information passed to the nodes may include the type of distribution used, since some distribution models are formed such that nodes relay information to other nodes. To pass information, some systems use a broadcast or multicast transmission process to transmit the required information. A broadcast transmission sends the same information message simultaneously to all attached processing nodes, while a multicast transmission sends the information message to a selected group of processing nodes. The use of either a broadcast or a multicast is inherently unstable, however, as it is impossible to know if a node received a complete transfer of information. Instead, a scatter command may be used for the safe transfer of information to multiple nodes. A scatter command moves data from a central location to multiple nodes. A typical non-multicast, non-broadcast communication model uses a tree-broadcast, a tree-multicast, or a Howard Cascade broadcast or multicast information distribution model.

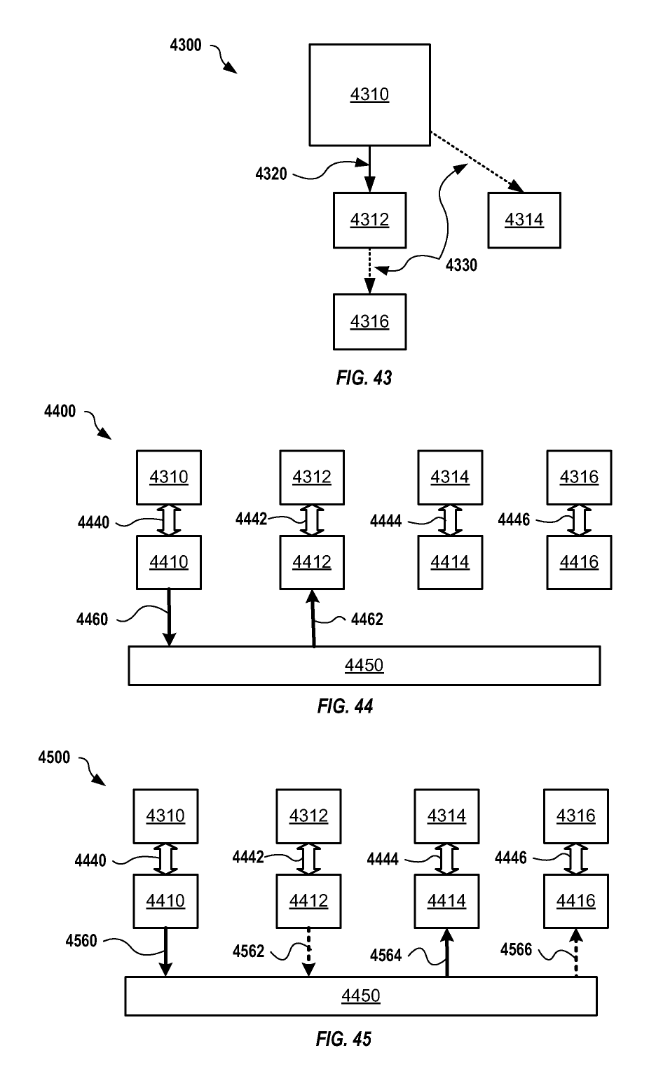

FIG. 43 shows a logical view of Howard Cascade-based Single Channel Multicast/Broadcast. The simplified Howard Cascade data movement and timing diagram 4300, FIG. 43, shows the transfer of data from node 4310 to nodes 4312-4316 in a first time step 4320 and second time step 4330. FIGS. 44 and 45 show exemplary hardware views of the first and second time steps 4320, 4330 of the Howard Cascade base broadcast/multicast described in FIG. 43.

FIG. 44 shows nodes 4310-4316 in communication with smart NIC cards 4410-4416, respectively, via bus 4440-4446, respectively. NIC cards 4410-4416 are in communication with switch 4450 for routing between nodes 4310-4316. The example of routing in first time step 4320 is depicted in FIG. 44. FIG. 44 shows an illustrative hardware view of data sent from node 4310 to node 4312 via bus 4440, NIC card 4410, and data transmission 4460, switch 4450, data transmission 4462, NIC card 4412 and bus 4440.

The example of routing in second time step 4330 is depicted in FIG. 45. FIG. 45 shows an illustrative hardware view of data sent from node 4310 to node 4314 and data sent from node 4312 to node 4316. Data sent from node 4310 to node 4314 occurs via bus 4440, NIC card 4410, data transmission 4560, switch 4450 data transmission 4564, NIC card 4414 and bus 4444. Data sent from node 4312 to node 4316 occurs via bus 4442, NIC card 4412, data transmission 4562, switch 4450 data transmission 4566, NIC card 4416 and bus 4446.

FIGS. 44 and 45 illustrate one example where a Howard Cascade uses a command requested from a Smart NIC card (e.g. NIC cards 4410-4416) to perform both the data movement and the valid operations. Placing the valid operations on the Smart NIC card facilitates overlapping communication/computation.

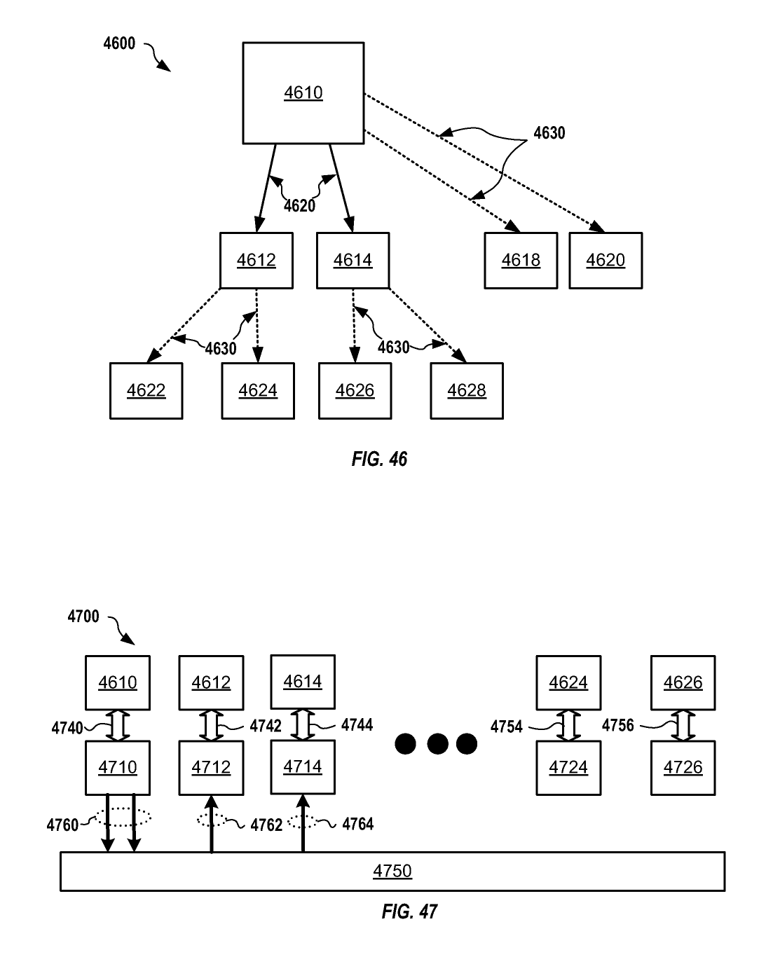

In one embodiment, the system utilizes multiple communication channels. In a separate embodiment, the system utilizes sufficient channel performance with bandwidth-limiting switch and network-interface card technology which emulates multiple communication channels; see U.S. Patent 20100183028. In either embodiment, the data movement differs from the examples shown in FIGS. 43-45. FIG. 46 shows one example of a nine node (nodes 4610-4628) multiple communication channel system 4600. In the example of FIGS. 46-48, which are best viewed together, the channels may be physical, virtual, or a combination of the two. Within system 4600, each node is illustratively shown with two communication channels. In a first time step 4620, node 4610 transmits to node 4612 and node 4614. In a second time step 4630, node 4610 transmits to nodes 4618 and 4620, node 4612 transmits to nodes 4622 and 4624 and node 4614 transmits to nodes 4626 and 4628.

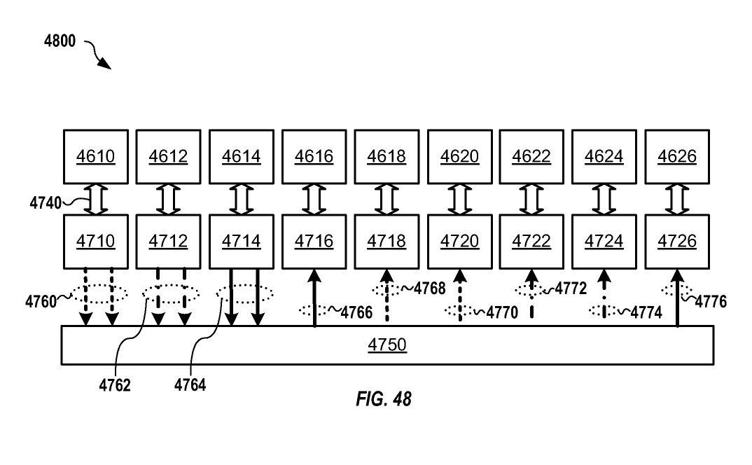

FIG. 47 shows one exemplary illustrative hardware view of the first time step 4620 of the 2-channel Howard Cascade-based multicast/broadcast of FIG. 46. FIG. 48 shows one exemplary illustrative hardware view of the second time step 4630, FIG. 46. FIG. 47 shows nodes 4610-4626 in communication with smart NIC cards 4710-4726, respectively, via bus 4710-4726, respectively. Although not all communications paths are shown for sake of clarity, all smart NICs 4710-4726 are in communication with switch 4750 via communication paths 4760-4776, respectively, for routing between nodes 4610-4626. In the example of FIG. 47, node 4610 transmits to nodes 4612-4614 via bus 4740, smart NIC 4710, communication path 4760, switch 4750, communication paths 4762, 4764, smart NIC 4712, 4714 and bus 4742, 4744.

FIG. 48 shows one exemplary illustrative hardware view of the second time step 4630 of the 2-channel Howard Cascade-based multicast/broadcast of FIG. 46. FIG. 48 shows data sent from nodes 4610-4614 to nodes 4616-4626 via bus 4740-4756, NIC card 4710-4726, and data transmission 4760-4764, and switch 4450. Nodes 4610-4614 transmit via both channels of their 2-channel communication paths. Nodes 4616-4626 receive via one channel of their 2-channel communication paths. Nodes 4610-4626 transmit and receive as shown in FIG. 46, e.g., node 4610 transmits to nodes 4618 and 4629, etc.

### Scan Detection

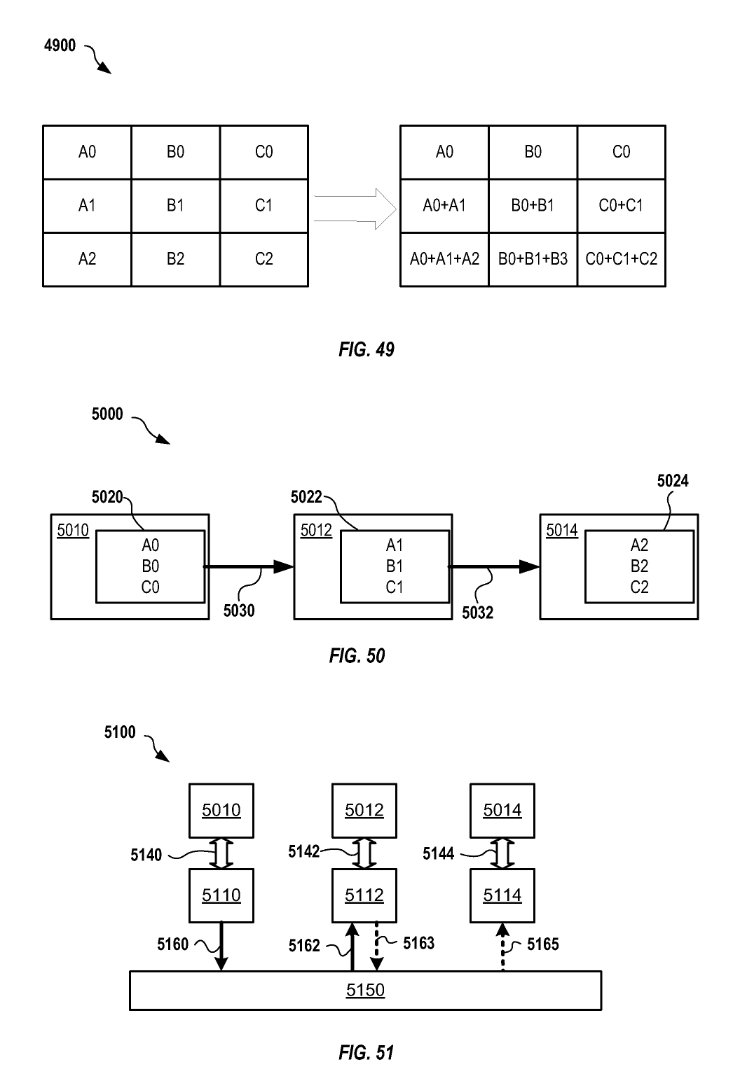

The SCAN command may use either the Howard Cascade (see U.S. Pat. No. 6,857,004) or a Lambda exchange (discussed below) distribution model 4900, FIG. 49 [see also U.S. Patent Pub. No. 20100185719]. The following shows one example of a scan command using SUM operation. The data pattern detected tells the system to use a Scan. In the example of FIG. 49, nodes are represented by rows, data items are represented by columns. The Lambda exchange is a pass-though exchange performed at the Smart NIC level (e.g., by smart NIC 4710-4726, FIG. 4), which is capable of simultaneously performing both operation functions and pass-through functions.

FIG. 50 show one exemplary Sufficient Channel Lambda Exchange Model 5000. Model 5000 shows data 5020 transmitted from node 5020 to node 5022 via transmission 5030 and stored as data 5022. Data 5022 is then transmitted from node 5012 to node 5014 via transmission 5032 and stored as data 5024.

FIG. 51 shows one exemplary hardware view 5100 of data transmitted from node 5010 to node 5012 and from node 5012 to nodes 5014 utilizing a Sufficient Channel Lambda exchange model. Data is transmitted from node 5010 to node 5012 via bus 5140, smart NIC 5110, communication path 5160, switch 5150, communication path 5162, smart NIC 5112, and bus 5142. Data 5022 is transmitted from node 5012 to node 5014 via bus 5142, smart NIC 5112, communication path 5163, switch 5150, communication path 5165, smart NIC 5114, and bus 5144.

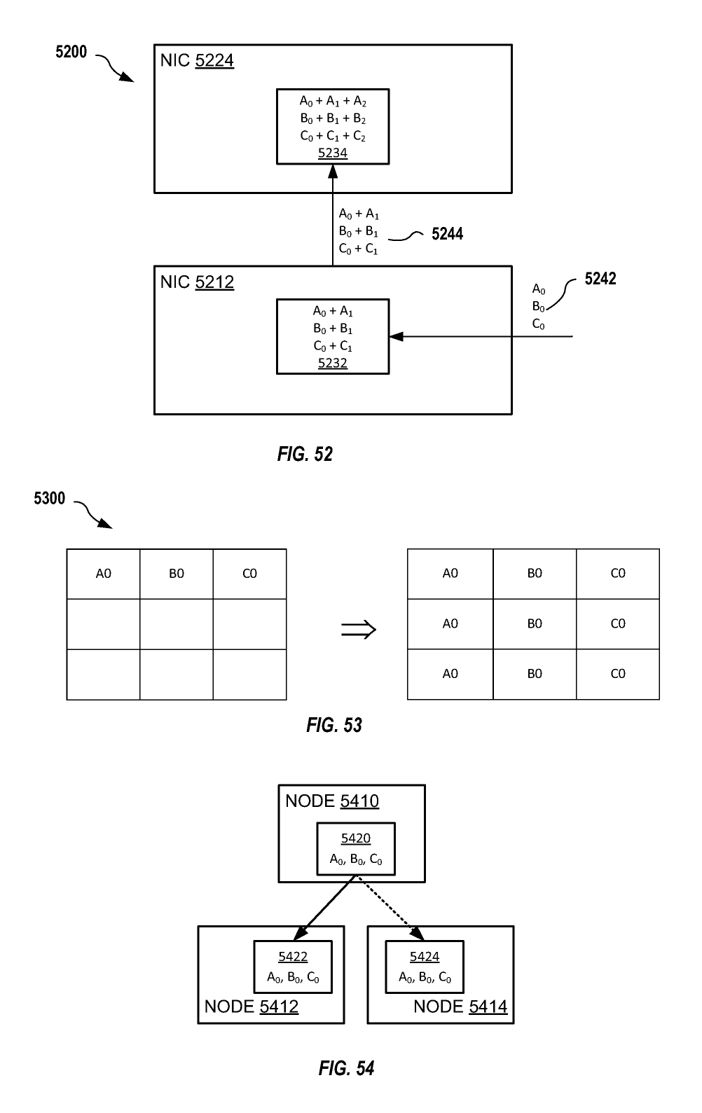

FIG. 52 shows one exemplary system 5200, which illustratively shows smart NIC 5212, 5214 performing SCAN (with Sum) using Sufficient Channel Lambda exchange model. In the example of FIG. 52, a NIC 5212 receives data 5242 performs a Sum operation and stores the data as data 5232. NIC 5212 then transmits data 5232 as data 5244 to NIC 5224. NIC 5224 performs a SUM operation and stores the data as data 5234.

### Multicast and Broadcast Detection

FIG. 53 shows a detectable communication pattern 5300 used to detect the use of a multicast or broadcast. In the example of FIG. 53, nodes are represented in the rows; data items are represented in the columns. A Sufficient Channel Howard Cascade version of a broadcast command subdivides a communication channel into multiple virtual communication channels, transmitting across all virtual channels. This model has advantage over a standard broadcast as it is defined pair-wise and therefore is a safe data transmission. If the number of sufficient virtual channels is less than the number of nodes, the multi-virtual channel version of the Howard Cascade is used to perform a high-efficiency tree-like broadcast.

FIG. 54 shows one exemplary logical view of a Sufficient Channel Howard Cascade-based Multicast/Broadcast. In the example of FIG. 54, node 5410 transmits data 5420 via a multicast/broadcast to nodes 5412, 5414. Node 5412 and node 5414 store data 5420 as data 5422 and data 5424, respectively.

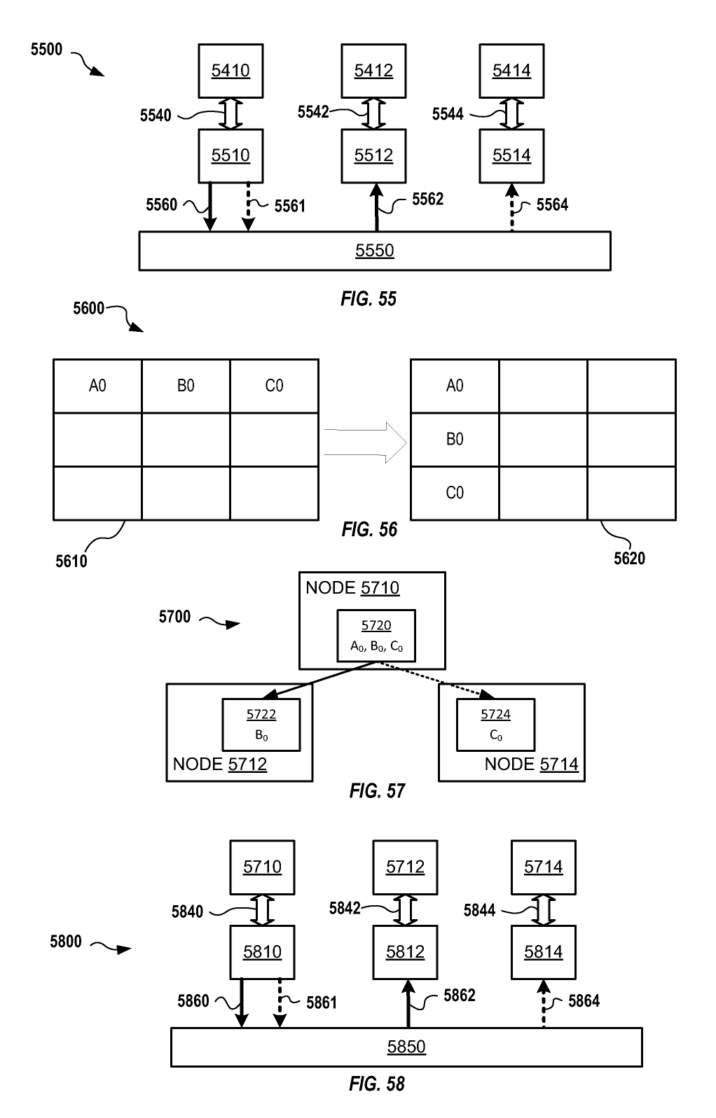

FIG. 55 shows an exemplary hardware view of a Sufficient Channel Howard Cascade-based multicast or broadcast communication model of FIG. 54. In the example of FIG. 55, node 5410 transmits one copy of data 5420 (FIG. 54) to node 5412 via bus 5540, smart NIC 5510, communication path 5560, switch 5550, communication path 5562, smart NIC 5512 and bus 5542. Node 5410 transmits another copy of data 5420 (FIG. 54) to node 5414 via bus 5540, smart NIC 5510, communication path 5560, switch 5550, communication path 5564, smart NIC 5514 and bus 5544.

### Scatter Detection

One exemplary scatter data pattern 5600 is shown in FIG. 56. In scatter data pattern 5600, nodes are represented by rows; data items are represented by columns. Data pattern 5610 represents nodes and data items prior to a data scatter. Data pattern 5610 shows all data items A0, B0 and C0 within one node. Data pattern 5620 represents nodes and data items after a data scatter. Data pattern 5620 shows one data item in each of the three nodes. FIG. 57 shows a Sufficient Channel Howard Cascade Scatter, in which node 5710 transmits a first portion (B0) of data 5720 to node 5712 and a second portion (C0) of data 5720 to node 5714. Node 5712 stores received data portion as data 5722. Node 5714 stores received data portion as data 5714. Although not shown in FIG. 57, it will be appreciated that, after the data scatter, node 5710 maintains data item A0, but no longer stores B0 and C0 data items.

FIG. 58 shows one exemplary illustrative hardware view of a first step of the Sufficient Channel Howard Cascade-based scatter model of FIG. 57. In the example of FIG. 58, node 5710 transmits a portion of data 5720 (B0) to node 5712 via bus 5840, smart NIC 5810, communication path 5860, switch 5850, communication path 5862, smart NIC 5812 and bus 5842. Node 5710 transmits a second portion of data 5720 (C0) to node 5714 via bus 5840, smart NIC 5810, communication path 5860, switch 5850, communication path 5864, smart NIC 5814 and bus 5844.

### Vector Scatter Detection Example

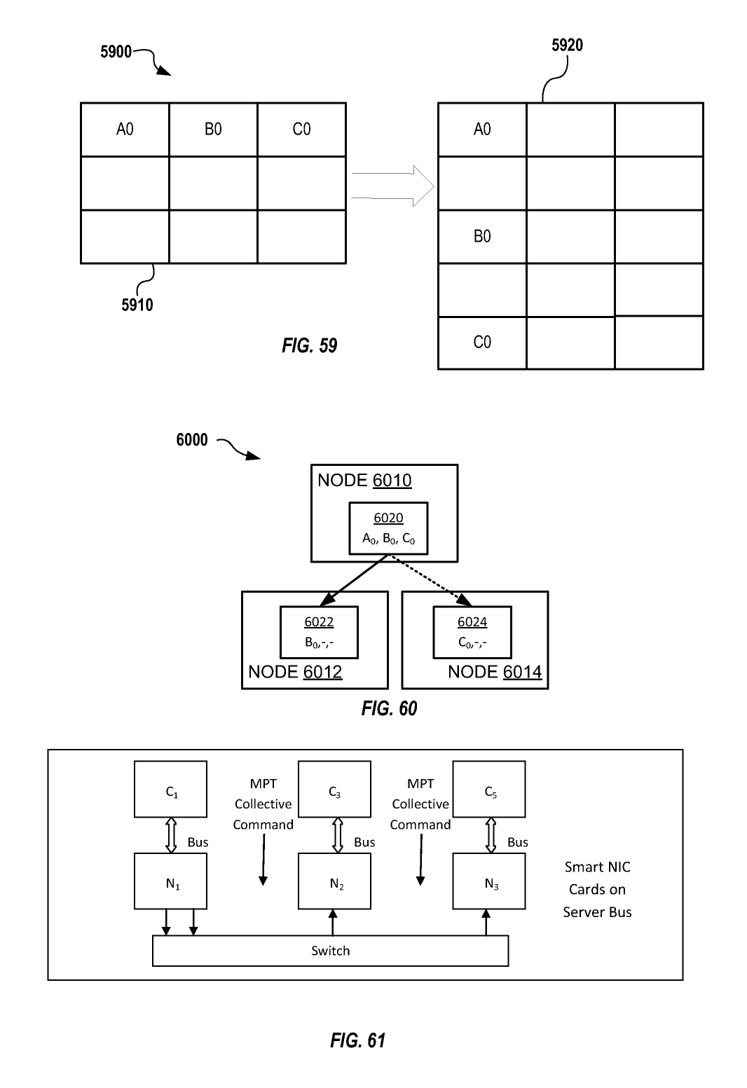

The following detectable data movement pattern determines when a vector scatter command is required. FIG. 59 shows a logical vector scatter view 5900. Data pattern 5910 shows data location prior to a vector scatter operation. Data pattern 5920 shows data locations after the vector data operation. A vector scatter operation allows the user specify an offset table which tells the system where to place the data it receives from various places. Vector scatter adds flexibility to a standard scatter operation in that the location of data for the send is specified by an send integer displacement array and the location of the placement of the data on the receive side is specified by receive integer displacement array.

FIG. 60 shows one exemplary timing diagram and data movement for the vector scatter operation.

FIG. 61 shows one exemplary hardware view of the vector scatter operation of FIG. 60.

### Initial Data Input Model Examples

Data input is the ability for a system to receive information from some outside source. Generally, there are two types of data input schemes: serial and parallel. Serial input receives data using a single communication channel whereas parallel input receives data using multiple communication channels. Utilizing current switch technology, it is possible to broadcast data to multiple independent computational devices within a system; however, this data transfer may not be reliable. Another possibility is to decompose the data into datasets and send the different datasets to different computational devices within a system.

### Serial Data Input Example

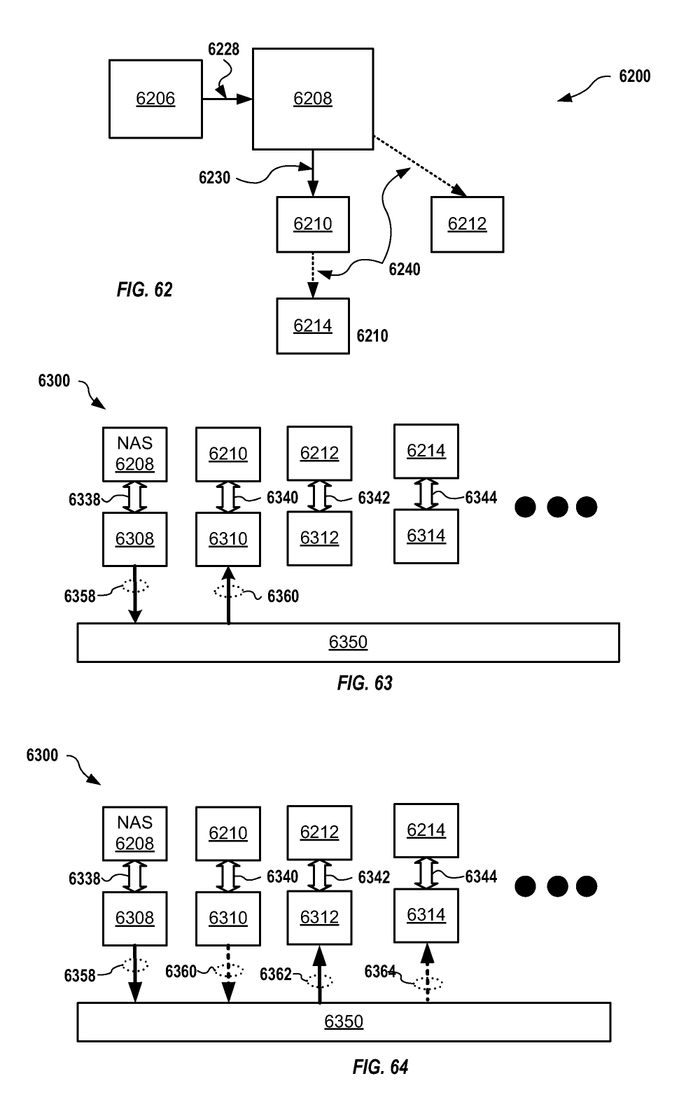

Data can be sent to a system through a network via a single communication channel from storage-area networks (SAN), network-attached storage (NAS) or other online data-storage methods. FIG. 62 shows a logical view of serial data input using Howard Cascade-based data transmission. FIG. 62 shows one exemplary system 6200 in which a home-node selection of top-level compute nodes transmit a decomposed dataset to a portion of the system in parallel. System 6200 includes a home node 6206, compute nodes 6210-6214 and a NAS 6208. Within system 6200, serial data transmission occurs by home node 6206 communicating 6228 with NAS 6208. NAS 6208, in a first time step transmission 6230 transmits data to node 6212. In a second time step transmission 6240, node 6210 transmits to node 621 and NAS 6208 transmits to node 6212.

FIGS. 63 and 64 show one exemplary hardware view of the first and second time step of transmitting portions of a dataset from a NAS device to nodes within a system 6300. Within FIGS. 63 and 64, node 6206 is not shown for sake of clarity. FIG. 63 shows one exemplary hardware view of system 6300 which transmits, in a first time step, portions of a decomposed dataset from a Network Attached Storage (NAS) 6208 to node 6210. FIG. 63 shows a NAS 6208 transmitting to node 6210 via bus 6338, smart NIC 6338, communication path 6358 switch 6350, communication path 6360, smart NIC 6310, and bus 6340. FIG. 64 shows a second time step of transmitting portions of a decomposed dataset from NAS 6208 and node 6210 to nodes 6212 and 6214, respectively. NAS 6208 transmits to node 6212 via bus 6338, NIC 6308, communication line 6358, switch 6350, communication line 6362, NIC 6312, and bus 6342. Simultaneously (in parallel), node 6210 transmits to node 6214 via bus 6340, NIC 6310, switch 6350, NIC 6314, and bus 6344.

### Parallel Data Input Example

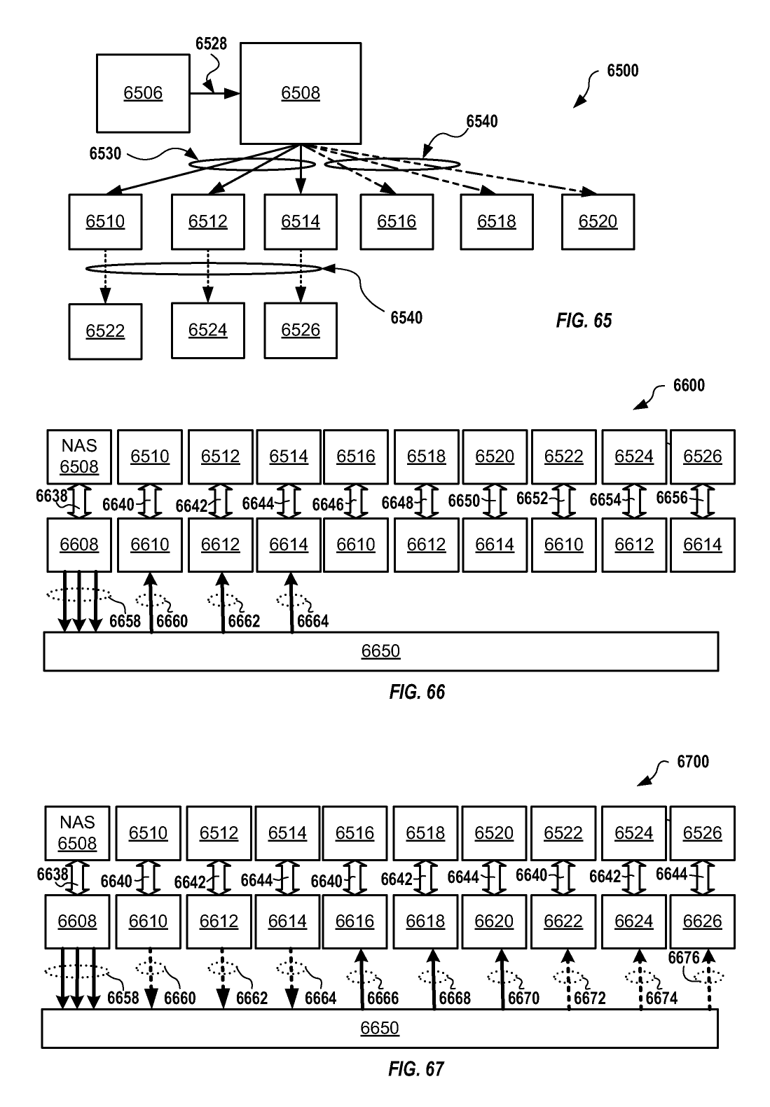

Data can also be sent to a system in parallel through network-attached storage (NAS), storage-area networks (SAN), or other methods. This can be accomplished via the Home-node selection of top-level compute nodes that will take a decomposed dataset and transmit it to a portion of the system, in parallel. FIGS. 65-67 show one example of transmitting a decomposed dataset to portions of a system 6500, 6600. In the example of FIG. 65, a NAS 6508 transmits to nodes 6510, 6512, 6514 in a first time step 6530. In a second time step 6540, NAS 6508 transmits to nodes 6516, 6518, 6520. Also, in second time step 6540, nodes 6510, 6512 and 6514 transmit to nodes 6522, 6524 and 6526, respectively. Hardware views of the first time step 6530 transmission is shown in FIG. 66 as system 6600 and a second time step 6540 transmission is shown in FIG. 67 as system 6700.

FIGS. 66 and 67 include NAS 6508 and nodes 6510-6526. NAS 6508 is in communication with a smart NIC 6608 via bus 6638. Nodes 6510-6526 are in communication with smart NICs 6610-6626, respectively, via bus 6640-6656, respectively. In system 6600, NAS 6508 transmits data, in parallel, to nodes 6510, 6512 and 6514. Data is transmitted from NAS 6508 to switch 6650 via bus 6638, NIC 6608 and parallel communication line 6658. Data is then transmitted from switch 6650 to nodes 6510, 6512, 6514 via communication lines 6660, 6662, 6664, NICs 6610, 6612, 6614 and bus 6642, 6644, 6646, respectively.

In the second time step shown in the hardware view of FIG. 67, system 6700, data is transmitted, in parallel, from NAS 6508 to nodes 6516, 6518 and 6520. In addition, data is transmitted from nodes 6510, 6512 and 6514 to nodes 6522, 6524 and 6526, respectively. Data is transmitted in system 6700 via buses 6638-6644, NICs 6608-6626, communication lines 6658-6676 and switch 6650.

### Cross Communication Model Examples

Various one- and two-dimensional cross-communication exchanges are shown below. The data-access patterns are used by the system to determine what type of exchange model is to be used by the algorithm when encountered as part of the profiling effort.

### One-Dimensional Left-Right Detection

The single dimensional left-right exchange behaves differently under different topologies. The one-dimensional left-right exchange under both Cartesian and circular topologies is shown below.

### One-Dimenisional Left-Right Exchange, Cartesian

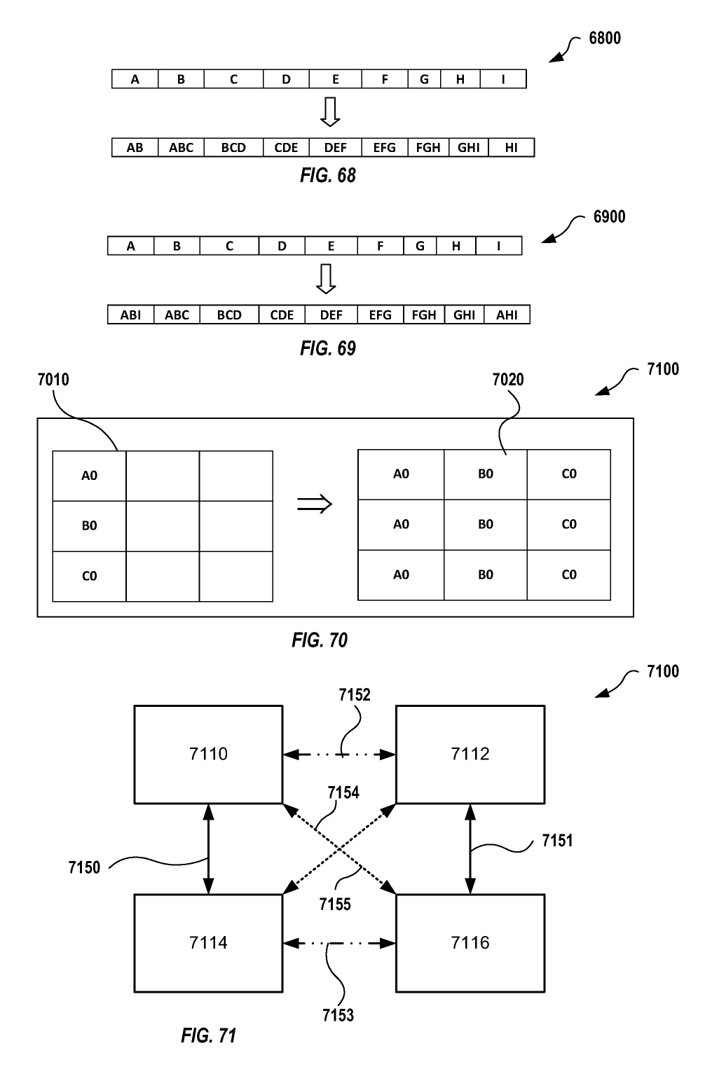

FIG. 68 shows a pattern used to detect a one-dimensional left-right exchange under a Cartesian topology.

### One-Dimensional Left-Right Exchange, Circular

FIG. 69 shows a pattern used to detect a left-right exchange under a circular topology.

### Two-Dimensional All-To-All Detection

An all-to-all exchange detection pattern is shown in FIG. 70 as a first and second matrix 7010, 7020. In matrix 7010, 7020, as above, nodes are represented by rows and columns represent data elements. Matrix 7010 shows data distributed prior to an all-to-all exchange, with one data element stored on each node, represented by one data element per row. Matrix 7020 shows data distributed after the all-to-all exchange with all data elements A0, B0, C0 stored on each node.

FIG. 71 shows one exemplary four node all-to-all exchange in three time steps. In the first time step, nodes 7110 and 7112 exchange data 7150, 7151 with nodes 7114 and 7116, respectively. In a second time step, nodes 7110 and 7114 exchange data 7152, 7153 with nodes 7112 and 7116. In the third and final time step, nodes 7110 and 7112 exchange data 7154, 7155 with nodes 7116, and 7114, respectively. After the final time step of the all-to-all exchange shown in FIG. 71, all nodes contain the same data.

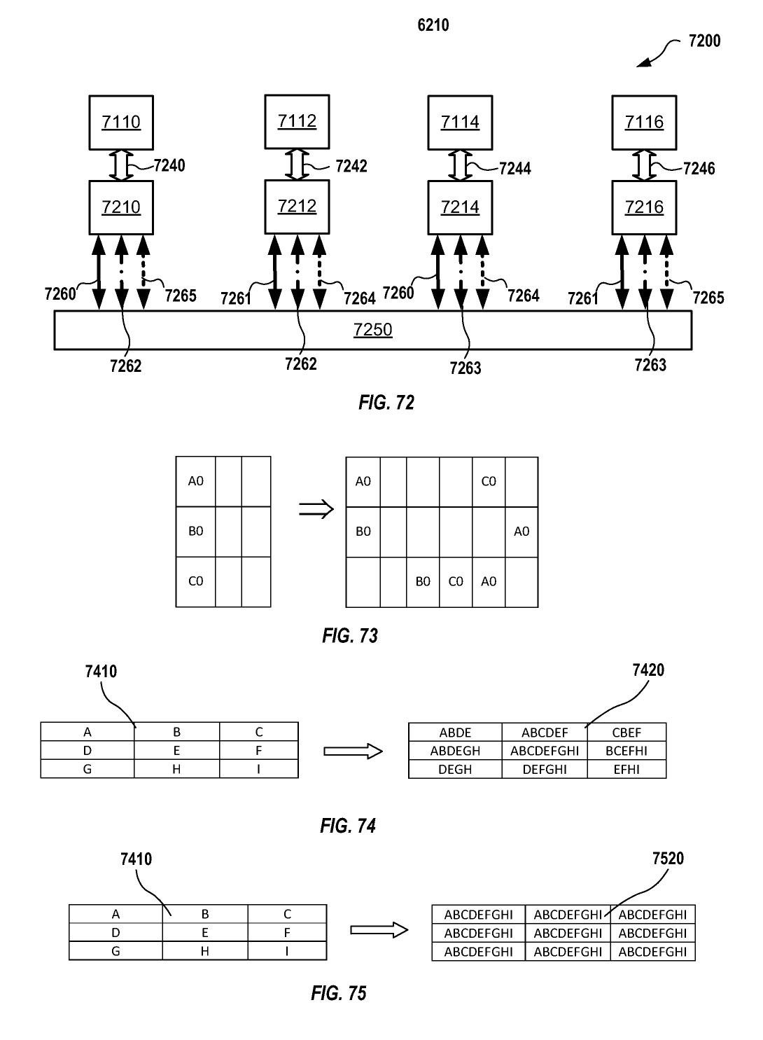

FIG. 72 shows an illustrative hardware view 7200 of the all-to-all exchange (PAAX/FAAX model) of system 7100, FIG. 71. In hardware view 7200, nodes 7110-7116 exchange data such that after a third time step all nodes contain the same data which was selected to be exchanged.

In the first time step, nodes 7110 and 7114 exchange data and nodes 7112 and 7116 exchange data. Nodes 7110 and 7114 exchange data via buses 7240, 7244, smart NICs 7210, 7214, communication path 7260, 7264 and switch 7250. Nodes 7112 and 7116 exchange data via buses 7242, 7246, smart NICs 7212, 7216, communication path 7262, 7266 and switch 7250.

In the second time step, nodes 7110 and 7112 exchange data and nodes 7114 and 7116 exchange data. Nodes 7110 and 7112 exchange data via buses 7240, 7242, smart NICs 7210, 7212, communication path 7260, 7262 and switch 7250. Nodes 7114 and 7116 exchange data via buses 7244, 7246, smart NICs 7214, 7216, communication path 7264, 7266 and switch 7250.

In the third time step, nodes 7110 and 7116 exchange data and nodes 7112 and 7114 exchange data. Nodes 7110 and 7116 exchange data via buses 7240, 7246, smart NICs 7210, 7216, communication path 7260, 7266 and switch 7250. Nodes 7112 and 7114 exchange data via buses 7242, 7244, smart NICs 7212, 7214, communication path 7262, 7264 and switch 7250.

Vector all-to-all Detection

FIG. 73 shows a vector all-to-all exchange model data pattern detection.

### Next-Neighbor Exchange Detection

FIG. 74 shows a 2-dimensional next neighbor data exchange in a Cartesian topology. FIG. 75 shows a 2-dimensional next neighbor data exchange in a toroid topology. A next-neighbor data exchange is typically defined over two dimensions, although higher dimensions are possible. The next-neighbor data exchange is an exchange where topology makes a difference in the outcome of the exchange. Both FIGS. 74 and 75 start with the same initial data 7410, but the final data 7420 and 7520 differ due to differing topologies, i.e. Cartesian topology and toroid topology.

The two-dimensional Cartesian next-neighbor exchange, FIG. 74, copies data from all adjacent locations to all other adjacent locations. In the example of FIG. 74, the first row, first column of initial data 7410, which contains data element A, is adjacent to data elements B, D and E. Therefore, the first row, first column of final data 7420 contains data elements A, B, D and E, that is, every data element that is adjacent to first row, first column data element of initial data 7410 is added to the first row first column of final data 7420. All other data exchanges follow this pattern. The standard way to accomplish this data movement is to move the data to the adjacent locations to the left (if any), then to the right, then up, then down, then diagonal up, and finally diagonal down. As can be seen, this takes six data movements. A system that uses sufficient channel PAAX exchange can perform this faster.

As described above, the two-dimensional next-neighbor exchange data pattern for toroid topology differs from the Cartesian topology. The two-dimensional next-neighbor exchange for toroid topology copies data from all adjacent locations to all other adjacent locations. The final data 7520 differs from final data 7420 because all data elements in a toroid topology are adjacent to every other data element; therefore all data elements of initial data 7410 are copied to every data element of final data 7520. As can be seen, the two-dimensional toroid next-neighbor exchange generates a true PAAX.

### Two-Dimensional Red-Black Exchange Detection

The two-dimensional red-black exchange exchanges data diagonal elements within a matrix. One illustrative example is the Red-Black exchange treats a matrix as if it were a checkerboard, with alternating red and black squares. The data within the red squares is exchanged with all other touching red squares (i.e. diagonally), and touching black squares exchange their data (i.e. diagonally). This is equivalent to two FAAX; a first FAAX exchange of the touching red squares and a second FAAX exchange of the touching black squares. Like the next-neighbor exchange, the red-black exchange behaves differently under different topologies.

A two-dimensional red-black exchange in a Cartesian topology in shown in FIG. 76.

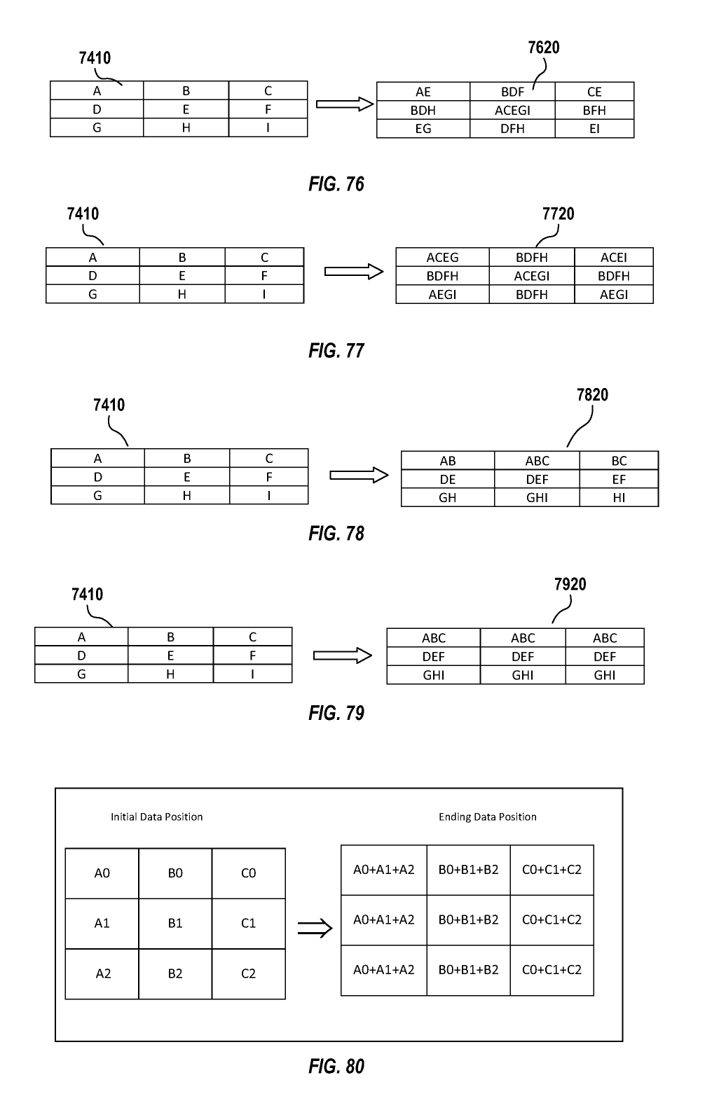

A two-dimensional red-black exchange in a toroid topology is shown in FIG. 77. Note that the pattern is equivalent to an all-to-all touching-red exchange plus an all-to-all touching-black exchange.

### Two-Dimensional Left-Right Exchange Detection

The two-dimensional left-right exchange places data on the left and right sides of a cell (if they exist) into the cell. Similar to the above exchanges, the left-right exchange is different under different topologies.

FIG. 78 shows a two-dimensional left-right exchange in a Cartesian topology. FIG. 79 shows a two-dimensional left-right exchange in a toroid.

### All-Reduce Command Software Detection

FIG. 80 shows a data pattern required to detect an all-reduce exchange. In one example, the Sufficient Channel Full Dataset All-To-All exchange (FAAX) communication model combined with the application of the required operation functions as the implementation model for the detected all-reduce exchange is used. FIG. 80 is an illustrative example of an all reduce command using a SUM Operation. As above, nodes are represented by rows and data items are represented by columns.

FIG. 81 shows an illustrative logical view of the sufficient channel-based FAAX of FIG. 80. When the number of sufficient channels equals one minus the number of nodes/servers 8110-8116, then all communication takes place in one time step. At worst, this communication takes (n−1) time steps (only one sufficient channel) compared with (n) time steps for a binomial gather followed by a binomial scatter.

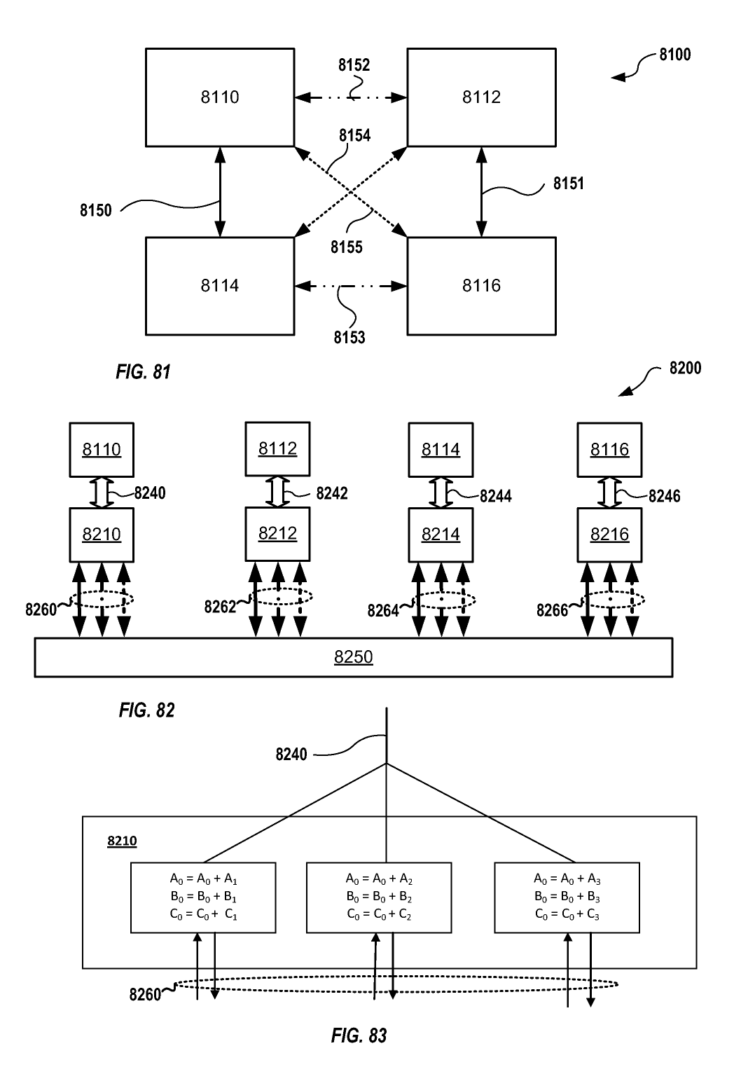

FIG. 82 shows an illustrative hardware view of Sufficient Channel-based FAAX Exchange of FIG. 81, with each node 8110-8116 utilizing a three channel communication path 8260-8266, respectively, to communicate with all other nodes via switch 8250. Each node 8110-8116 utilizes communication paths 8260-8266 via bus 8240-8246 and smart NIC 8210-8216.

FIG. 83 shows a smart NIC, NIC 8210, performing all reduction (with Sum) using FAAX model in a three channel 8260 overlap communication. Overlapped communication with computation uses the processor (not shown) available on smart NIC 8210. Each of the three virtual channels 8260 of the target sum-reduce operation have data calculated separately for each channel prior to the final operations.

### Reduce-Scatter Detection

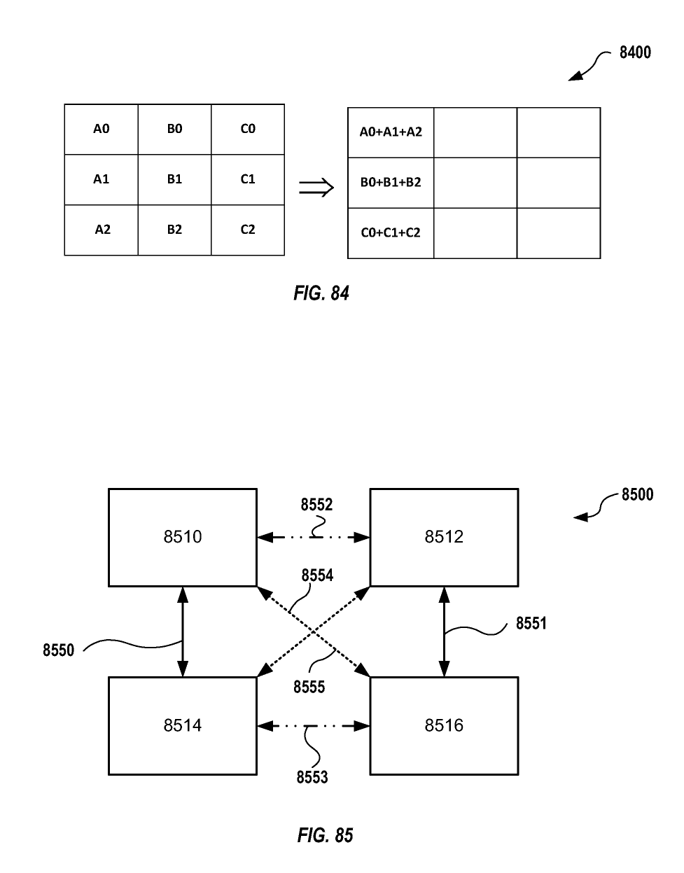

A reduce-scatter model uses the Sufficient Channel Partial Dataset All-To-All Exchange (PAAX) communication model combined with the application of the required operation function. FIG. 84 shows a logical view of Sufficient Channel Partial Dataset All-to-All Exchange (PAAX). As above, nodes are represented by rows and data items are represented by columns.

A difference between the PAAX and FAAX communication models is in the FAAX exchange used by the all-reduce command above, only some of the data from each node is transmitted to the other nodes. In the example of FIG. 85, node 8510 receives data elements A₁ A₂ A₃; node 8512 receives data elements B₀ B₂ B₃; node 8514 receives data elements C₀ C₁ C₂; and node 8516 receives data elements D₀ D₁ D₂. To complete this data exchange, the PAAX communication model requires the square root of the time to perform a FAAX exchange, which is the square root of (n−1), whereas a gather followed by a scatter takes (n) time steps. The hardware view of Sufficient Channel-based PAAX Exchange (not shown) is the same as the illustrative hardware view of Sufficient Channel-based FAAX Exchange of FIG. 81.

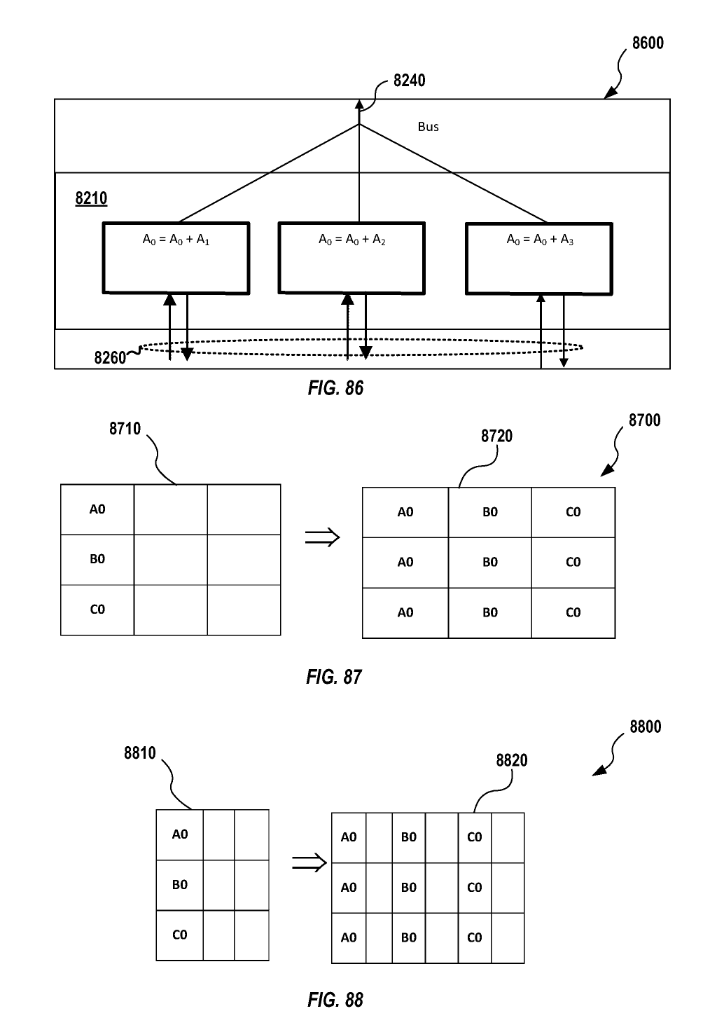

As above, overlapped communication with computation use the processors (not shown) available on the smart NICs. Each virtual channel of the target sum-reduce operation have data calculated separately for each channel, prior to final operations. FIG. 86 shows smart NIC 8210 performing reduce scatter (with Sum) using PAAX model.

### All-Gather Detection

The all-gather data exchange is detected by the data movements shown in FIG. 87 which illustrates one exemplary all gather data movement table 8700. Table 8700 shows initial data 8710 and final data 8720. The illustrative logical view and illustrative hardware views for the all-gather are the same as shown above.

### Vector All-Gather Detection

FIG. 88 shows a vector All Gather as a Sufficient Channel Full Dataset All-to-All Exchange (FAAX). In FIG. 88 the vector all-gather data table 8800 with initial data 8810 and final data 8820. As above, nodes are represented by rows and data items are represented by columns. The illustrative logical view and illustrative hardware views for the all-gather are the same as shown above.

### Initial Agglomeration Model Examples

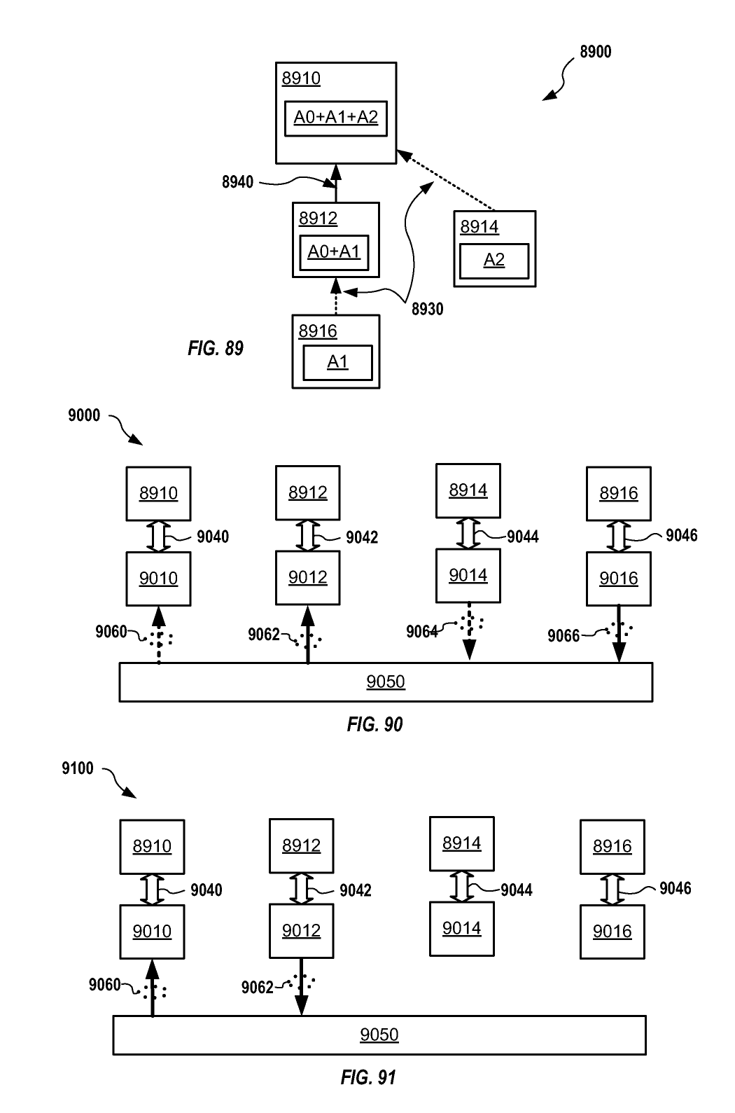

Agglomeration gathers the results of processed, scattered data portions such that a final result is centrally located. In the example of FIG. 89, results A0, A1 and A2 are gathered to a node 8910 to produce a final result A0+A1+A2. Results are gathered in a first time step 8930 and a second time step 8940 using a Reduce-Sum method within a Howard Cascade. In the first time step 8930, node 8914 sends results A2 to node 8910 and node 8916 sends results A1 to node 8912. In the second time step 8940 node 8912 sends combined results A0+A1 to node 8910, which is combined with A2 to produce final result A0+A1+A2.

FIG. 90 shows one exemplary hardware view 9000 of the agglomeration gather shown in FIG. 89, during the first time step 8930. In system 9000, node 8916 sends results A1 to node 8912 via bus 9046, smart NIC 9016, communication path 9066, switch 9050, communication path 9062, smart NIC 9012, and bus 9042. Node 8914 send results A2 to node 8910 via bus 9044, smart NIC 9014, communication path 9064, switch 9050, communication path 9060, smart NIC 9010 and bus 9040.

FIG. 91 shows one exemplary hardware view 9100 of the agglomeration gather shown in FIG. 89, during the second time step 8940. In the second time step 8940, node 8912 sends combined results A0+A1 to node 8910 via bus 9042, smart NIC 9012, communication path 9062, switch 9050, communication path 9060, smart NIC 9010, and bus 9040.

It will be appreciated that when a Howard Cascade is used, any required smart NIC command is first requested from the smart NIC, e.g., smart NICs 9010-9016. The smart NIC then performs both the data movement and the valid operations (for example, the sum operation shown above). Placing the valid operation on the smart NIC facilitates overlapping communication and computation.

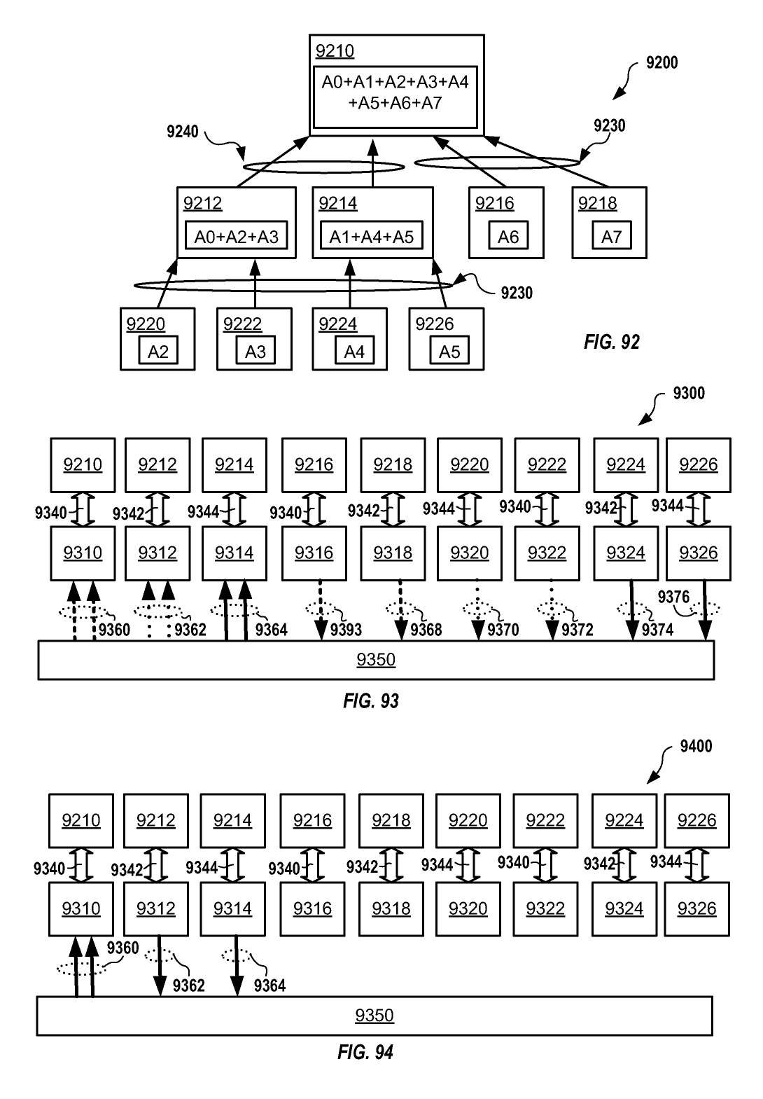

In a system with either multiple communication channels or capable to use Sufficient Channel performance with bandwidth-limiting (emulating multiple communication channels), then data movements change as shown in FIG. 92.

FIG. 92 shows a logical view of 2-channel Howard Cascade data movement and timing diagram, the present example showing a Reduce Sum operation. In a first time step 9230, nodes 9220, 9222 transmit to node 9112, nodes 9224, 9226 transmit to node 9214 and nodes 9216, 9218 transmit to node 9210. In a second time step 9240, nodes 9212, 9214 transmit to node 9210.

FIG. 93 shows a hardware view of the first time step 9230 (FIG. 92) of the two-channel data and command movement. As can be seen, the channel count follows from FIG. 92. The channels can be physical, virtual, or a combination of the two. In FIG. 93, it can be seen that nodes transmit data as described in FIG. 92. Transmitting data in FIG. 93 is via communication channels 9360-9376, some of which act as two channel communication channels, e.g. communication channels 9360-9364. It will be appreciated that all communication channels 9360-9376 may be two channel communication channels.

FIG. 94 shows one exemplary hardware view of the second time step 9240 (FIG. 92). In FIG. 94, nodes 9212, 9214 transmit to node 9210.

### Gather Model Detection

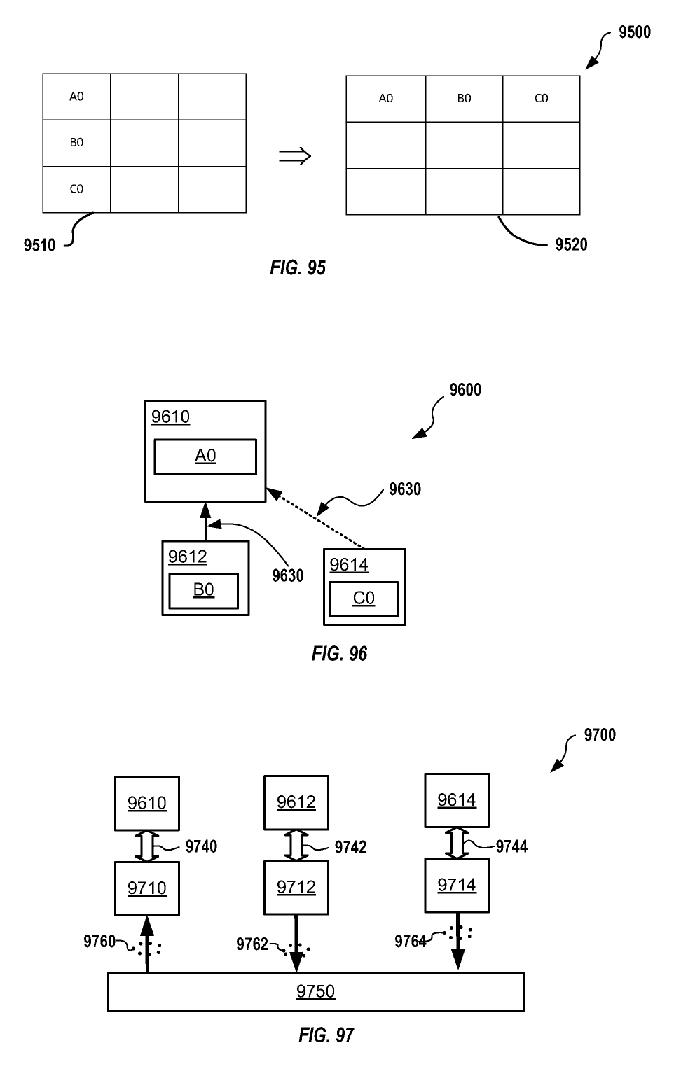

Gather model data movement detection is shown in FIGS. 95-98.

FIG. 95 shows an illustrative example of a gather model data movement. In FIG. 95, nodes are represented by rows and data items are represented by columns. A before gather matrix 9510 is shown with one data item (A0, B0, C0) in each row (node). An after gather matrix 9520 is shown with all three data items (A0, B0, C0) in one row (node).

In FIG. 96 shows a logical view of a sufficient channel Howard Cascade gather, system 9600. Communication channels may be physical, virtual, or a combination of the two. In the example of system 9600, prior to the gather operation, node 9610 stores data A0, node 9612, stores data B0 and node 9614 stores data C0. Node 9612 transmits data B0 to node 9610. During a first time step 9630, node 9612 transmits data B0 to node 9610. During a second time step 9640, node 9610 transmits data C0 to node 9610.

FIG. 97 shows a hardware view of sufficient channel Howard Cascade-based gather communication model, system 9700. In a first time step 9630 (FIG. 96), node 9612 transmits data to node 9610 via bus 9742, smart NIC 9712, communication path 9762, switch 9750, communication path 9760, smart NIC 9710 and bus 9740. In a second time step 9640 (FIG. 96), node 9614 transmits data to node 9610 via bus 9744, smart NIC 9714, communication path 9764, switch 9750, communication path 9760, smart NIC 9710 and bus 9740. This completes the gather operation.

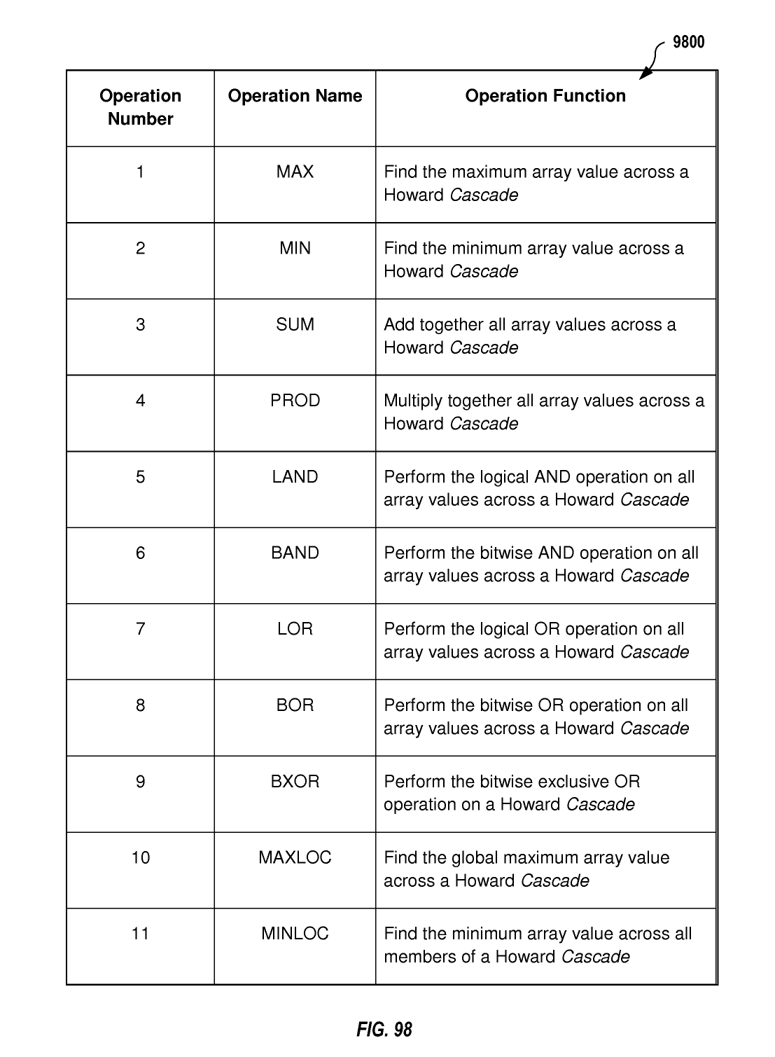

FIG. 98 is a list 9800 of the basic gather operations which can take the place of the sum-reduce.

### Detecting a Reduce Command

The transformation which identifies the Reduce parallel communication model should be used is shown below.

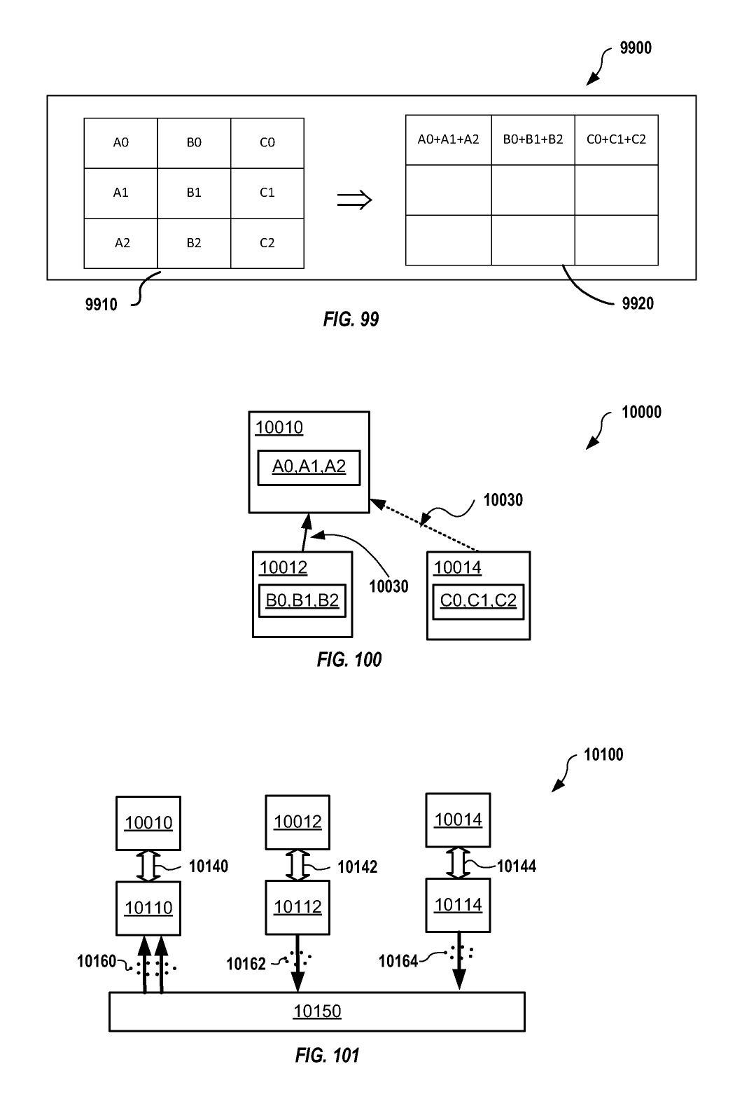

FIG. 99 shows one example of a reduce command using SUM operation. In FIG. 99, nodes are represented by rows and data items are represented by columns. A before the reduce command using SUM operation matrix 9910 is shown with one set of data item (e.g., A0, B0, C0) in each row (node). An after reduce command using SUM operation matrix 9520 is shown with all data items (A0, A1, A2, B0, B1, B2, C0, C1, C2) in one row (node), with the ‘A’ data items in the first column, the ‘B’ data items in a the next column and the ‘C’ data items in the last column.

Using the sufficient channel overlapped Howard Cascade communication pattern allows the reduce-sum pattern to be implemented, as shown in FIG. 100. FIG. 100 shows one example of a Howard Cascade data movement and timing diagram using reduce command using sum operation, system 10000. In system 10000, node 10012 and 10014 transmit data to node 10010 in a first time step 10030. Node 10012 transmits data B0, B1, B2. Node 10014 transmits data C0, C1, C2.

FIG. 101 shows a hardware view of sufficient channel overlapped Howard Cascade-based reduce command, system 10100. In the example of system 10100, data is transmitted from nodes 10012 and 10014 to node 10010 simultaneously during a first time step 10030 (FIG. 100).

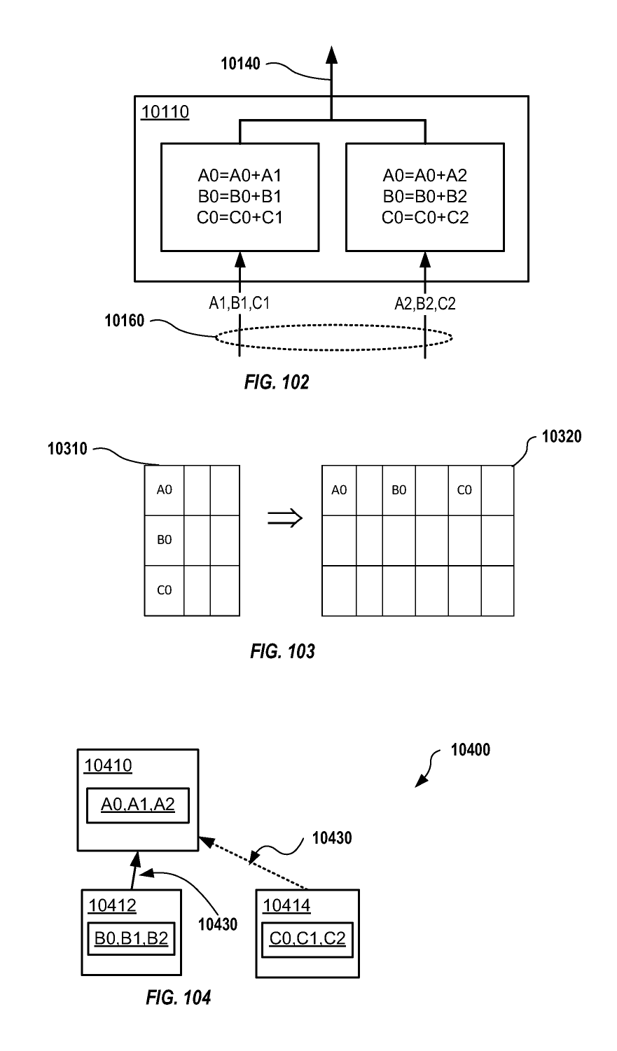

Overlapped communication with computation uses the processors available on the Smart NIC 10110, 10112, 10114. Each virtual channel (e.g. communication paths 10160-10164) of the target reduce operation may have data calculated separately on each channel, followed by the final operations. One example of a smart NIC, NIC 10210 in the present example, performing a reduction is shown in FIG. 102. Data A1, B1, C1 and A2, B2, C2 are received by NIC 10110, processed by NIC 10110, and then transmitted via bus 10140 to node 10010.

### Vector Gather Detection

Detection of a vector gather operation occurs from the detection of the data movements shown in FIG. 103, which illustrates two matrices 10310 and 10320. Matrix 10310 is a representation of data A0, B0, C0 stored on three nodes (as above, columns represent data items and rows represent nodes). Matrix 10320 shows data after a vector gather operation with data A0, B0, C0 stored on one node.

FIG. 104 shows a logical view of vector gather system 10400, having three nodes 10410, 10412 and 10414. In FIG. 104, system 10400 performs a vector gather operation utilizing a sufficient channel Howard Cascade such that data is transmitted from nodes 10412 and 10414 in the same time steps 10430.

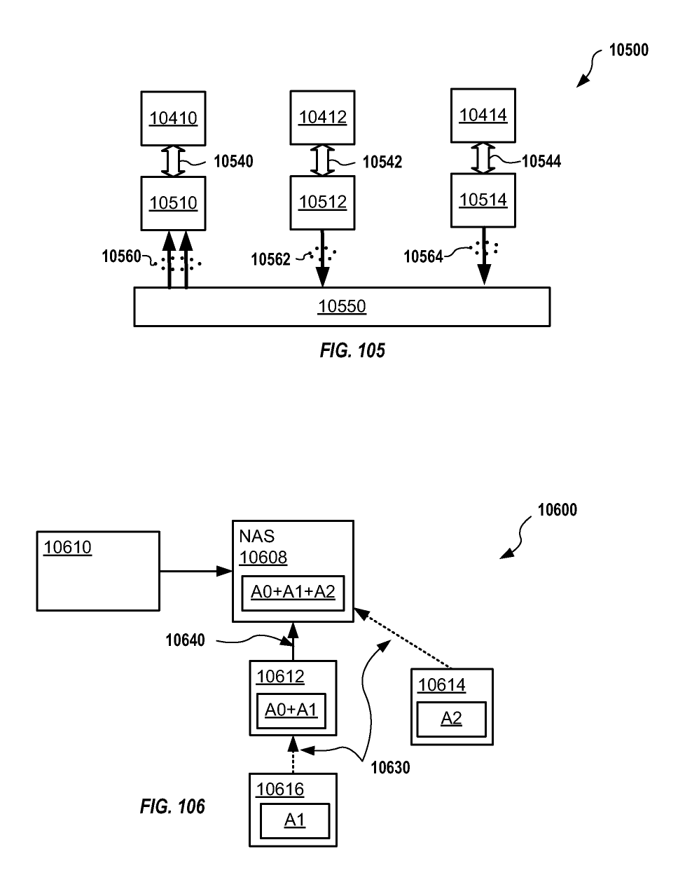

FIG. 105 shows a hardware view of system 10500 of the sufficient channel Howard Cascade vector gather operation shown in FIGS. 103 and 104. In FIG. 105, nodes 10412, 10414 transmit data to node 10410 via bus 10542, 10544, smart NICs 10512, 10514, communication paths 10562, 10564, switch 10550, communication path 10560, smart NIC, 10510, and bus 10540.

### Initial Data Output Model Examples

Data output can be defined as the ability of a system to transmit information to a receiving source. Generally, there are two types of data output: serial and parallel. Serial output transmits data using a single communication channel. Parallel data output transmits data using multiple communication channels.

### Serial Data Output Example

Data can be transmitted to a data storage device within a system utilizing a network having a single communication channel. Examples of a data storage device include, but are not limited to a storage-area network (SAN), a network-attached storage (NAS) and other online data-storage methods. Transmitting data can be accomplished via a Home-node selection of top-level compute nodes that will take an agglomerated dataset and transmit it to a portion of the system serially. FIG. 106 shows a logical view of system 10600 of serial data output using Howard Cascade-based data transmission. Within system 10600, home node 10610 and nodes 10612-10616 are in serial communication with NAS 10608. Data A2, A1 is sent to NAS 10608 and node 10612, respectively, in a first time step 10630. Data A0, A1 within node 10612 are combined and sent to NAS 10608 in a second time step 10640 where the node 10612 data, A0+A1, is combined with node 1614 data, A2. Node now has access to combined data A0+A1+A2 via NAS 10608.

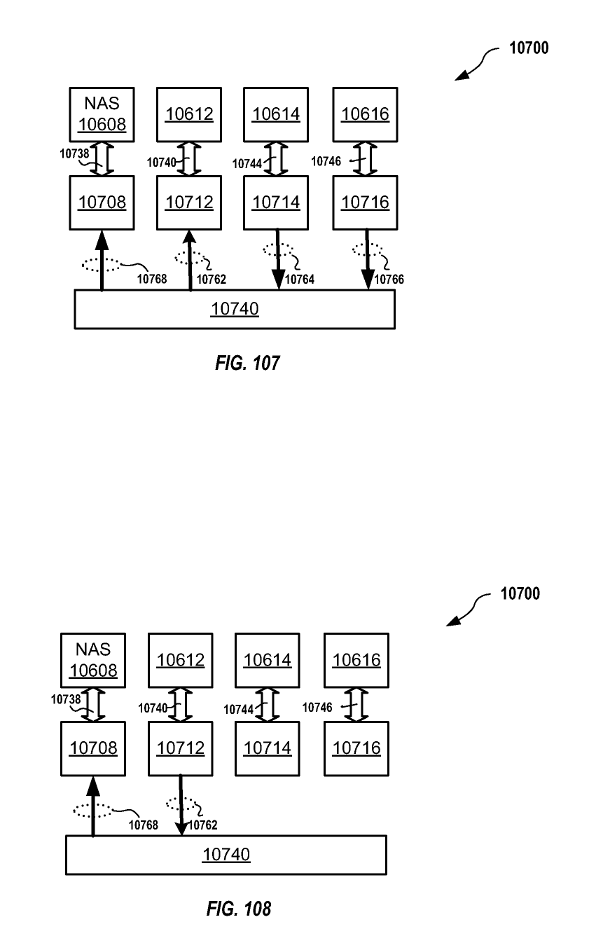

FIG. 107 shows a partial, illustrative hardware view of a serial data system 10700 using Howard Cascade-based data transmission in 1^{st} time step 10630, FIG. 106. In system 10700, nodes 10612, 10614 transmit data to node 10612 and NAS 10608 utilizing serial communication.

FIG. 108 shows the partial, illustrative hardware view of the serial data system 10700 using a Howard Cascade-based data transmission in second time step. In the second time step node 10612 transmits data to NAS 10608 utilizing a serial communication.

### Parallel Data Input Example

Data can also be sent to a data storage device with a system utilizing a parallel communication structure. Examples of a data storage device include, but are note limited to a network-attached storage (NAS), a storage-area networks (SAN), and other devices. Transmitting data can be accomplished via the Home-node selection of top-level compute nodes that will take a decomposed dataset and transmit it to a portion of the system, in parallel.

FIG. 109 shows one example of a Howard Cascade-based parallel data input transmission. Within a first time step 10930, nodes 10916, 10918, 10920 transmit to NAS 10908 and nodes 10922, 10924, 10926 transmit to node 10910, 10912, 19014, respectively. In a second time 10940 step nodes 10910, 10912, 10914 transmit to NAS 10908. After the second time step 10940, home node 10906 has access to all data transmitted to NAS 10908.

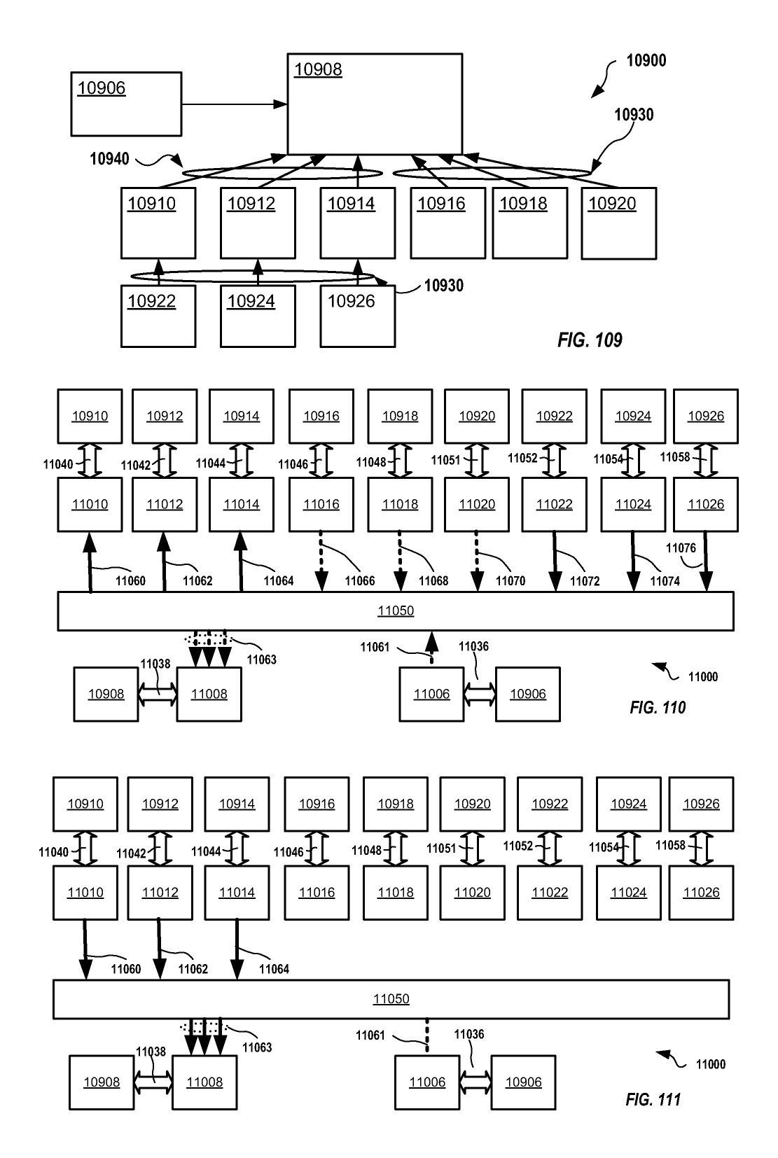

FIG. 110 shows one illustrative hardware view of a parallel data output system 11000 using a Howard Cascade during the first time step 10930, FIG. 109. Data transfer occurs as described in FIG. 109, with the buses 11036-11058, smart NICs 11006-11026, communication paths 11060-11076, and switch 11050 participating in the parallel data transfer.

FIG. 111 shows one illustrative hardware view of a parallel data output system 11000 using a Howard Cascade during the second time step 10940, FIG. 109. Data transfer occurs as described in FIG. 109, with the buses 11036-11044, smart NICs 11006-11014, communication paths 11060-11064, and switch 11050 participating in the parallel data transfer.

### Initial State Transition Patterns

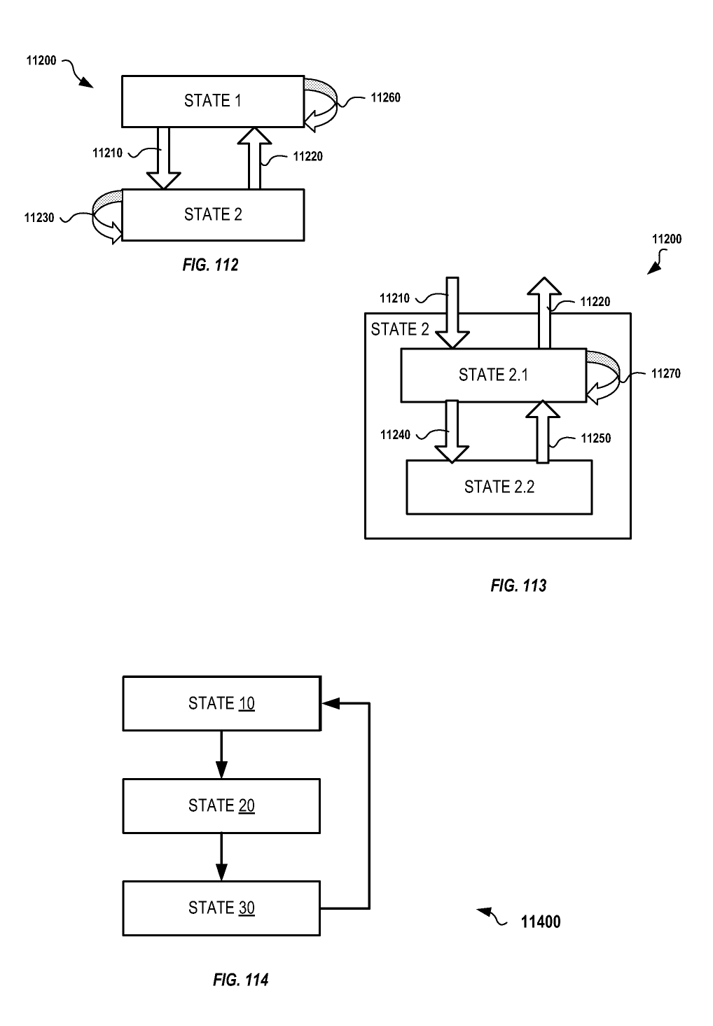

Some parallel processing patterns are determinable only at the state-transition level. In the examples shown in FIGS. 112, 113, state machine 11200 detects looping structures via state transition, as follows.

FIG. 112 shows a state machine 11200 with two states, state 1 and state 2, and four transmissions, transmission 11210, 11220, 11230, 11260. Transmission 11210, 11220 are transmissions which can be described as multiple, sequential call-return cycles with call-return from grouped state which may include a multi-level loop structure. Transmission 11230 is a direct loop with call on grouped state (see FIG. 113), which may include multi-level looping structure. Transmission 11260 is a direct loop with call on non-group state, single looping structure.

FIG. 113 shows state 2 of FIG. 112 with states 11210, 11220. State 2 additional includes a state 2.1 and a state 2.2. Transmissions 11240, 11250 are multiple, sequential call-return cycles inside of a grouped state, state 2, with subsequent states non-grouped states 2.1, 2.2. Transmission 12270 of FIG. 113 is similar to transmission 11230 of FIG. 112, with the difference being transmission 11270 FIG. 113 is associated with state 2.1.

It will be appreciated that transition vectors (e.g., transmissions 11210, 11220, 11230, etc) provide all of the variable and variable-value information required to determine looping conditions.

### Initial Combined Data Movement Plus Transition Patterns

Some parallel processing determination requires combining data movement with state transition for detection. In one example, shown in FIG. 114, the data movement found in a state 20 does not access variables accessed in a state 30. State 30 is always called after state 20, therefore both state 20 and state 30 can be processed together.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for automatically adding parallel processing capability to a serial algorithm defined by a finite state machine executing on a parallel computing system comprising:
executing process kernels to determine data access patterns used for accessing memory referenced by the algorithm;
executing control kernels to determine state transition patterns of the algorithm;
wherein the process kernels define states of the state machine, and
wherein the control kernels define state transitions of the state machine;
comparing the data access patterns and the state transition patterns with predetermined patterns in a library; and
when the data access patterns and the state transition patterns match a predetermined pattern, then storing an extension kernel associated with the predetermined pattern into the algorithm's finite state machine;
wherein the extension kernel comprises software that defines a parallel processing model with respect to sections of the algorithm where parallelization of the algorithm can occur, and wherein the sections comprise network topology of the parallel computing system, data distribution through the computing system, computing system data input and output, cross-communication within the computing system, and agglomeration of data after a computation is performed by the computing system; and
wherein the extension kernel is attached to a non-extension kernel in the algorithm to create the finite state machine wherein the current kernel is one state and the extended kernel is another state.

2. The method of claim 1, wherein the state machine links together all associated control kernels into a single non-language construct that provides for activation of the process kernels in the correct order when the algorithm is executed.

3. The method of claim 1, wherein the control kernels contain computer-language constructs consisting of subroutine calls, looping statements, decision statements, and branching statements.

4. The method of claim 1, wherein the process kernels represent only the linearly independent code being executed, and
do not contain computer-language constructs consisting of subroutine calls, looping statements, decision statements, and branching statements.

5. The method of claim 1, wherein the sections of data distribution, data input and output, cross-communication, and agglomeration are invoked by a state machine interpreter, running on the computing system, during execution of the algorithm.

6. The method of claim 1, further comprising the step of annotating the finite state machine to include parallel processing capability by adding extension kernels' states to the finite state machine.

7. A method for profiling an algorithm executing on a parallel processing system comprising:
loading, into a state machine interpreter, a serial version of a finite state machine representing the algorithm;
executing a list of data kernels on a first thread to generate data movement data;
storing the data movement data in a first data output file;
executing a list of transition kernels on a second thread to generate transition data;
storing the transition data in a second data output file;
executing the finite state machine on a third thread; and
determining if the first data output file and the second data output file match a predetermined pattern;
if the predetermined pattern is matched, then using data associated with the pattern to instruct the state machine interpreter to utilize an extension kernel associated with the pattern when data movement and transition conditions, indicative of the pattern, are identified during the profiling of the algorithm;
wherein the extension kernel comprises software that defines a parallel processing model with respect to sections of the algorithm where parallelization of the algorithm may occur, and wherein the sections comprise network topology of the parallel computing system, data distribution through the computing system, computing system data input and output, cross-communication within the computing system, and agglomeration of data after a computation is performed by the computing system.

8. The method of claim 7, wherein test input data is executed in the step of executing the algorithm's finite state machine on the third thread.

9. The method of claim 7, wherein when the pattern is matched, then storing an associated extension kernel into the algorithm's finite state machine prior to execution of the algorithm.

10. A method for automatically adding parallel processing capability to a serial algorithm defined by a finite state machine executing on a parallel processing system comprising:
defining an extension kernel for each stage of parallel processing in which movement of information occurs in the parallel processing system during execution of the algorithm; wherein the extension kernel comprises a kernel representing a parallel-processing model comprising software selected from the set of extension kernels consisting of (a) network topology, (b) problem set distribution, (c) input data receipt, (d) network cross-communication, (e) data agglomeration, and (f) output data transmission;
profiling the algorithm by:
creating process kernels representing states of the state machine;
creating control kernels defining state transitions of the state machine;
determining data access patterns of the process kernels by executing the process kernels; and
determining control kernel state transition patterns during execution of the algorithm; and
analyzing the data access patterns and the state transition patterns to determine an extension kernel for the currently executing kernel to be applied to a state interpreter at algorithm runtime at the memory location used by the kernel currently executing during the profiling.

11. The method of claim 10, wherein the state machine is annotated such that the states are the process kernels and the state transitions are defined by the control kernels, wherein parallel processing capability is established by adding extension kernels, comprising new states, to the finite state machine that represents the algorithm.

12. The method of claim 10, wherein the state-machine comprises states which are the process kernels and associated data storage, wherein the states are connected together using state vectors consisting of control kernels.

13. The method of claim 12, wherein the control kernels contain computer-language constructs consisting of subroutine calls, looping statements, decision statements, and branching statements.

14. The method of claim 10, wherein the process kernels represent only the linearly independent code being executed, and do not contain computer-language constructs consisting of subroutine calls, looping statements, decision statements, and branching statements.

15. The method of claim 10, wherein a state machine links together all associated control kernels into a single non-language construct that provides for activation of the process kernels in the correct order when the algorithm is executed.

16. A method for parallelization of an algorithm executing on a parallel processing system comprising:
generating an extension element for each of the sections of the algorithm, wherein the sections comprise:
distribution of data to multiple processing elements;
transfer of data from outside of the algorithm to inside of the algorithm;
global cross-communication of data between processing elements;
moving data to a subset of the processing elements; and
transfer of data from inside of the algorithm to outside of the algorithm;
wherein each said extension element functions to provide said parallelization at a respective place in the algorithm where parallelization of the algorithm may occur.

17. The method of claim 13, wherein network topology of the parallel computing system is determined prior to execution of the algorithm on the parallel processing system.

18. The method of claim 13, wherein a state machine links together all associated control kernels into a single non-language construct that provides for activation of the process kernels in the correct order when the algorithm is executed.

19. A method for parallelization of an algorithm executing to process data on a parallel processing system comprising:
executing the algorithm;
tracking data accesses to the largest vector/matrix used by the algorithm;
tracking the relative physical element movement to determine a current data movement pattern when the data is moved by copying the contents of an element of the vector/matrix to a different element within the same vector/matrix;
comparing the current data movement pattern with existing patterns in a library;
If the current pattern is found in library of patterns, then a discretization model for the found library pattern is assigned to the current kernel;
attaching, to the current kernel, a parallel extension kernel associated with the found library pattern to form a finite state machine with the current kernel as a state and at least one additional said parallel extension kernel as at least one other state;
wherein the parallel extension kernel comprises software for processing each of:
distribution of data to multiple processing elements, transfer of data from outside of the algorithm to inside of the algorithm, global cross-communication of data between processing elements, moving data to a subset of the processing elements, and transfer of data from inside of the algorithm to outside of the algorithm.

20. The method of claim 19, wherein the discretization model indicates the topology of the parallel processing system.
